(19) United States
(12) Patent Application Publication
(10) Pub. No.: US 2011/0172898 A1
(43) Pub. Date: Jul. 14, 2011

(54) INTERNAL COMBUSTION ENGINE SYSTEM CONTROL DEVICE

(75) Inventors: Akira Eiraku, Sunto-gun (JP); Machiko Katsumata, Susono-shi (JP)

(73) Assignee: TOYOTA JIDOSHA KABUSHIKI KAISHA, Toyota-shi, Aichi-ken (JP)

(21) Appl. No.: 13/060,380

(22) PCT Filed: Aug. 31, 2009
(86) PCT No.: PCT/IB09/06671

§ 371 Date: Feb. 23, 2011

(30) Foreign Application Priority Data
Sep. 1, 2008 (JP) 2008-223250
Jan. 29, 2009 (JP) 2009-017445
Apr. 9, 2009 (JP) 2009-094525

(51) Int. Cl. F02D 41/00

(52) U.S. Cl. 701/103

(57) ABSTRACT

A device with models constructed based on thermodynamics laws and fluid dynamics laws including the energy conservation law, momentum conservation law and mass conservation law. Compressor outflow flow rate calculation section calculates the flow rate of air that flows out of a compressor based on a relationship between an in-cylinder intake air flow rate during steady-state operation in an internal combustion engine system and supercharging pressure, which is pressure of air compressed by the compressor, and a value of the in-cylinder intake air flow rate calculated by in-cylinder intake air flow rate calculation section.

### BACKGROUND OF THE INVENTION

1. Field of the Invention

The invention relates to an internal combustion engine system control device that controls an internal combustion engine system provided with a supercharger having a compressor that compresses air inside an intake passage.

2. Description of the Related Art

In order to make the air-fuel ratio of a fuel-air mixture supplied to the cylinders of a fuel combustion engine equal to a target air-fuel ratio, the amount of air introduced into the cylinders (to be referred to as in-cylinder air amount) must be estimated accurately.

However, a supercharger may be installed in the intake system of an internal combustion engine for the purpose of, for example, improving maximum output of the internal combustion engine. In this case, air inside the intake passage is compressed by the supercharger. Consequently, the pressure and temperature of air upstream from the throttle valve vary suddenly in comparison with atmospheric pressure and temperature. Accordingly, in the case of an internal combustion engine system provided with a supercharger, it is more difficult to accurately estimate in-cylinder air amount than in the case of natural aspiration.

Therefore, various devices have been previously proposed for estimating in-cylinder air amount in this type of internal combustion engine system with high accuracy (see, for example, Japanese Patent Application Publication No. 2006-22763 (JP-A-2006-22763), Japanese Patent Application Publication No. 2006-70881 (JP-A-2006-70881) and Japanese Patent Application Publication No. 2006-194107 (JP-A-2006-194107)). These devices of the related art estimate supercharging pressure based on a model of various elements and the behavior of gas in an intake system, and then estimate in-cylinder air amount based on this estimated value of supercharging pressure.

For example, in the configuration disclosed in JP-A-2006-22763, turbine power is calculated from exhaust parameters and a turbine model. Supercharging pressure is then calculated from the calculated turbine power and a compressor model.

The exhaust parameters including such parameters as temperature of the exhaust turbine vary over a wide range in accordance with engine operating status. Accordingly, it is difficult to accurately estimate exhaust parameters based on measurements using sensors and calculations. Consequently, it is difficult to accurately estimate supercharging pressure and in-cylinder air amount in a configuration of the related art using characteristics of the exhaust system (such as in the configuration disclosed in JP-A-2006-22763).

In addition, providing sensors in the exhaust system for acquiring exhaust temperature and turbine rotating speed (which is equal to compressor rotating speed) results in increased costs.

Thus, in a device of the related art that uses measurement and estimation of exhaust parameters (such as that disclosed in JP-A-2006-22763), it is difficult to accurately control this type of internal combustion engine system with an inexpensive device configuration.

### SUMMARY OF THE INVENTION

The invention provides an internal combustion engine system control device that enables the in-cylinder air amount in an internal combustion engine system provided with a supercharger to be estimated more accurately. In addition, the invention provides an internal combustion engine system control device that enables an internal combustion engine system provided with a supercharger to be controlled more accurately using an inexpensive device configuration.

An internal combustion engine system that is an application target of the invention is provided with an internal combustion engine, an intake passage, an intake valve and a supercharger.

The intake passage is connected to a cylinder provided within the internal combustion engine. The intake valve is provided in the internal combustion engine so as to open and close an intake port. This intake port is a portion that is connected to the cylinder in the intake passage.

A throttle valve can be installed in the intake passage in the internal combustion engine system. This throttle valve is composed to enable adjustment of the flow path cross-sectional area in the intake passage.

The supercharger has a compressor. This compressor is installed in the intake passage farther upstream than the intake valve (farther upstream than the throttle valve in the case a throttle valve is installed). This compressor is composed so as to compress air within the intake passage.

A first aspect of the invention is a device that controls an internal combustion engine system having a configuration as described above, and is characterized by being provided with in-cylinder intake air flow rate calculation means and compressor outflow flow rate calculation means as described below.

The in-cylinder intake air flow rate calculation means calculates in-cylinder intake air flow rate using parameters that indicate the status of an intake system and an air model. Here, the intake passage and the intake valve are included in the intake system. The throttle valve can also be included in the intake system. The in-cylinder intake air flow rate is the flow rate of air that flows into the cylinder. The air model is a calculation model that is constructed on the basis of physical laws relating to the behavior of air in the intake system (including thermodynamics laws and fluid dynamics laws such as the energy conservation law, momentum conservation law and mass conservation law).

The in-cylinder intake air flow rate calculation means calculates the in-cylinder intake air flow rate using, for example, an intake valve model which is an air model. Here, the intake valve model is a calculation model that is constructed on the basis of physical laws relating to the behavior of air around the intake valve.

The compressor outflow flow rate calculation means calculates compressor outflow flow rate on the basis of a prescribed relationship and the value of the in-cylinder intake air flow rate calculated by the in-cylinder intake air flow rate calculation means. Here, the prescribed relationship is a relationship between the in-cylinder intake air flow rate and supercharging pressure during steady state operation of the internal combustion engine system. This supercharging pressure is a value corresponding to the pressure of air compressed by the compressor, and more specifically, is the air pressure at the outlet of the supercharger, or the difference or ratio between this pressure and the air pressure on the upstream side of the compressor (such as atmospheric pressure). In addition, the compressor outflow flow rate is the flow rate of air, that flows out from the compressor.

The compressor outflow flow rate calculation means may also calculate the compressor outflow flow rate based on a provisional supercharging pressure by acquiring a provisional value of the supercharging pressure in the form of this provisional supercharging pressure based on the above-mentioned relationship and the value of the in-cylinder intake air flow rate calculated by the in-cylinder intake air flow rate calculation means.

Alternatively, the compressor outflow flow rate calculation means may calculate the compressor outflow flow rate based on a calculated value of compressor rotating speed by calculating the compressor rotating speed based on the above-mentioned relationship and the value of in-cylinder intake air flow rate calculated by the in-cylinder intake air flow rate calculation means.

The internal combustion engine system control device can be further provided with throttle passage air flow rate calculation means and supercharging pressure calculation means.

The throttle passage air flow rate calculation means calculates the flow rate of air in the throttle valve in the form of throttle passage air flow rate based on the opening of the throttle valve using a throttle model. Here, the throttle model is a calculation model that is constructed on the basis of physical laws relating to the behavior of air in the throttle valve.

The supercharging pressure calculation means calculates the supercharging pressure based on the throttle passage air flow rate calculated by the throttle passage air flow rate calculation unit using an intercooler model. Here, the intercooler model is a calculation model that is constructed on the basis of physical laws relating to the behavior of air in an intercooler. This intercooler is installed between the compressor and the throttle valve, and cools air that flows out from the compressor.

In this case, the in-cylinder intake air flow rate calculation means calculates the in-cylinder intake air flow rate on the basis of the throttle passage air flow rate calculated by the throttle passage air flow rate calculation means using the intake valve model.

In addition, the compressor outflow flow rate calculation means acquires the provisional supercharging pressure based on the above-mentioned relationship and the value of the in-cylinder intake air flow rate calculated by the in-cylinder intake air flow rate calculation means. The compressor outflow flow rate calculation means calculates the compressor outflow flow rate based on the provisional supercharging pressure and the value of supercharging pressure calculated by the supercharging pressure calculation means.

More specifically, the compressor outflow flow rate calculation means may calculate the compressor outflow flow rate by, for example, acquiring a compressor outflow flow rate correction value based on the difference between the calculated value of supercharging pressure and the provisional supercharging pressure, and then correcting the calculated value of the in-cylinder intake air flow rate with this compressor outflow flow rate correction value.

The internal combustion engine system control device may be further provided with intake pipe internal status calculation means. This intake pipe internal status calculation means calculates intake pipe internal pressure and intake pipe internal temperature based on the throttle passage air flow rate calculated by the throttle passage air flow rate calculation means using an intake pipe model. Here, the intake pipe model is a calculation model that is constructed on the basis of physical laws relating to the behavior of air in a portion of the intake passage farther downstream than the throttle valve. In addition, the intake pipe internal pressure and the intake pipe internal temperature are the pressure and temperature of air at this portion of the intake passage.

In this case, the in-cylinder intake air flow rate calculation means calculates the in-cylinder intake air flow rate based on the values of intake pipe internal pressure and intake pipe internal temperature calculated by the intake pipe internal status calculation means using the intake valve model.

The internal combustion engine system control device can be further provided with responsiveness reflecting means. This responsiveness reflecting means reflects a response delay of the supercharger in the value of compressor outflow flow rate calculated by the compressor outflow flow rate calculation means.

More specifically, the responsiveness reflecting means reflects a response delay of the supercharger in the value of the in-cylinder intake air flow rate calculated by the in-cylinder intake air flow rate calculation means (which is the value serving as the basis for calculation of the compressor outflow flow rate by the compressor outflow flow rate calculation means).

The inventors of the invention obtained the findings indicated below as a result of conducting various studies.

When considering the supercharger alone, the relationship between the compressor outflow flow rate and the supercharging pressure changes in various ways in accordance with compressor rotating speed. Namely, a graph representing the relationship between the compressor outflow flow rate and the supercharging pressure in the case of a constant compressor rotating speed is in the form of a single curved line (substantially elliptical arc opening in the direction of the origin). When the compressor rotating speed changes, the shape of the curve changes and its position shifts.

On the other hand, in the internal combustion engine system provided with the supercharger, the supercharging pressure can be expressed as a function of the compressor outflow flow rate during steady state operation. Namely, a graph representing the relationship between these parameters is in the form of a prescribed single curved line along the direction of the above-mentioned shift regardless of the compressor rotating speed.

Therefore, the internal combustion engine system control device of the first aspect of the invention calculates the in-cylinder intake air flow rate using the above-mentioned parameters of the intake system (such as throttle valve opening) and the air model, and calculates the compressor outflow flow rate based on this calculated value and the previously described prescribed relationship.

In this manner, in a configuration of the first aspect of the invention, the compressor outflow flow rate is calculated using the above-mentioned parameters of the intake system that can be acquired (measured or calculated) more accurately than parameters of the exhaust system. Thus, according to this configuration, in-cylinder air amount can be estimated more accurately by using the compressor outflow flow rate.

In addition, in cases in which the supercharger response delay cannot be ignored, the response delay can be favorably compensated by reflecting the response delay in the calculated value of the compressor outflow flow rate (and more specifically, by reflecting in, for example, a calculated value of the in-cylinder intake air flow rate that serves as a basis for calculating the compressor outflow flow rate).

In a second aspect of the invention, an internal combustion engine system that is an application target of the invention is provided with an internal combustion engine, an intake passage, a throttle valve and a supercharger. In addition, this internal combustion engine system can be further provided with an intercooler.

The intake passage is connected to a cylinder provided within the internal combustion engine. In addition, an intake valve is provided in the internal combustion engine. This intake valve opens and closes an intake port, which is a portion of the intake passage connected to the cylinder. The throttle valve is installed in the intake passage and is composed to enable adjustment of the flow path cross-sectional area in the intake passage.

The supercharger has a compressor. This compressor is composed so as to compress air within the intake passage farther upstream than the throttle valve in the intake passage. The intercooler is installed between the compressor and the throttle valve, and cools air that flows out from the compressor.

The second aspect of the invention is a device that controls an internal combustion engine system having a configuration as described above, and is characterized by being provided with in-cylinder intake air flow rate acquisition means, supercharging pressure acquisition means, provisional intake air amount acquisition means, and compressor rotating speed estimation means. The internal combustion engine system control device of the invention can be further provided with provisional in-cylinder intake air flow rate acquisition means, provisional supercharging pressure acquisition means and compressor outflow flow rate acquisition means. The term “acquisition” can also be read as calculation or estimation.

The in-cylinder intake air flow rate acquisition means acquires in-cylinder intake air flow rate (flow rate of air entering the cylinder; to have the same meaning hereinafter) using a calculation model that is constructed on the basis of physical laws relating to the behavior of air in the intake system (including the intake passage, the throttle valve, the compressor and the intake valve; to have the same meaning hereinafter).

The supercharging pressure acquisition means acquires supercharging pressure (value corresponding to the pressure of air compressed by the compressor; to have the same meaning hereinafter) using another calculation model (that can include a portion of the above-mentioned calculation model) that is constructed on the basis of other physical laws (that can include a portion of the above-mentioned physical laws) relating to the behavior of air in the intake system.

The provisional intake air amount acquisition means acquires provisional intake air amount (the in-cylinder intake air flow rate in the case the supercharging pressure is assumed to coincide with the supercharging pressure acquired value during the above-mentioned steady state operation; to have the same meaning hereinafter) on the basis of an intake amount-supercharging pressure steady-state relationship (relationship between the in-cylinder intake air flow rate and the supercharging pressure during steady-state operation in the internal combustion engine system; to have the same meaning hereinafter) and the value of supercharging pressure acquired by the supercharging pressure acquisition means.

The compressor rotating speed estimation means estimates the compressor rotating speed based on an intake amount-rotating speed steady-state relationship (relationship between the in-cylinder intake air flow rate and compressor rotating speed during the steady-state operation; to have the same meaning hereinafter) and the in-cylinder intake air flow rate acquired by the in-cylinder intake air flow rate acquisition means, and the provisional intake air amount.

The provisional in-cylinder intake air flow rate acquisition means acquires the provisional in-cylinder intake air flow rate (the in-cylinder intake air flow rate in the case the compressor rotating speed is assumed to coincide with the rotating speed estimated value during the steady-state operation; to have the same meaning hereinafter) based on the rotating speed estimated value estimated by the compressor rotating speed estimation means and the intake amount-rotating speed steady-state relationship.

The provisional supercharging pressure acquisition means acquires provisional supercharging pressure (provisional value of the supercharging pressure; to have the same meaning hereinafter) based on the intake air-rotating speed steady-state relationship and the provisional in-cylinder intake air flow rate.

The compressor outflow flow rate acquisition means acquires compressor outflow flow rate (flow rate of air flowing out from the compressor; to have the same meaning hereinafter) based on the provisional in-cylinder intake air flow rate, the provisional supercharging pressure, and the supercharging pressure acquired value.

Here, the compressor rotating speed estimation means can be provided with first provisional rotating speed acquisition means, second provisional rotating speed acquisition means and rotating speed estimated value acquisition means.

The first provisional rotating speed acquisition means acquires a first provisional rotating speed which is a provisional value of the compressor rotating speed, based on the in-cylinder intake air flow rate acquired by the in-cylinder intake air flow rate acquisition means and the intake amount-rotating speed steady-state relationship.

The second provisional rotating speed acquisition means acquires a second provisional rotating speed which is another provisional value of the compressor rotating speed, based on the provisional intake air amount and the intake air-rotating speed steady-state relationship.

The rotating speed estimated value acquisition means acquires an estimated value of the compressor rotating speed by estimating a transient change in the compressor rotating speed based on the first provisional rotating speed and the second provisional rotating speed.

In this case, the compressor outflow flow rate acquisition means may calculate the compressor outflow flow rate by correcting the provisional in-cylinder intake air flow rate with a correction value calculated from the product of a coefficient determined on the basis of a difference between the provisional supercharging pressure and the supercharging pressure acquired value and the provisional in-cylinder intake air flow rate, and that difference.

On the other hand, the in-cylinder intake air flow rate acquisition means can be provided with throttle passage air flow rate acquisition means and intake pipe internal status acquisition means.

The throttle passage air flow rate acquisition means acquires throttle passage air flow rate (flow rate of air in the throttle valve; to have the same meaning hereinafter) based on the opening of the throttle valve using a throttle model (the calculation model that is constructed on the basis of physical laws relating to the behavior of air in the throttle valve; to have the same meaning hereinafter).

The intake pipe internal status acquisition means acquires an intake pipe internal pressure and an intake pipe internal temperature which are the pressure and temperature of air in that portion, based on the throttle passage air flow rate using an intake pipe model (the calculation model that is constructed on the basis of physical laws relating to the behavior of air in a portion of the intake passage farther downstream than the throttle valve; to have the same meaning hereinafter).

In this case, the in-cylinder intake air flow rate acquisition means acquires the in-cylinder intake air flow rate based on the intake pipe internal pressure and the intake pipe internal temperature using an intake valve model (the calculation model that is constructed on the basis of physical laws relating to the behavior of air around the intake valve; to have the same meaning hereinafter).

In addition, the supercharging pressure acquisition means may acquire the supercharging pressure based on the throttle passage air flow rate acquired by the throttle passage air flow rate acquisition means using an intercooler model (the calculation model that is constructed based on physical laws relating to the behavior of air in the intercooler; to have the same meaning hereinafter).

Furthermore, each of the above-mentioned parameters (such as rotating speed, pressure and flow rate) can be substituted with other parameters equivalent thereto. For example, these other equivalent parameters can be used instead of the in-cylinder intake air flow rate or the supercharging pressure. In addition, “rotating speed” can be used instead of the rotating speed of the compressor (per unit time).

In general, when considering only the supercharger alone, the relationship between the compressor outflow flow rate and the supercharging pressure changes in various ways in accordance with the compressor rotating speed.

Namely, the relationship between the compressor outflow flow rate and the supercharging pressure in the case the compressor rotating speed is constant is in the form of a single curved line in the shape of an elliptical arc opening in the direction of the origin (to be referred to as the “compressor characteristic curve”). The shape and position of this compressor characteristic curve vary according to the compressor rotating speed. More specifically, when the compressor rotating speed increases, the compressor characteristic curve shifts to the outside (direction moving away from the origin). A plurality of the compressor characteristic curves corresponding to different compressor rotating speeds are arranged in the form of substantially concentric elliptical arcs.

Here, the inventors of the invention obtained the findings indicated below as a result of conducting various studies.

(1) During the above-mentioned steady-state operation in the internal combustion engine system provided with the supercharger as described above (during which time the compressor outflow flow rate and the in-cylinder intake air flow rate coincide), the supercharging pressure is expressed as a function of the compressor outflow flow rate.

Namely, the relationship between the supercharging pressure and the compressor outflow flow rate during the steady-state operation of the internal combustion engine system provided with the supercharger (the above-mentioned intake amount-supercharging pressure steady-state relationship) is in the form of a single curved line that intersects one time each with the plurality of compressor characteristic lines arranged in the form of substantially concentric elliptical arcs as previously described (to be referred to as the “intake amount-supercharging pressure steady-state curve”).

A single specific point on this intake amount-supercharging pressure steady-state curve indicates the compressor outflow flow rate (namely, the in-cylinder intake air flow rate) and the supercharging pressure for a specific operating state that satisfies the conditions of the above-mentioned steady-state operation. The compressor rotating speed during this operating state is uniquely determined. Namely, a single specific point on the intake amount-supercharging pressure steady-state curve is an intersect between a single compressor characteristic curve corresponding to the compressor rotating speed in the above-mentioned specific operating state and the intake amount-supercharging pressure steady-state curve.

Thus, if it were possible to accurately estimate the compressor rotating speed, the supercharging pressure and the in-cylinder intake air flow rate during the specific operating state corresponding to this estimated value (namely, the provisional supercharging pressure and the provisional in-cylinder intake air flow rate) can be specified. The use thereof makes it possible to accurately control the internal combustion engine system provided with the supercharger.

Namely, the actual compressor outflow flow rate during an actual operating state that does not satisfy the conditions of the above-mentioned steady-state operation can be accurately acquired by correcting the provisional in-cylinder intake air flow rate based on a shift of that operating state from the steady-state operation.

More specifically, the compressor outflow flow rate is calculated by correcting the provisional in-cylinder intake air flow rate with the correction value calculated from the product of the coefficient that is determined based on the difference between the provisional supercharging pressure and the supercharging pressure acquired value and the provisional supercharging pressure, and that difference. The actual in-cylinder intake air flow rate can then be accurately estimated based on this calculated value.

(2) A response delay of the supercharger cannot be ignored in the internal combustion engine system provided with that supercharger. This response delay is thought to be strongly correlated with transient changes in the compressor rotating speed.

This compressor rotating speed can be measured directly with a sensor. However, installing a compressor rotating speed sensor in the internal combustion engine system increases device costs. Accordingly, accurately estimating the compressor rotating speed while taking into consideration this response delay makes it possible to carry out suitable control in consideration of this response delay without increasing device costs.

When this response delay is taken into consideration, a point on the intake amount-supercharging pressure steady-state curve corresponding to a current actual compressor rotating speed (namely, the above-mentioned intersect) can be assumed to be located between a first point corresponding to the current in-cylinder intake air flow rate and a second point corresponding to the current supercharging pressure acquired value.

Here, during the steady-state operation of the internal combustion engine system provided with the supercharger, the compressor rotating speed is expressed as a function of the mass flow rate of intake air in the intake passage in the form of intake air amount (the intake amount-rotating speed steady-state relationship). At this time, the intake air amount and the in-cylinder intake air flow rate coincide. In addition, the curve indicating the intake amount-rotating speed steady-state relationship is to be referred to as the “intake amount-rotating speed steady-state curve”.

Accordingly, a point on the intake amount-rotating speed steady-state curve corresponding to the current actual compressor rotating speed can be assumed to be located between a first point corresponding to the current in-cylinder intake air flow rate and a second point corresponding to the provisional intake air amount acquired according to the current supercharging pressure acquired value and the intake amount-supercharging pressure steady-state curve. The current actual compressor rotating speed can then be accurately estimated on the basis thereof.

More specifically, the first provisional rotating speed is acquired based on, for example, the in-cylinder intake air flow rate acquired by the in-cylinder intake air flow rate acquisition means and the intake amount-rotating speed steady-state relationship. In addition, a second provisional rotating speed is acquired based on the provisional intake air amount and the intake amount-rotating speed steady-state relationship. An estimated value of the compressor rotating speed is then acquired by estimating a transient change in the compressor rotating speed based on the first provisional rotating speed and the second provisional rotating speed.

According to the internal combustion engine system control device of the invention provided with configuration as described above, the compressor rotating speed can be accurately estimated while taking into consideration a response delay by using intake parameters (parameters indicating the status of the intake system), which can be acquired (measured or calculated) more accurately than exhaust parameters.

Thus, according to the second aspect of the invention, the internal combustion engine system provided with the supercharger can be controlled more accurately with an inexpensive device configuration.

In the first and second aspects described above, a configuration may be adopted in which, when the amount of air actually taken into the cylinder during the intake stroke is designated as an actual value of in-cylinder intake air amount, the actual value of in-cylinder intake air amount when a predetermined amount of time has elapsed from the start of calculation of in-cylinder intake air amount is calculated as a predicted value of in-cylinder intake air amount at the start of calculation of in-cylinder intake air amount, the difference between the predicted value of the in-cylinder intake air amount and the actual value of in-cylinder intake air amount at the start of calculation of in-cylinder intake air amount is calculated as a predicted value of the change in in-cylinder intake air amount at the start of calculation of in-cylinder intake air amount, and when the predicted value of the change in in-cylinder intake air amount is greater than a predetermined predicted value of change, the calculated value of in-cylinder intake air amount is corrected in accordance with the predicted value of change in the in-cylinder intake air amount, and operation of the internal combustion engine is controlled based on the corrected calculated value of in-cylinder intake air amount.

In this case, when the difference between the opening of the throttle valve at the start of calculation of in-cylinder intake air amount and a target throttle valve opening at the start of calculation of the in-cylinder intake air amount is greater than a predetermined opening difference, a predicted value of change in in-cylinder intake air amount may be determined to be greater than the predetermined predicted value of change.

Moreover, a configuration may be adopted in which, when pressure in the intake passage downstream the throttle valve is designated as a throttle valve downstream pressure, the throttle valve downstream pressure when the predetermined amount of time has elapsed from the start of calculation of in-cylinder intake air amount is calculated as a predicted value of the throttle valve downstream pressure at the start of calculation of the in-cylinder intake air amount, a difference between the predicted value of the throttle valve downstream pressure and the throttle valve downstream pressure at the start of calculation of in-cylinder intake air amount is calculated as the amount of change in the throttle valve downstream pressure at the start of calculation of the in-cylinder intake air amount, and when the amount of change in the throttle valve downstream pressure is greater than a predetermined pressure change, the predicted value of the change in in-cylinder intake air amount is determined to be greater than the predetermined predicted value of change.

In addition, a configuration may be adopted in which, when the predicted value of change in in-cylinder intake air amount has been determined to be greater than the predetermined predicted value of change, and the predicted value of change in the in-cylinder intake air amount has been determined to increase more than the predetermined predicted value of change, the calculated value of in-cylinder intake air amount is corrected so as to increase; on the other hand, when the predicted value of change in the in-cylinder intake air amount has been determined to be greater than the predetermined predicted value of change, and the predicted value of change in the in-cylinder intake air amount has been determined to decrease more than the predetermined predicted value of change, the calculated value of in-cylinder intake air amount is corrected so as to decrease.

In addition, calculation of the in-cylinder intake air amount may be executed at a predetermined time interval, and the predetermined time may be equal to the predetermined time interval.

In addition, the predetermined time may be equal to a time from the start of calculation of the in-cylinder intake air amount until a calculated value of in-cylinder intake air amount, which is obtained by calculating the in-cylinder intake air amount, is used to control operation of an internal combustion engine.

As a result of a calculated value of in-cylinder intake air amount being corrected in accordance with the amount of change in the in-cylinder intake air amount when the actual amount of change in in-cylinder intake air amount after the start of calculation of the in-cylinder intake air amount is comparatively large, an in-cylinder intake air amount is calculated that coincides with the actual in-cylinder intake air amount or that is at least closer to the actual in-cylinder intake air amount as compared with a calculated value of in-cylinder intake air amount for which correction is not made.

In addition, as a result of correcting the calculated valve of in-cylinder intake air amount in accordance with the amount of change in the in-cylinder intake air amount until the calculated value of in-cylinder air amount is used to control operation of an internal combustion engine, an in-cylinder intake air amount is calculated that coincides with an actual in-cylinder intake air amount when it is used to control operation of the internal combustion engine or that is at least closer to the actual in-cylinder intake air amount as compared with a calculated value of in-cylinder intake air amount, for which correction is not made.

### BRIEF DESCRIPTION OF THE DRAWINGS

The features, advantages, and technical and industrial significance of this invention will be described in the following detailed description of example embodiments of the invention with reference to the accompanying drawings, in which like numerals denote like elements, and wherein:

FIG. 1 is a drawing schematically showing the overall configuration of an internal combustion engine system to which one embodiment of the invention is applied;

FIG. 2 is a function block diagram of the control device shown in FIG. 1;

FIG. 3 is a drawing showing a table referenced by a central processing unit (CPU) shown in FIG. 1 that defines the relationship between an accelerator pedal depression amount and a target throttle valve opening;

FIG. 4 is a time chart showing changes in provisional target throttle valve opening, target throttle valve opening and predicted throttle valve opening;

FIG. 5 is a graph showing a function used when calculating predicted throttle valve opening;

FIG. 6 is a drawing showing a table referenced by the CPU shown in FIG. 1 to acquire provisional supercharging pressure and compressor rotating speed that defines the relationship among intercooler internal pressure, compressor outflow air flow rate and compressor rotating speed;

FIG. 7 is a drawing showing a table referenced by the CPU shown in FIG. 1 to acquire provisional supercharging pressure that defines the relationship between in-cylinder inflow air flow rate and intercooler internal pressure;

FIG. 8 is a function block diagram showing the details of the configuration of the compressor model shown in FIG. 2;

FIG. 9 is a drawing showing a table referenced by the CPU shown in FIG. 1 that defines the relationship among compressor outflow air flow rate, compressor rotating speed and compressor efficiency;

FIG. 10 is a flow chart showing a throttle valve opening estimation routine executed by the CPU shown in FIG. 1;

FIG. 11 is a flow chart showing an in-cylinder air amount estimation routine executed by the CPU shown in FIG. 1;

FIG. 12 is a flow chart showing a throttle passage air flow rate routine executed by the CPU shown in FIG. 1;

FIG. 13 is a schematic drawing showing the relationship among a first time point, a prescribed time interval Δt0, a previous estimation time point t1 and a current estimation time point t2;

FIG. 14 is a flow chart showing a routine for estimating compressor outflow air flow rate and compressor-imparted energy that is executed by the CPU shown in FIG. 1;

FIG. 15 is a function block diagram showing a variation of the compressor model shown in FIG. 8;

FIG. 16 is a graph showing the relationship among intercooler internal pressure, compressor outflow flow rate and compressor rotating speed for only the supercharger alone shown in FIG. 1;

FIG. 17 is a drawing showing an intake amount-supercharging pressure steady state map that defines the steady state relationship between intake amount and supercharging pressure in the internal combustion engine system shown in FIG. 1;

FIG. 18 is a drawing showing (i) an intake amount-rotating speed steady state map that defines the steady state relationship between intake amount and rotating speed in the internal combustion engine system shown in FIG. 1, and (ii) the form of transient changes in compressor rotating speed;

FIG. 19 is a function block diagram showing the details of a configuration relating to acquisition of compressor outflow flow rate in the compressor model shown in FIG. 2;

FIG. 20 is a function block diagram showing the details of the configuration of the compressor rotating speed estimation unit shown in FIG. 19;

FIG. 21 is a flow chart showing a routine for estimating compressor outflow air flow rate and compressor-imparted energy executed by the CPU shown in FIG. 1;

FIG. 22 is a drawing showing a spark ignition-type internal combustion engine provided with a supercharger to which the control device of the invention is applied;

FIG. 23 is a function block diagram showing the functions of models of the invention;

FIG. 24 is a drawing showing a map that defines the relationship between an accelerator pedal depression amount Accp and a target throttle opening θt;

FIG. 25 is a drawing showing a map that defines the relationship between a difference Δθ between a target throttle opening θt and a predicted throttle opening θe and a function f(θt,θe);

FIG. 26 is a drawing showing a map that defines the relationship between a throttle opening θ and a product C(θ)·A(θ);

FIG. 27 is a drawing showing a map that defines the relationship among an engine rotating speed (number of rotations of the engine (NE)), an intake valve opening and closing timing (valve timing (VT)) and a proportionality coefficient c;

FIG. 28 is a drawing showing a map that defines the relationship among an engine rotating speed NE, an intake valve opening and closing timing VT and a value d;

FIG. 29 is a drawing showing the relationship between a pressure ratio Pm/Pi and a throttle valve passage air flow rate mt;

FIG. 30 is a drawing showing the relationship between a pressure ratio Pm/Pi and a throttle valve passage air flow rate mt;

FIG. 31 is a drawing showing the relationship between an intake pipe pressure Pm and a value Φ (Pm/Pi);

FIG. 32 is a drawing showing a map that defines the relationship among intake pipe pressure Pm, throttle opening θ and a value Φ (Pm/Pi);

FIG. 33 is a drawing showing an example of a flow chart for executing an arithmetic operation in accordance with an electronically controlled throttle valve model M1;

FIG. 34 is a drawing showing a map that defines the relationship among pressure ratio Pm/Pi, throttle opening θ and a value Φ (Pm/Pi);

FIG. 35 is a drawing showing the relationship among pressure ratio Pi/Pa, compressor rotating speed NC and compressor outflow air flow rate mcm;

FIG. 36 is a drawing showing a map that defines the relationship among pressure ratio Pm/Pi, compressor rotating speed NC and compressor outflow air flow rate mcm;

FIG. 37 is a drawing showing the relationship among compressor outflow air flow rate mcm, compressor rotating speed NC and compressor efficiency η;

FIG. 38 is a drawing showing a map that defines the relationship among compressor outflow air flow rate mcm, compressor rotating speed NC and compressor efficiency η;

FIG. 39 is a drawing showing the relationship among intercooler pressure Pi, compressor rotating speed NC and compressor outflow air flow rate mcm;

FIG. 40 is a drawing showing a map that defines the relationship among intercooler pressure Pi, Compressor rotating speed NC and compressor outflow air flow rate mcm;

FIG. 41 is a drawing showing an example of a flow chart for executing an arithmetic operation in accordance with a throttle model M2, an intake valve model M3, an intake pipe model M6, and intake valve model M7, a compressor model M4 and an intercooler model M5;

FIG. 42 is a drawing showing the example of the flow chart for executing the arithmetic operation in accordance with the throttle model M2, the intake valve model M3, the intake pipe model M6, the intake valve model M7, the compressor model M4 and the intercooler model M5;

FIG. 43 is a drawing showing the example of the flow chart for executing the arithmetic operation in accordance with the throttle model M2, the intake valve model M3, the intake pipe model M6, the intake valve model M7, the compressor model M4 and the intercooler model M5; and

FIG. 44 is a drawing showing the relationship among intercooler pressure Pi, compressor rotating speed NC and compressor outflow air flow rate mcm.

### DETAILED DESCRIPTION OF EMBODIMENTS

The following provides an explanation of an embodiment of the invention (embodiment considered to be the best mode for carrying out the invention by the applicant at the time of filing) with reference to the drawings.

Furthermore, the following descriptions of the embodiment merely provide descriptions in as much detail as possible of examples that embody the invention in order to satisfy description requirements of specifications as required by rules and regulations (description requirements and requirements for enabling working of an invention). Accordingly, as will be described later, it is completely a matter of common sense that the invention is not limited in any way to a specific configuration of the embodiment as described below. Since the insertion of various modifications that can be made with respect to the embodiments hinders a consistent understanding of the explanation of the embodiments, these are summarily described at the end of the description.

<Configuration of Internal Combustion Engine System>

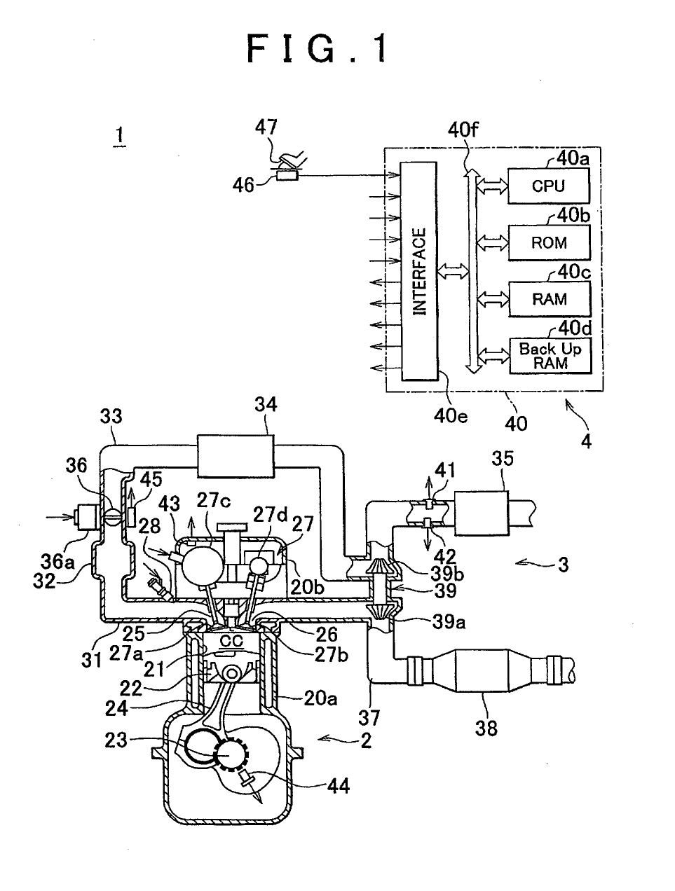

FIG. 1 is a drawing schematically showing the overall configuration of an internal combustion engine system 1 to which a first embodiment of the invention is applied. This internal combustion engine system 1 is provided with an inline multi-cylinder internal combustion engine 2, an intake/exhaust system 3 and a control device 4 (in FIG. 1, a cross-sectional view of the internal combustion engine 2 is shown using a plane that is perpendicular to the direction of the arrangement of cylinders). The following provides a more detailed explanation of the configuration of each portion of the internal combustion engine system 1.

<Internal Combustion Engine> An explanation is first provided of the configuration of the internal combustion engine 2.

A cylinder block 20a, which includes a lower case, an oil pan and the like, is a member that composes the main unit portion (engine block) of the internal combustion engine 2 together with a cylinder head 20b. The cylinder head 20b is fixed to the upper end of the cylinder block 20a.

A plurality of cylinders 21 are provided in a row as previously described in the cylinder block 20a. Pistons 22 are reciprocatably housed in the cylinders 21. A crankshaft 23 is housed while rotatably supported below the cylinders 21 and the pistons 22. The crankshaft 23 is coupled to the pistons 22 through connecting rods 24 so as to be rotated and driven based on the reciprocating motion of the pistons 22.

An indentation is formed in the bottom surface of the cylinder head 20b (surface opposing the cylinder block 20a). This indentation is provided at a location corresponding to the upper end of the cylinders 21. A combustion chamber CC is formed by a space inside this indentation and a space inside the cylinder head 21 above the top surface of the piston 22.

A gas passage in the form of an intake port 25 and an exhaust port 26, which communicates with the combustion chamber CC, is formed in the cylinder head 20b. The intake port 25 composes an intake passage of the invention together with a portion of the intake/exhaust system 3, and serves as a connecting portion with the cylinders 21 in the intake passage.

In addition, a valve train 27 for opening and closing the intake port 25 and the exhaust port 26 is provided in the cylinder head 20b. This valve train 27 is provided with an intake valve 27a that opens and closes the intake port 25, an exhaust valve 27b that opens and closes the exhaust port 26, and a mechanism for causing the intake valve 27a and the exhaust valve 27b to open and close at a prescribed timing. This mechanism includes an intake camshaft that drives the intake valve 27a, along with a variable intake timing device 27c that continuously varies the phase angle of the intake camshaft, and an exhaust camshaft 27d that drives the exhaust valve 27b.

Moreover, an injector 28 is installed in the internal combustion engine 2. The injector 28 is provided so as to inject fuel into the exhaust port 25.

<Intake/Exhaust System> The following provides an explanation of the configuration of the intake/exhaust system 3 connected to the internal combustion engine 2.

An intake manifold 31 is connected to the intake port 25. The intake manifold 31 is connected to a surge tank 32. The surge tank 32 is connected to an intake duct 33. Namely, the intake passage of the invention is composed of the intake port 25, the intake manifold 31, the surge tank 32 and the intake duct 33.

An intercooler 34 is installed in the intake duct 33. The intercooler 34 of this embodiment is of the air cooling type, and cools air that passes through the intake passage by exchanging heat with outside air. An air filter 35 is installed in the intake duct 33 farther upstream than the intercooler 34.

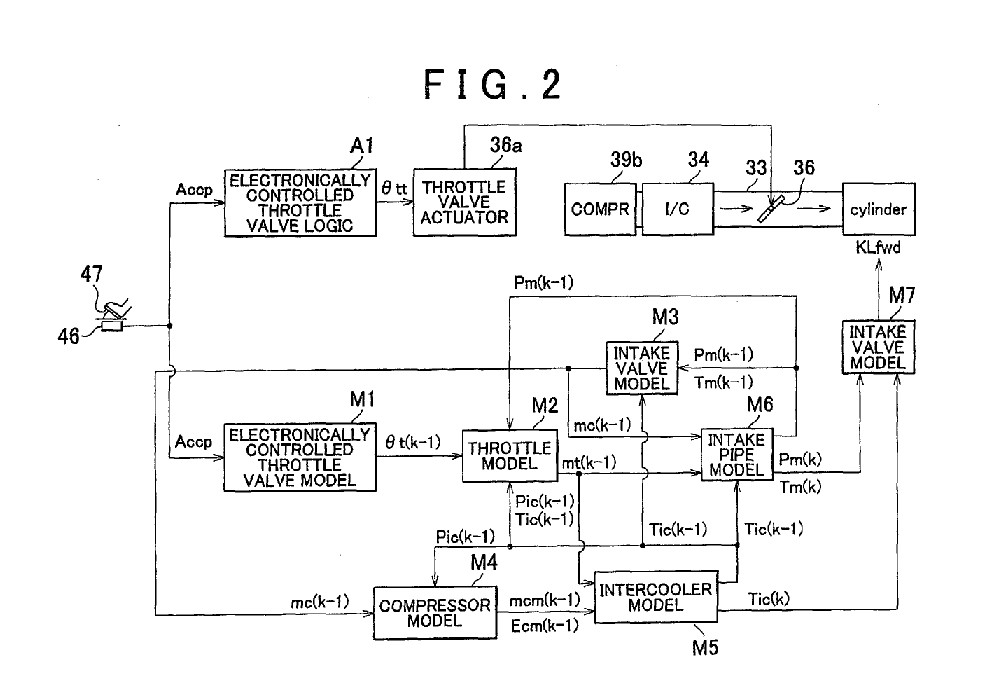

A throttle valve 36 is installed at a location between the surge tank 32 and the intercooler 34 in the intake duct 33. The throttle valve 36 is provided so as to vary the flow path cross-sectional area (opening cross-sectional area) in the intake passage, and is driven by a throttle valve actuator 36a. In this embodiment, the throttle valve actuator 36a is a DC motor. This throttle valve actuator 36a operates according to a drive signal generated and transmitted by an electronically controlled throttle valve logic A1 (see FIG. 2) to be described later achieved by the control device 4 so that an actual throttle valve opening eta becomes a target throttle valve opening θtt.

On the other hand, an exhaust pipe 37 that includes an exhaust manifold is connected to the exhaust port 26. An exhaust gas purifying catalyst 38 is installed in the exhaust pipe 37 that composes an exhaust passage together with the exhaust port 26.

In addition, a supercharger 39 is provided in the intake/exhaust system 3. The supercharger 39 in this embodiment is a so-called turbocharger, and is provided with a turbine 39a and a compressor 39b. The turbine 39a is installed farther upstream than the exhaust gas purifying catalyst 38 in the exhaust pipe 37, and is rotated and driven by exhaust gas that flows through the exhaust pipe 37. The compressor 39b is installed at a location between the intercooler 34 and the air filter 35 in the intake duct 33 (namely, farther upstream than the throttle valve 36). This compressor 39b compresses air within the intake duct 33 by being rotated and driven accompanying rotation of the turbine 39a.

<Device Configuration of Control Device> The control device 4, which is one embodiment of the internal combustion engine system control device of the invention, is composed as described below so as to control operation of the internal combustion engine system 1.

The control device 4 is provided with an electronic control unit (to be abbreviated as “ECU”) 40. The ECU 40 is provided with a CPU 40a, a read only memory (ROM) 40b, a random access memory (RAM) 40c, a backup RAM 40d, an interface 40e and a bidirectional bus 40f. The CPU 40a, the ROM 40b, the RAM 40c, the backup RAM 40d and the interface 40e are interconnected by the bidirectional bus 40f.

A routine (program) that is executed by the CPU 40a and table (map), parameters and the like that are used when executing this routine are stored in advance in the ROM 40b. The RAM 40c is able to temporarily store data as necessary when the routine is executed by the CPU 40a. The backup RAM 40d stores data when the routine is executed by the CPU 40a when the power is turned on, and is able to retain this stored data even after power is interrupted.

The interface 40e is electrically connected to various types of sensors to be described below, and signals therefrom are able to be transmitted to the CPU 40a. In addition, the interface 40e is electrically connected to operating portions such as the injector 28 and the throttle valve actuator 36a, and is able to transmit control signals for operating these operating portions to these operating portions from the CPU 40a. Namely, the ECU 40 is composed to receive signals from the each of the above-mentioned sensors and transmit the signals to each operating portion based on the result of arithmetic processing performed by the CPU 40a in accordance with those signals.

<Various Types of Sensors> A pressure sensor 41, a temperature sensor 42, a cam position sensor 43, a crank position sensor 44, a throttle position sensor 45 and an accelerator depression amount sensor 46 are provided in the internal combustion engine system 1 of this embodiment.

The pressure sensor 41 and the temperature sensor 42 are installed at a location between the air filter 35 and the compressor 39b in the intake duct 33. The pressure sensor 41 outputs a signal representing the pressure of air within the intake passage upstream from the compressor 39b in the form of intake pressure Pa. The temperature sensor 42 outputs a signal representing the temperature of air within the intake passage upstream from the compressor 39b in the form of intake temperature Ta.

The cam position sensor 43 generates a signal (G2 signal) having a single pulse for each 90° rotation of the intake camshaft described above contained in the variable intake timing device 27c (namely, for each 180° rotation of the crankshaft 23).

The crank position sensor 44 is arranged so as to oppose the crankshaft 23. This crank position sensor 44 outputs a signal of a waveform that has a pulse corresponding to the angle of rotation of the crankshaft 23 (signal corresponding to the engine rotating speed NE). More specifically, the crank position sensor 44 outputs a signal that has a narrow width pulse for each 10° rotation of the crankshaft 23 and a wide width pulse for each 360° rotation of the crankshaft 23.

The throttle position sensor 45 is provided at a location corresponding to the throttle valve 36. This throttle position sensor 45 outputs a signal that corresponds to the rotation phase of the throttle valve 36 in the form of the throttle valve opening θta.

The accelerator depression amount sensor 46 outputs a signal representing the amount of depression of an accelerator pedal 47 operated by a driver (accelerator pedal depression amount Accp).

<Function Block Configuration of Control Device> FIG. 2 is a function block diagram of the control device 4 shown in FIG. 1. As shown in FIG. 2, the control device 4 of this embodiment is provided with the above-mentioned electronically controlled throttle valve logic A1 along with an electronically controlled throttle valve model M1, a throttle model M2, an intake valve model M3, a compressor model M4, an intercooler model M5, an intake pipe model M6 and an intake valve model M7.

As will be made clear by a detailed explanation to be provided later, in this embodiment, the principal portion of in-cylinder intake air flow rate calculation means of the invention is realized by the intake valve model M3. In addition, in this embodiment, the principal portion of compressor outflow flow rate calculation means of the invention is composed by the compressor model M4. In addition, in this embodiment, the principal portion of throttle passage air flow rate calculation means of the invention is composed by the throttle model M2. In addition, in this embodiment, the principal portion of supercharging pressure calculation means of the invention is composed by the intercooler model M5. Moreover, in this embodiment, the principal portion of intake pipe internal status calculation means of the invention is composed by the intake pipe model M6.

Function of Each Block> The following provides an explanation of the functions and actions of each element shown in FIG. 2. Furthermore, since derivation of the formulas representing each model is commonly available (see, for example, Japanese Patent Application Publication No. 2001-41095 (JP-A-2001-41095) or Japanese Patent Application Publication No. 2003-184613 (JP-A-2003-184613)), a detailed explanation thereof is omitted from this description.

First, an explanation is provided of an overview of estimation of in-cylinder air amount.

In the internal combustion engine 2 of this embodiment, the injector 28 is arranged farther upstream than the intake valve 27a. Consequently, fuel must be injected by the time the intake valve 27a closes (at the time of completion of the intake stroke). Accordingly, in order to determine fuel injection amount so that the air-fuel ratio of the fuel-air mixture formed in the combustion chamber CC coincides with a target air-fuel ratio, it is necessary to estimate in advance the in-cylinder air amount when the intake valve 27a closes.

Therefore, the control device 4 of this embodiment estimates the pressure and temperature of air within the intercooler 34 (throttle valve upstream air) at a prescribed future time point relative to the current time point by using a calculation model that is constructed on the basis of physical laws, and then estimates the in-cylinder air amount at the prescribed future time point based on these estimated values.

Each model is represented by a numerical formula (also referred to as a “general formula”) that is derived on the basis of physical laws so as to represent the behavior of air at a certain point in time. Normally, values (variables) used in this general formula must all be values at a certain point in time if the values desired to be determined are values for that certain point in time. Namely, when a certain model is represented by the general formula y=f(x), for example, in order to determine the value y at a prescribed future time point relative to the current time point, the variable x must be a value at the future time point.

Here, as was previously described, the in-cylinder air amount desired to be determined is a value at a prescribed future time point relative to the current time point (arithmetic processing time point). Accordingly, values such as throttle valve opening θt, intake pressure Pa, intake temperature Ta, engine rotating speed NE and opening timing of the intake valve 27a (to be referred to as “intake valve timing VT”) used in each model as will be described later are all required to be values at a prescribed future time point relative to the current time point.

Therefore, the control device 4 of this embodiment estimates the throttle valve opening θt a prescribed future time point relative to the current time point by controlling the throttle valve 36 (the throttle valve actuator 36a) by delaying from a point in time when a target throttle valve opening was determined.

The intake pressure Pa, intake temperature Ta, engine rotating speed NE and intake valve timing VT naturally do not change that much within the short period of time from a current time point to the above-mentioned prescribed time point. Accordingly, the control device 4 respectively employs detected values at the current time point for the intake pressure Pa, intake temperature Ta, engine rotating speed NE and intake valve timing VT at the prescribed time point in the above-mentioned general formula.

As has been described above, the control device 4 of this embodiment estimates the in-cylinder air amount at a prescribed future time point relative to the current time point based on an estimated value of throttle valve opening θt at that prescribed future time point, on detected values of intake pressure Pa, intake temperature Ta, engine rotating speed NE and intake valve timing VT at the current time point, and on each model.

The following provides a detailed explanation of each of the models M1 to M7 and of the logic A1.

<Electronically Controlled Throttle Valve Model M1 and Electronically Controlled Throttle Valve Logic A1> The electronically controlled throttle valve model M1 is a model that estimates the throttle valve opening θt until a first time point after the current time point (time point following the passage of a delay time (TD) (64 ms in this example) from the current time point) based on the accelerator pedal depression amount Accp until the current time point in coordination with the electronically controlled throttle valve logic A1.

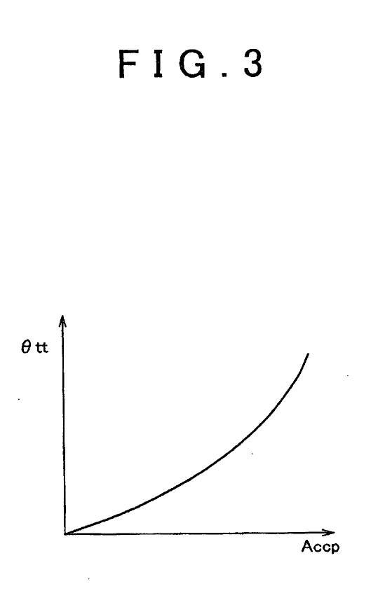

More specifically, the electronically controlled throttle valve logic A1 determines a provisional target throttle valve opening in the form of provisional target throttle valve opening θtt1 at every predetermined time ΔTt1 (2 ms in this example) based on a table that defines the relationship between the accelerator pedal depression amount Accp and a target throttle valve opening θtt shown in FIG. 3 and an actual accelerator pedal depression amount Accp that is detected by the accelerator depression amount sensor 46.

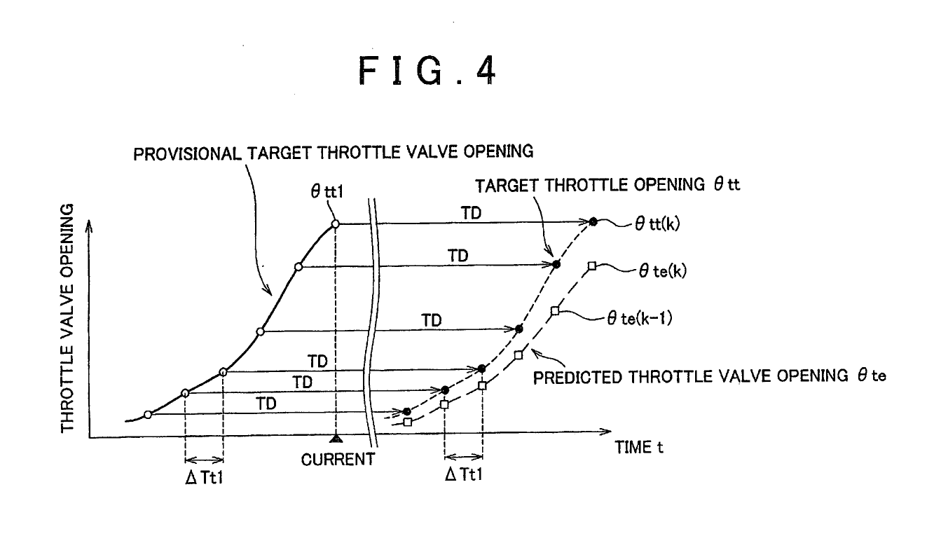

In addition, the electronically controlled throttle valve logic A1 sets the determined provisional target throttle valve opening θtt1 as the target throttle valve opening θtt at a time point following the prescribed delay time TD (first time point) as shown in the time chart of FIG. 4. Namely, the electronically controlled throttle valve logic A1 sets the provisional target throttle valve opening θtt1 determined the prescribed delay time TD ago as the current target throttle valve opening θtt. The electronically controlled throttle valve logic A1 then transmits a drive signal to the throttle valve actuator 36a so that the current throttle valve opening θta becomes the current target throttle valve opening θtt.

However, when the drive signal is transmitted from the electronically controlled throttle valve logic A1 to the throttle valve actuator 36a, the actual throttle valve opening eta follows the target throttle valve opening θtt with a certain delay due to a delay in the operation of the throttle valve actuator 36a, the inertia of the throttle valve 36 and the like. Therefore, the electronically controlled throttle valve model M1 estimates (predicts) the throttle valve opening at a time after the delay time TD based on the following formula (1) (see FIG. 4).

θte(k)=θte(k−1)+ΔTt1·f(θtt(k),θte(k−1)) (1)

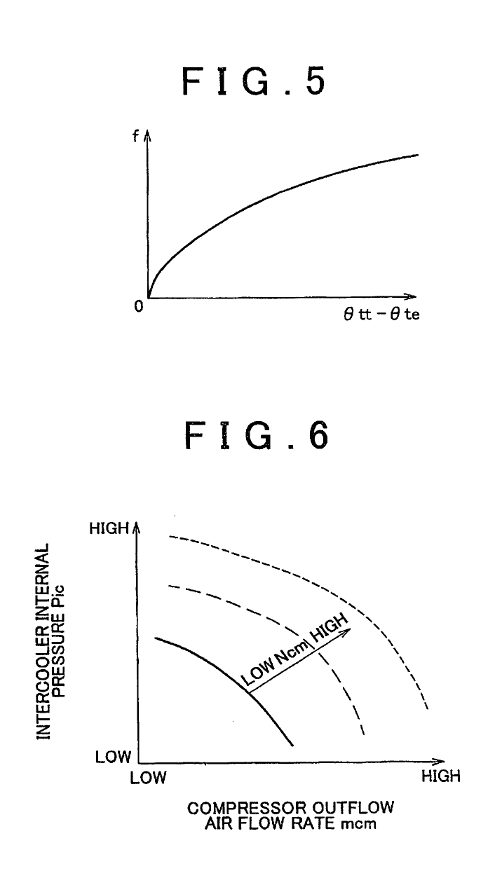

In this formula (1), θte(k) is a predicted throttle valve opening θte newly estimated at the current arithmetic processing time point, θtt(k) is the target throttle valve opening θtt newly set at the current arithmetic processing time point, and θte(k−1) is a predicted throttle valve opening θte previously estimated at the current arithmetic processing time point (namely a predicted throttle valve opening θte newly estimated at the previous arithmetic processing time point). In addition, function f(θtt, θte) is a function that returns a value that becomes larger as the difference Δθ between θtt and θte (namely, θtt−θte) increases as shown in FIG. 5 (function f that increases monotonically relative to Δθ).

In this manner, the electronically controlled throttle valve model M1 newly determines, at the current arithmetic processing time point, a target throttle valve opening θtt at the above-mentioned first time point (time point the delay time TD after the current time point), and newly estimates the throttle valve opening θte at the first time point. In addition, the electronically controlled throttle valve model M1 stores (retains) the target throttle valve opening θtt and predicted throttle valve opening θte until the first time point in the RAM 40c in a form associated with the passage of time from the current time point.

<Throttle Model M2> The throttle model M2 is a model that estimates the flow rate of air passing the periphery of the throttle valve 36 in the form of a throttle passage air flow rate mt based on general formulas representing this model in the form of formula (2) and formula (3).

$$\begin{matrix}mt = Ct ( θ t ) \cdot At ( θ t ) \cdot \frac{Pic}{\sqrt{R \cdot Tic}} \cdot Φ ( Pm / Pic ) & ( 2 ) \\ Φ ( Pm / Pic ) = ( \begin{matrix}\sqrt{\frac{κ}{2 \cdot ( κ + 1 )}} & where & \frac{Pm}{Pic} ≦ \frac{1}{κ + 1} \\ \sqrt{\begin{matrix}( \begin{matrix}\frac{κ - 1}{2 κ} ( 1 - \frac{Pm}{Pic} ) + \\ \frac{Pm}{Pic}\end{matrix} ) \\ ( 1 - \frac{Pm}{Pic} )\end{matrix}} & where & \frac{Pm}{Pic} > \frac{1}{κ + 1}\end{matrix} & ( 3 )\end{matrix}$$

In formula (2), Ct(θt) is a flow rate coefficient that changes in accordance with throttle valve opening θt, At(θt) is a throttle opening cross-sectional area (opening cross-sectional area of the periphery of the throttle valve 36 within the intake passage) that changes in accordance with the throttle valve opening θt, Pic is the pressure of air within the intercooler 34 in the form of intercooler internal pressure (namely, the pressure of air within the intake passage upstream from the throttle valve 36 in the form of throttle valve upstream pressure), Pm is the pressure of air within an intake pipe portion (portion from the throttle valve 36 to the intake valve 27a in the intake passage; to have the same meaning hereinafter) in the form of intake pipe internal pressure, Tic is the temperature of air within the intercooler 34 in the form of intercooler internal temperature (namely, the temperature of air within the intake passage upstream from the throttle valve 36 in the form of throttle valve upstream temperature), R is a gas constant, and κ is the specific heat ratio of air (κ is hereinafter treated as a constant value).

Here, Ct(θt)·At(θt), which is the product of Ct(θt) and At(θt) on the right side of formula (2), can be determined empirically based on the throttle valve opening θt. Therefore, in this embodiment, a table MAPCTAT that defines the relationship between throttle valve opening θt and Ct(θt)·At(θt) is stored in advance in the ROM 40b. The throttle model M2 determines Ct(θt)·At(θt) (namely, MAPCTAT(θt(k−1))) based on the predicted throttle valve opening θt(k−1) (namely, Step) estimated by the electronically controlled throttle valve model M1 and the above-mentioned table MAPCTAT.

Moreover, the throttle model M2 determines a value Φ (Pm(k−1)/Pic(k−1)) (namely, MAPΦ (Pm(k−1)/Pic(k−1))) from the value (Pm(k−1)/Pic(k−1)) and the table MAPΦ. Here, the value (Pm(k−1)/Pic(k−1)) is a value obtained by dividing the immediately prior (most recent) intake pipe internal pressure Pm(k−1) previously estimated by the intake pipe model M6 to be described later by the immediately prior (most recent) intercooler internal pressure (throttle valve upstream pressure) Pic(k−1) previously estimated by the intercooler model M5 to be described later. In addition, the table MAPΦ is a table that defines the relationship between the value Pm/Pic and the value Φ(Pm/Pic), and is stored in advance in the ROM 40b.

The throttle model M2 determines the throttle passage air flow rate mt(k−1) by substituting into the above-mentioned formula (2) the value of Φ(Pm(k−1)/Pic(k−1)) determined in the manner described above, the immediately prior (most recent) intercooler internal pressure (throttle valve upstream pressure) Pic(k−1) and the intercooler internal temperature (throttle valve upstream temperature) Tic(k−1) previously estimated by the intercooler model M5 to be described later.

<Intake Valve Model M3> The intake valve model M3 is a model that estimates the flow rate of air entering the cylinders 21 by passing the periphery of the intake valve 27a in the form of the in-cylinder intake air flow rate mc from the pressure of air within the intake pipe portion in the form of the intake pipe internal pressure Pm, the temperature of air inside the intake pipe portion in the form of the intake pipe internal temperature Tm, the intercooler internal temperature Tic and the like.

Pressure within the cylinders 21 (combustion chamber CC) during the intake stroke (including the time point of closing of the intake valve 27a) can be considered to be pressure upstream from the intake valve 27a, or in other words, intake pipe internal pressure Pm. Accordingly, the in-cylinder intake air flow rate mc can be considered to be proportional to the intake pipe internal pressure Pm at the time of closing of the intake valve. Therefore, the intake valve model M3 determines the in-cylinder intake air flow rate mc in accordance with a general formula representing this model in the form of the following formula (4) that is based on empirical laws.

mc=(Tic/Tm)·(c·Pm−d) (4)

In formula (4) above, the value c is a proportionality coefficient, and the value d is a value that reflects the amount of burned gas remaining in the combustion chamber CC. The value of c can be determined from a table MAPC, which defines the relationship among the engine rotating speed NE, the intake valve timing VT and a constant c, and the current engine rotating speed NE and intake valve timing VT (c=MAPC(NE,VT)). This table MAPC is stored in advance in the ROM 40b. Similarly, the value of d can be determined from a table MAPD, which defines the relationship among the engine rotating speed NE, the intake valve timing VT and a constant d, and the current engine rotating speed NE and intake valve timing VT (d=MAPC(NE,VT)). This table MAPD is also stored in advance in the ROM 40b.

The intake valve model M3 estimates the in-cylinder intake air flow rate mc(k−1) by substituting into the above-mentioned formula (4) the immediately prior (most recent) intake pipe internal pressure Pm(k−1) and the intake pipe internal temperature Tm(k−1) previously estimated by the intake pipe model M6 to be described later, and the immediately prior (most recent) intercooler internal temperature Tic(k−1) previously estimated by the intercooler model M5 to be described later.

<Compressor Model M4> The compressor model M4 is a model that estimates the flow rate of air flowing out from the compressor 39b (air supplied to the intercooler 34) in the form of a compressor outflow air flow rate mcm based on the intercooler internal pressure Pic and the in-cylinder intake air flow rate mc.

The inventors of the invention obtained the findings indicated below as a result of conducting various studies.

In terms of the supercharger 39 alone, the relationship between the compressor outflow air flow rate mcm and the intercooler internal pressure Pic (supercharging pressure) changes in various ways in accordance with a compressor rotating speed Ncm as shown in FIG. 6. Namely, a graph indicating the relationship between the compressor outflow air flow rate mcm and the intercooler internal pressure Pic in the case the compressor rotating speed Ncm is constant is in the form of a single curve (a substantially elliptical arc that opens in the direction of the origin, namely the direction downward and to the left in the drawing). However, when the compressor rotating speed Ncm increases, together with the shape of the curve changing, the position thereof also shifts in a direction that moves away from the origin.

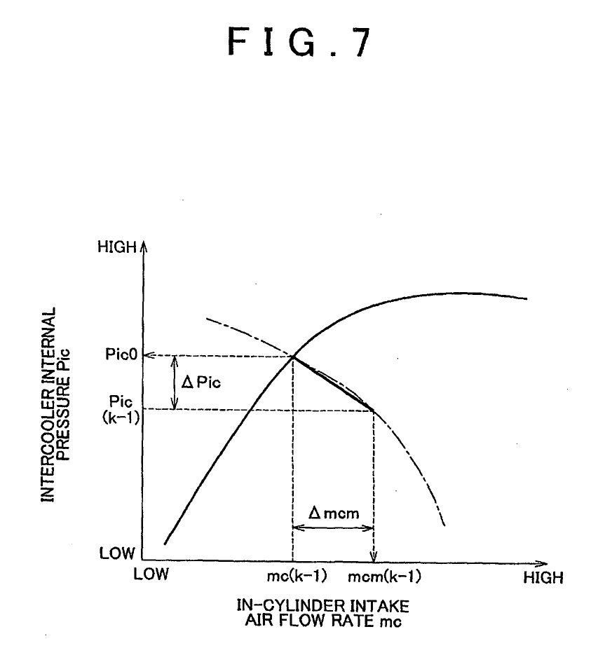

On the other hand, in terms of the internal combustion engine system 1 provided with the supercharger 39 instead of the supercharger 39 alone, the intercooler internal pressure Pic can be represented as a function of the in-cylinder intake air flow rate mc, which coincides with the compressor outflow air flow rate mcm during steady-state operation, during that steady-state operation as shown in FIG. 7 (refer to the curve represented with a narrow solid line in the drawing). Namely, a graph indicating the relationship between these two parameters during this steady-state operation is in the form of a single prescribed curve along a direction of the shift mentioned above regardless of the compressor rotating speed Ncm. Furthermore, this relationship can be determined in advance through experimentation.

Therefore, the compressor model M4 first acquires a provisional supercharging pressure Pic0 from the in-cylinder intake air flow rate mc based on the relationship indicated in FIG. 7. This provisional supercharging pressure Pic0 is a provisional value of supercharging pressure, namely the intercooler internal pressure Pic corresponding to the in-cylinder intake air flow rate mc in the case the current operating state is assumed to be steady-state operation.

Furthermore, the curve indicated with a single dot dashed line in FIG. 7 represents the relationship between the compressor outflow air flow rate mcm and the intercooler internal pressure Pic, corresponding to a certain in-cylinder intake air flow rate mc and the provisional supercharging pressure Pic0 acquired on the basis thereof, under conditions in which the compressor rotating speed Ncm is constant (see FIG. 6) (namely, the compressor rotating speed Ncm can be estimated by specifying a curve indicated with the single dot dashed line). In addition, the straight line indicated with the thick solid line in FIG. 7 is a tangent of the single dot dashed line curve at an intersect of the thin solid line curve and the single dot dashed line curve in the drawing.

During transient operation, the intercooler internal pressure Pic differs from the provisional supercharging pressure Pic0, and the compressor outflow air flow rate mcm also differs from the in-cylinder intake air flow rate mc. Accordingly, the compressor model M4 acquires a compressor outflow flow rate correction value Δmcm based on a difference ΔPic between the provisional supercharging pressure Pic0 and the intercooler internal pressure Pic, and estimates the compressor outflow air flow rate mcm by adding this correction value Δmcm to the in-cylinder intake air flow rate mc.

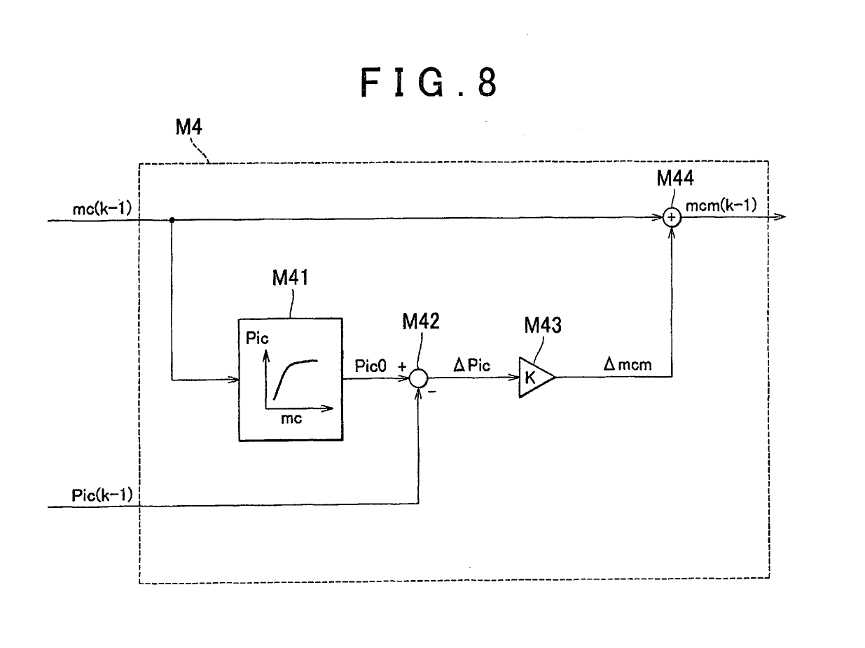

FIG. 8 is a function block diagram showing the details of the configuration of the compressor model M4 shown in FIG. 2. With reference to FIGS. 2, 7 and 8, the compressor model M4 hereinafter has a map M41 and arithmetic processing units M42 to M44.

The map M41 is a map MAPPIC0(mc) for acquiring the provisional supercharging pressure Pic0 from the in-cylinder intake air flow rate mc(k−1) previously estimated by the intake valve model M3 (see FIG. 7), and is stored in advance in the ROM 40b. The arithmetic processing unit M42 calculates the difference ΔPic between the provisional supercharging pressure Pic0 acquired using the map M41 (namely, MAPPIC0(mc(k−1))) and an immediately prior (most recent) intercooler internal pressure Pic(k−1) previously estimated by the intercooler model M5 to be described later.

The arithmetic processing unit M43 calculates a compressor outflow flow rate correction value Δmcm by multiplying a prescribed gain K by the value of ΔPic calculated with the arithmetic processing unit M42 (the gain K corresponds to the slope of the thick solid line in FIG. 7). Furthermore, this gain K is acquired based on a map stored in advance in the ROM 40b, the above-mentioned in-cylinder intake air flow rate mc(k−1) and the intercooler internal pressure Pic(k−1) (K=MAPK(mc,Pic)).

The arithmetic processing unit M44 calculates and estimates a compressor outflow air flow rate mcm(k−1) by adding the compressor outflow flow rate correction value Δmcm calculated with the arithmetic processing unit M43 to the in-cylinder intake air flow rate mc(k−1).

Referring again to FIG. 2, the compressor model M4 is a model that estimates a compressor-imparted energy Ecm. The compressor-imparted energy Ecm is determined according to a general formula representing a portion of this model in the form of the following formula (5) from a compressor efficiency η, the compressor outflow air flow rate mcm, the value of Pic/Pa (value obtained by dividing the intercooler internal pressure Pic by the intake pressure Pa) and the intake temperature Ta (refer to JP-A-2006-70881 for the process for deriving the following formula (5)).

$$Ecm = Cp \cdot mcm \cdot Ta ( {( \frac{Pic}{P a} )}^{\frac{κ - 1}{κ}} - 1 ) \frac{1}{η} \qquad ( 5 )$$

In formula (5) above, Cp is the isobaric specific heat of air. In addition, the compressor efficiency η can be estimated empirically based on the compressor outflow air flow rate mcm and the compressor rotating speed Ncm. Thus, the compressor efficiency η is determined based on a table MAPETA, which defines the relationship among the compressor outflow air flow rate mcm, the compressor rotating speed Ncm and the compressor efficiency η, the compressor outflow air flow rate mcm and the compressor rotating speed Ncm.

Here, the compressor model M4 of this embodiment accurately estimates the compressor rotating speed Ncm based on the relationships indicated in FIGS. 6 and 7 without using a compressor rotating speed detection sensor. Namely, the compressor model M4 estimates the compressor rotating speed Ncm from the immediately prior (most recent) intercooler internal pressure Pic(k−1) previously estimated by the intercooler model M5 to be described later, the compressor outflow air flow rate mcm(k−1) estimated as described above, and a map (MAPNcm(Pic,mcm)) as shown in FIG. 6 (Ncm=MAPNcm(Pic(k−1),mcm(k−1))).

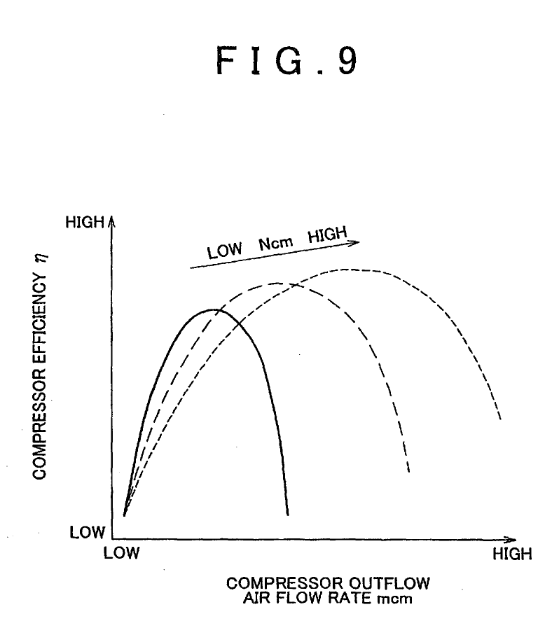

The above-mentioned table MAPETA is stored in advance in the ROM 40b (see FIG. 9). The compressor model M4 estimates compressor efficiency η(k−1) from this table MAPETA, the compressor outflow air flow rate mcm(k−1) estimated in the manner described above and the compressor rotating speed Ncm (namely MAPETA(mcm(k−1),Ncm)).

The compressor model M4 then estimates the compressor-imparted energy Ecm(k−1) by substituting into the above-mentioned formula (5) the compressor efficiency η(k−1) and the compressor outflow air flow rate mcm(k−1) estimated in the manner described above, the value of Pic(k−1)/Pa, and the current intake temperature Ta. Here, the value of Pic(k−1)/Pa is a value obtained by dividing the immediately prior (most recent) intercooler internal pressure Pic(k−1) previously estimated by the intercooler model M5 described below by the current intake pressure Pa.

<Intercooler Model M5> The intercooler model M5 is a model that determines the intercooler internal pressure Pic and the intercooler internal temperature Tic according to general formulas representing this model in the form of the following formulas (6) and (7) from the intake temperature Ta, the flow rate of air flowing into the intercooler portion (namely, the compressor outflow air flow rate mcm), the compressor-imparting energy Ecm and the flow rate of air flowing out from the intercooler portion (namely, the throttle passage air flow rate mt) (refer to JP-A-2006-70881 for the process for deriving the following formulas (6) and (7)).

Furthermore, the intercooler portion includes the intercooler 34 along with the intake passage from the outlet of the compressor 39b to the throttle valve 36. In addition, in the following formulas (6) and (7), Vic represents the volume of the intercooler portion.

d(Pic/Tic)/dt=(R/Vic)−(mcm−mt) (6)

dPic/dt=κ·(R/Vic)·(mcm·Ta−mt·Tic)+(κ−1)/(Vic)·(Ecm−K(Tic−Ta)) (7)

The intercooler model M5 estimates the most recent intercooler internal pressure Pic(k) and intercooler internal temperature Tic(k) by carrying out calculations based on formulas (6) and (7) by substituting the compressor outflow air flow rate mcm(k−1) and the compressor-imparted energy Ecm(k−1) acquired by the compressor model M4, the throttle passage air flow rate mt(k−1) acquired by the throttle model M2 and the current intake temperature Ta into the right sides of the formulas (6) and (7).

<Intake Pipe Model M6> The intake pipe model M6 is a model that determines the intake pipe internal pressure Pm and the intake pipe internal temperature Tm according to general formulas representing this model in the form of the following formulas (8) and (9) from the flow rate of air flowing into the intake pipe portion (namely, the throttle passage air flow rate mt), and intercooler internal temperature (throttle valve upstream temperature) Tic and the flow rate of air flowing out from the intake pipe portion (namely, the in-cylinder intake air flow rate mc). Furthermore, Vm represents the volume of the intake pipe portion in the following formulas (8) and (9).

d(Pm/Tm)/dt=(R/Vm)·(mt−mc) (8)

dPm/dt=κ·(R/Vm)·(mt·Tic−mc·Tm) (9)

The intake pipe model M6 estimates the most recent intake pipe internal pressure Pm(k) and intake pipe internal temperature Tm(k) by carrying out calculations based on formulas (8) and (9) by substituting the throttle passage air flow rate mt(k−1) acquired by the throttle model M2, the in-cylinder intake air flow rate mc(k−1) acquired by the intake valve model M3, and the most recent intercooler internal temperature (throttle valve upstream temperature) Tic(k) estimated by the intercooler model M5 into the right sides of the formulas (8) and (9).

<Intake Valve Model M7> The intake valve model M7 includes a model similar to the previously described intake valve model M3. The intake valve model M7 determines the most recent in-cylinder intake air flow rate mc(k) by substituting into a general formula representing this model in the form of the above-mentioned formula (4) the most recent intake pipe internal pressure Pm(k) and intake pipe internal temperature Tm(k) estimated by the intake pipe model M6, and the most recent intercooler internal temperature Tic(k) estimated by the intercooler model M5.

The intake valve model M7 then determines an estimated value of in-cylinder air amount in the form of a predicted in-cylinder air amount KLfwd by multiplying a time Tint (time from opening to closing of the intake valve 27a) calculated from the current engine rotating speed NE and the current intake valve timing VT by the in-cylinder intake air flow rate mc(k) determined in the manner previously described.

### Specific Example of Operation of the Embodiment

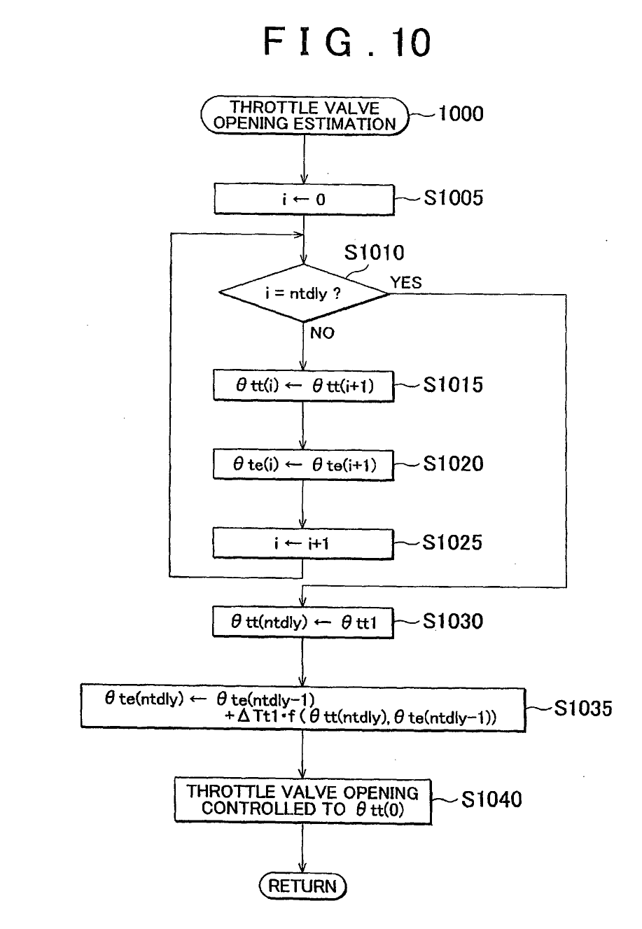

Next, an explanation is provided of a specific example of the operation of the control device 4 of this embodiment provided with the configuration described above using flow charts. Furthermore, in the drawings showing flow charts, the term “step” is abbreviated with an “S”.

<Estimation of Throttle Valve Opening> The CPU 40a executes a throttle valve opening estimation routine 1000 shown in FIG. 10 at every prescribed arithmetic processing cycle ΔTt1 (2 ms in this example).

The CPU 40a begins processing of the routine 1000 at a prescribed timing. When processing of the routine 1000 is begun, a variable i is first set to “0” in Step 1005. Next, in Step 1010, a determination is made as to whether or not the variable is equal to the number of delays ntdly. This number of delays ntdly is a value (32 in this example) obtained by dividing the delay time TD (64 ms in this example) by the arithmetic processing cycle ΔTt1.

At this point in time immediately after commencement of processing of the routine 1000, the variable i is “0”. Accordingly, the determination of Step 1010 is “No” and processing proceeds to Step 1015. In Step 1015, the CPU 40a substitutes the value of the target throttle valve opening θtt(i+1) into the target throttle valve opening θtt(i), and in the subsequent Step 1020, substitutes the value of the predicted throttle valve opening θte(i+1) into the predicted throttle valve opening θte(i). As a result of the processing as described above, the value of the target throttle valve opening θtt(1) is substituted into the target throttle valve opening θtt(0), and the value of the predicted throttle valve opening θte(1) is stored for the predicted throttle valve opening θte(0). Subsequently, the CPU 40a increases the value of the variable i by “1” in Step 1025 and then returns to the processing of Step 1010.

During the time the value of the variable i is smaller than the number of delays ntdly, Steps 1015 to 1025 are executed again. Namely, Steps 1015 to 1025 are executed repeatedly until the value of the variable i becomes equal to the number of delays ntdly. As a result, the value of the target throttle valve opening θtt(i+1) is sequentially shifted to the target throttle valve opening θtt(i), and the value of the predicted throttle valve opening θte(i+1) is sequentially shifted to the predicted throttle valve opening θte(i).

When the value of the variable i is equal to the number of delays ntdly, the determination of Step 1010 becomes “Yes” and processing proceeds to Step 1030. In Step 1030, the CPU 40a determines the current provisional target throttle valve opening θtt1 based on the current accelerator pedal depression amount Accp and the table of FIG. 3, and stores this for the target throttle valve opening θtt(ntdly) in order to make this the target throttle valve opening θtt after the delay time TD.

Subsequently, processing proceeds to Step 1035. In this Step 1035, the CPU 40a calculates the predicted throttle valve opening θte(ntdly) after the delay time TD from the current time based on the predicted throttle valve opening θte(ntdly−1) stored at the time of the previous arithmetic processing, the target throttle valve opening θtt(ntdly) stored in Step 1030, and the above-mentioned formula (1) (refer to the formula shown in Step 1035 in FIG. 10). The CPU 40a then transmits a drive signal to the throttle valve actuator 36a in Step 1040 so that the actual throttle valve opening θta becomes the target throttle valve opening θtt(0), after which this routine temporarily ends.

As has been described above, in the memory relating to the target throttle valve opening θtt (RAM 40c), the contents of that memory are shifted by one each time this routine is executed. The value stored for the target throttle valve opening θtt(0) is then set as the target throttle valve opening θtt output to the throttle valve actuator 36a by the electronically controlled throttle valve logic A1.

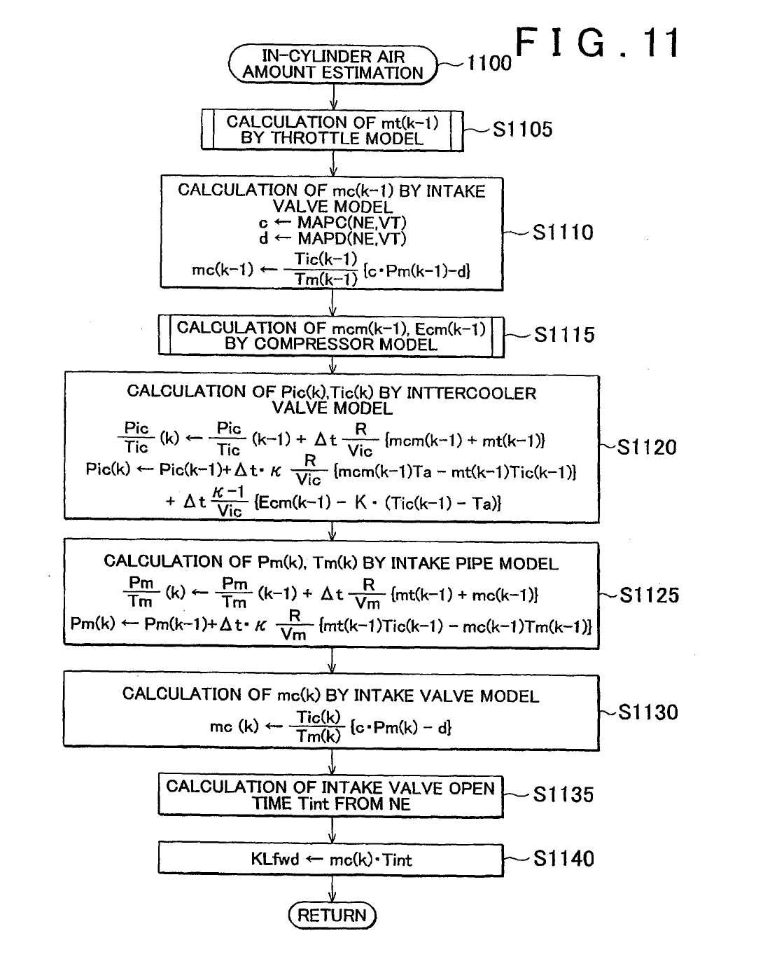

Namely, the value stored for the target throttle valve opening θtt(ntdly) as a result of current execution of this routine is stored for θtt(0) after this routine 1100 has been repeated by the number of delays ntdly (after the delay time TD). In addition, in the memory relating to the predicted throttle valve opening θte (RAM 40c), the predicted throttle valve opening θte after the passage of a predetermined time (m·ΔTt) from the current time is stored for θte(m) in that same memory. The value of m in this case is an integer from 0 to ntdly.

<Estimation of In-cylinder Air Volume> On the other hand, the CPU 40a estimates the in-cylinder air amount (predicted in-cylinder air amount KLfwd) at a time point after the current time by executing an in-cylinder air amount estimation routine shown in FIG. 11 at every prescribed arithmetic processing cycle ΔTt2 (8 ms in this example).

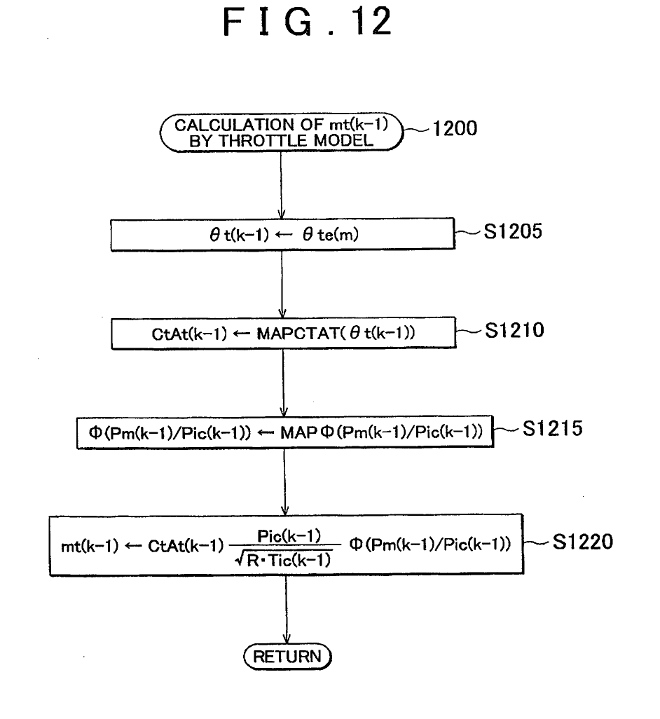

More specifically, the CPU 40a begins processing of the routine 1100 at a prescribed timing. When processing of the routine 1100 is begun, processing first proceeds to a routine 1200 indicated in the flow chart of FIG. 12 in order to determine the throttle passage air flow rate mt(k−1) by the above-mentioned throttle model M2 in Step 1105.

In the routine 1200, the CPU 40a, in Step 1205, first reads the predicted throttle valve opening θte(m), which was estimated as the throttle valve opening at a time closest to the current time after a prescribed time interval Δtθ from the current time, as the predicted throttle valve opening θt(k−1) from the value of θte(m) stored in memory as a result of executing the above-mentioned routine 1000. Here, in this example, the prescribed time interval Δtθ is the amount of time from a prescribed time point prior to start of fuel injection in a specific cylinder (final time point by which fuel injection amount need to be determined) to closure of the intake valve 27a in the intake stroke of that same cylinder (second time point).

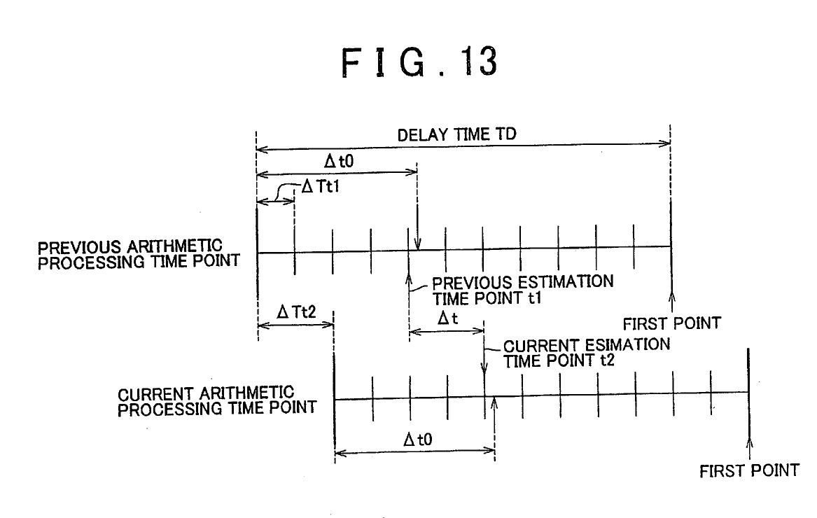

For the sake of convenience in subsequent explanations, the time point corresponding to the predicted throttle valve opening θt(k−1) at the time of the previous arithmetic processing is designated as the previous estimation time point t1, and the time point corresponding to the predicted throttle valve opening θt(k−1) at the time of the current arithmetic processing is designated as the current estimation time point t2 (refer to FIG. 13, which is a schematic diagram showing the relationship among the first time point, the prescribed time interval Δtθ, the previous estimation time point t1 and the current estimation time point t2).

Next, processing proceeds to Step 1210, and the CPU 40a determines Ct(θt)·At(θt) of the above-mentioned formula (2) from the table MAPCTAT and the predicted throttle valve opening θt(k−1). Next, processing proceeds to Step 1215, and the CPU 40a-determines the value Φ(Pm(k−1)/Pic(k−1)) from the value of (Pm(k−1)/Pic(k−1)) and the table MAPΦ. Here, the value (Pm(k−1)/Pic(k−1)) is a value obtained by dividing the intake pipe internal pressure Pm(k−1) at the previous estimation time point t1 determined in Step 1125 to be described later during previous execution of the routine of FIG. 11, by the intercooler internal pressure Pic(k−1) at the previous estimation time point t1 determined in Step 1120 to be described later during previous execution of the routine of FIG. 11.

Subsequently, processing proceeds to Step 1220, and the CPU 40a determines the throttle passage air flow rate mt(k−1) at the previous estimation time point t1 based on the values respectively determined in Steps 1210 and 1215, the above-mentioned formula (2) representing the throttle model M2 (refer to the formula shown in Step 1220 in FIG. 12), and the intercooler internal pressure Pic(k−1) and intercooler internal temperature Tic(k−1) at the previous estimation time point t1 determined in Step 1120 to be described later during previous execution of the routine of FIG. 11. This routine 1200 then temporarily ends and processing proceeds to Step 1110 of FIG. 11.

In Step 1110, the CPU 40a determines a coefficient c of the above-mentioned formula (4) that represents the intake valve model M3 (refer to the formula shown in Step 1110 in FIG. 11) from the table MAPC, the current engine rotating speed NE and the current intake valve timing VT. Similarly, the CPU 40a determines a value d of the formula (4) from the table MAPD, the current engine rotating speed NE and the current intake valve timing VT. Moreover, the CPU 40a determines the in-cylinder intake air flow rate mc(k−1) at the previous estimation time point t1 based on the formula (4), the intercooler internal temperature Tic(k−1) at the previous estimation time point t1 determined in Step 1120 to be described later during the previous execution of this routine, and the intake pipe internal pressure Pm(k−1) and intake pipe internal temperature Tm(k−1) at the previous estimation time point t1 determined in Step 1125 to be described later during the previous execution of this routine.

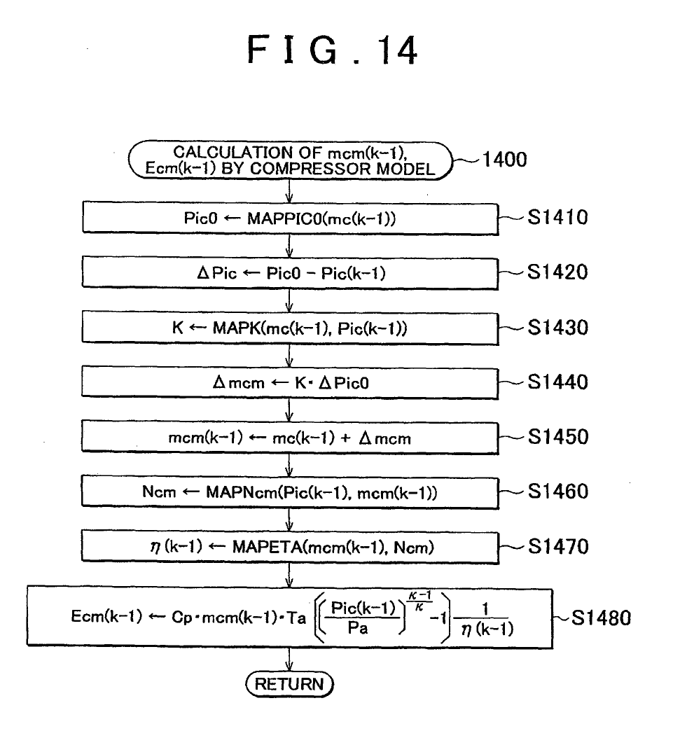

Next, processing proceeds to Step 1115, and then proceeds to the processing of a routine 1400 indicated in the flow chart of FIG. 14 to determine the compressor outflow air flow rate mcm(k−1) and the compressor-imparted energy Ecm(k−1) with the compressor model M4.

In the routine 1400, the CPU 40a acquires the provisional supercharging pressure Pic0 in Step 1410 based on the in-cylinder intake air flow rate mc(k−1) at the previous estimation time point t1 acquired in the Step 1110 and the above-mentioned map MAPPIC0(mc). Next, processing proceeds to Step 1420, and the CPU 40a calculates the difference ΔPic between this provisional supercharging pressure Pic0 and the intercooler internal pressure Pic(k−1) at the previous estimation time point t1 determined in Step 1120 to be described later during the previous execution of the routine of FIG. 11.

Subsequently, processing proceeds to Step 1430, and the CPU 40a acquires the gain K based on the intercooler internal pressure Pic(k−1), the in-cylinder intake air flow rate mc(k−1) at the previous estimation time point t1, and the above-mentioned map MAPK(mc,Pic). Next, processing proceeds to Step 1440, and the CPU 40a calculates the compressor outflow flow rate correction value Δmcm by multiplying this gain K and the above-mentioned value ΔPic. Next, processing proceeds to Step 1450, and the CPU 40a determines the compressor outflow air flow rate mcm(k−1) at the previous estimation time point t1 by adding the correction value Δmcm calculated in Step 1440 to the in-cylinder intake air flow rate mc(k−1) at the previous estimation time point t1.

Subsequently, processing proceeds to Step 1460, and the CPU 40a estimates the compressor rotating speed Ncm based on the intercooler internal pressure Pic(k−1), the compressor outflow air flow rate mcm(k−1), and the above-mentioned map MAPNcm(Pic,mcm). Subsequently, the CPU 40a determines the compressor efficiency η(k−1) in Step 1470 based on the table MAPETA and the compressor rotating speed Ncm estimated in Step 1460.

Moreover, processing proceeds to Step 1480, and the CPU 40a determines the compressor-imparted energy Ecm(k−1) at the previous estimation time point t1 based on the value of Pic(k−1)/Pa, which is obtained by dividing the intercooler internal pressure Pic(k−1) at the previous estimation time point t1 determined in Step 1120 to be described later during the previous execution of the routine of FIG. 11 by the current intake pressure Pa, the compressor outflow air flow rate mcm(k−1) determined in Step 1450, the compressor efficiency η(k−1) determined in Step 1470, the current intake temperature Ta, and the above-mentioned formula (5) representing a portion of the compressor model M4 (refer to the formula shown in Step 1420 in FIG. 14). This routine 1400 then ends temporarily, and processing proceeds to Step 1120 of FIG. 11.

In Step 1120, the CPU 40a determines the intercooler internal pressure Pic(k) at the current estimation time point t2, and the value {Pic/Tic}(k), which is obtained by dividing this intercooler internal pressure Pic(k) by the intercooler internal temperature Tic(k) at the current estimation time point t2, based on a formula obtained by discretizing the formulas (6) and (7) representing the intercooler model M5 (difference equation; refer to the formula shown in Step 1120 in FIG. 11), the throttle passage air flow rate mt(k−1), the compressor outflow air flow rate mcm(k−1), and the compressor-imparted energy Ecm(k−1) determined in Steps 1105 and 1115.

Furthermore, Δt is a discrete interval used in calculations by this intercooler model M5 (Step 1120) and in calculations by the intake pipe model M6 to be described later (Step 1125), and is represented by the following formula: Δt=t2−t1.

Namely, in Step 1120, the intercooler internal pressure Pic(k) and intercooler internal temperature Tic(k) at the current estimation time point t2 are determined from the intercooler internal pressure Pic(k−1) and intercooler internal temperature Tic(k−1) at the previous estimation time point t1.

Next, processing proceeds to Step 1125, and the CPU 40a determines the Pm(k) at the current estimation time point t2, and the value {Pm/Tm}(k), which is obtained by dividing the intake pipe internal pressure Pm(k) at the current estimation time point t2 by the intake pipe internal temperature Tm(k) at the current estimation time point t2, based on a formula obtained by discretizing the formulas (8) and (9) that represent the intake pipe model M6 (difference equation; refer to the formula shown in Step 1125 in FIG. 11), the throttle passage air flow rate mt(k−1) and the in-cylinder intake air flow rate mc(k−1) respectively determined in Steps 1105 and 1110, and the intercooler internal temperature Tic(k−1) at the previous estimation time point t1 determined in Step 1120 during the previous execution of this routine. Namely, in Step 1125, the intake pipe internal pressure Pm(k) and intake pipe internal temperature Tm(k) at the current estimation time point t2 are determined from the intake pipe internal pressure Pm(k−1) and the intake pipe internal temperature Tm(k−1) at the previous estimation time point t1.

Subsequently, processing proceeds to Step 1130, and the CPU 40a determines the in-cylinder intake air flow rate mc(k) at the current estimation time point t2 using the above-mentioned formula (4) that represents the intake valve model M7. At this time, the values determined in Step 1110 are used for the coefficient c and the value d. In addition, the values (most recent values) at the current estimation time point t2 respectively determined in Steps 1120 and 1125 are used for the intercooler internal temperature Tic(k), the intake pipe internal pressure Pm(k) and the intake pipe internal temperature Tm(k).

The CPU 40a then calculates an intake valve open time (time from opening to closing of the intake valve 27a) Tint in Step 1135 that is determined according to the current engine rotating speed NE and the current intake valve timing VT, and further calculates the predicted in-cylinder air amount KLfwd in the subsequent Step 1140 by multiplying the intake valve open time Tint by the in-cylinder intake air flow rate mc(k) at the current estimation time point t2, after which this routine temporarily ends.

The following provides an additional explanation of the predicted in-cylinder air amount KLfwd calculated in the manner described above. Here, for the sake of explanation, the arithmetic processing cycle ΔTt2 of the in-cylinder air amount estimation routine of FIG. 11 is assumed to be sufficiently shorter than the time in which the crankshaft 23 rotates 360°, and the prescribed time internal Δt0 is assumed to not change greatly.

At this time, the current estimation time point t2 shifts to a future time point by approximately the length of the arithmetic processing cycle ΔTt2 each time execution of the in-cylinder air amount estimation routine 1100 is repeated. When this routine is then executed at a prescribed time point (final time point by which fuel injection amount need to be determined) prior to the start of fuel injection of a specific cylinder, the current estimation time point t2 substantially coincides with the above-mentioned second time point (time of closure of the intake valve 27a in the intake stroke of that cylinder). Thus, the predicted in-cylinder air amount KLfwd calculated at this point in time becomes the estimated value of the in-cylinder air quantity at the second time point.

<Action and Effects of the Embodiment> As has been described above, the control device 4 of this embodiment calculates the in-cylinder intake air flow rate mc using intake system parameters, which can be acquired (measured or calculated) more accurately than exhaust system parameters, and air models (such as an intake valve model), and calculates the compressor outflow air flow rate mcm based on the calculated in-cylinder intake air flow rate mc and a prescribed relationship as shown in FIG. 7. Thus, according to the configuration of this embodiment, the compressor outflow air flow rate mcm and the predicted in-cylinder air amount KLfwd can be estimated more accurately.

In addition, when the control device 4 of this embodiment calculates the compressor outflow air flow rate mcm and the predicted in-cylinder air amount KLfwd, instead of the output values of an air flow rate sensor, the throttle passage air flow rate mt, which is estimated by the throttle model M2, is used. Thus, according to the configuration of this embodiment, the compressor outflow air flow rate mcm and the predicted in-cylinder air amount KLfwd can be estimated with even greater accuracy.

Moreover, in the control device 4 of this embodiment, the compressor model M4 and the intercooler model M5 are constructed without using a compressor rotating speed detection sensor. Thus, according to this embodiment, highly accurate estimation of the compressor outflow air flow rate mcm and the predicted in-cylinder air amount KLfwd can be carried out with a simple and highly reliable system configuration.

<Examples of Variations> Furthermore, as has been described above, the applicant has merely illustrated a typical embodiment of the invention considered to be the best mode for carrying out the invention at the time of filing. Accordingly, the invention is naturally not limited in any way to the embodiment described above. Thus, it goes without saying that various modifications with respect to the embodiment described above can be carried out within a range that does not deviate from the essential portions of the invention.

The following provides a description of several examples of typical variations. It goes without saying that the variations are not limited to those listed below. In addition, all or a portion of a plurality of variations can be suitably mutually combined within a range that is not technically conflicting. The invention (and particularly that represented in terms of action or function among each of the constituents that compose the means for solving the problems of the invention) should not be considered as limiting based on the descriptions of the above-mentioned embodiment or the following variations. Such a limiting interpretation is not permitted since it unfairly impedes the benefit of the applicant (who is hurrying with filing because of the first-to-file rule) while conversely benefiting imitators.

(A) The invention is not limited to the specific device configuration indicated in the above-mentioned embodiment.

For example, the invention can be applied to a gasoline engine, diesel engine, methanol engine, bioethanol engine or any other type of internal combustion engine. There are also no particular limitations on the number of cylinders or cylinder arrangement (in-line, V-type or boxer type).

The intercooler 34 may also be of the water-cooled type. Alternatively, the intercooler 34 may be absent. The supercharger 39 may also be of a type other than a turbocharger type.

(B) In addition, the invention is also not limited to the specific functions and operation indicated in the above embodiment.

For example, the delay time TD is not required to be a constant time, but rather may be a variable amount of time that corresponds to the engine rotating speed NE (for example, the time required for the crankshaft 23 to rotate by a prescribed angle).

In the case the throttle valve 36 is not provided in the internal combustion engine system 1, parameters required for calculation in another model such as the compressor model M4 can be generated by constructing a calculation model that is obtained by appropriately transforming the intake valve model M3 and/or the intake pipe model M6 instead of the throttle model M2. This applies similarly in the case of not providing the intercooler 34.

In the case the actual throttle valve opening eta becomes the target throttle valve opening θtt with substantially no delay from the time a drive signal is transmitted to the throttle valve actuator 36a, the following formula may be used instead of formula (1): θte(k)=θtt(k).

Instead of the intercooler internal pressure Pic in FIGS. 6 and 7, the value of Pic/Pa, which is the ratio between the intercooler internal pressure Pic and the intake pressure Pa, can be used as the “supercharging pressure” of the invention.

In the compressor model M4 of the embodiment described above, the compressor rotating speed Ncm is estimated in order to estimate the compressor-imparted energy Ecm. Namely, the compressor model M4 in the embodiment described above includes compressor rotation speed estimation means.

In the case the compressor rotating speed Ncm is estimated by a compressor model as previously described, by applying this to the configuration disclosed in JP-A-2006-70881, the compressor rotating speed estimation means can be omitted from this configuration. More specifically, in providing an explanation in line with this description, the compressor model M4 is able to calculate and estimate the compressor outflow air flow rate mcm(k−1) based on the compressor rotating speed Ncm, the intercooler internal pressure Pic and the map of FIG. 6 by acquiring the provisional supercharging pressure Pic0 based on the relationship of FIG. 7 and the calculated value of in-cylinder intake air flow rate mc(k−1), and then acquiring the compressor rotating speed Ncm from this provisional supercharging pressure Pic0, the calculated value of in-cylinder intake air flow rate mc(k−1) and the map of FIG. 6.

Namely, the “provisional supercharging pressure” in the “compressor outflow flow rate estimation means” of the invention can be said to be equivalent to the “compressor rotating speed”.

In the case the response delay of the supercharger 39 cannot be ignored, the response delay can be favorably compensated by reflecting the response delay in the calculated value of the compressor outflow air flow rate mcm.

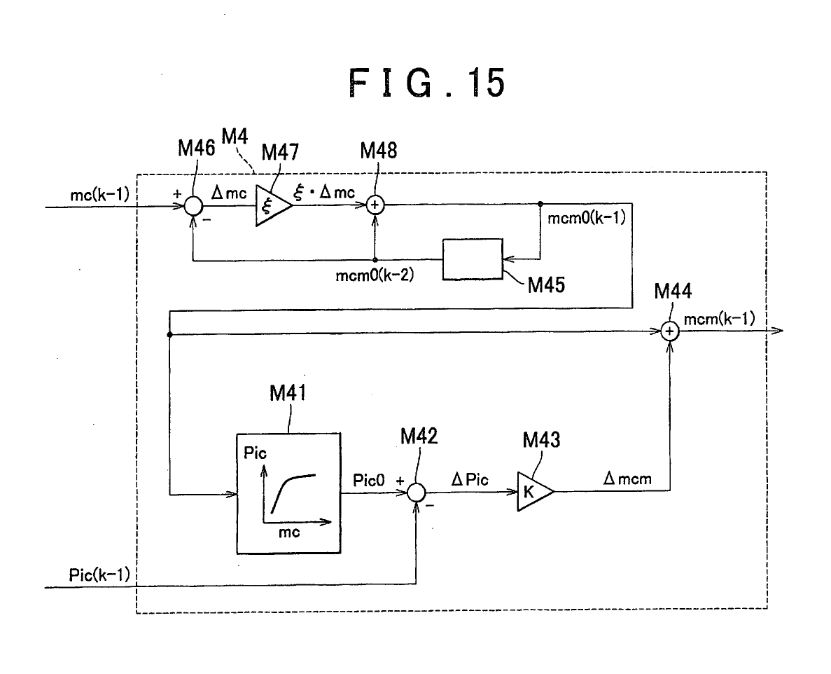

FIG. 15 is a function block diagram corresponding to this variation that shows a variation of the compressor model M4 shown in FIG. 8. In this variation, the compressor model M4 reflects the response delay of the supercharger 39 in the calculated value of the in-cylinder intake air flow rate mc serving as a basis for calculation of the compressor outflow air flow rate mcm.

More specifically, the compressor model M4 is provided with a delay memory M45 and arithmetic processing units M46 to M48, and acquires a provisional compressor outflow air flow rate mcm0 by smoothing the in-cylinder intake air flow rate mc.

The delay memory M45 outputs the previous value of mcm0(k−2) of the provisional compressor outflow air flow rate mcm0(k−1). The arithmetic processing unit M46 outputs a difference Δmc between the in-cylinder intake air flow rate mc(k−1) and the value of mcm0(k−2) output from the delay memory M45. The arithmetic processing unit M47 outputs the result of multiplying a smoothing coefficient by this difference Δmc. The arithmetic processing unit M48 outputs the current provisional compressor outflow air flow rate mcm0(k−1) by adding the output value of the arithmetic processing unit M47 and the value of mcm0(k−2). This provisional compressor outflow air flow rate mcm0(k−1) is then sequentially stored in the delay memory M45 constructed in the RAM 40c.

The following provides an explanation of a second embodiment of the invention with reference to the drawings. The second embodiment is similar to the first embodiment with the exception of a portion of the configuration of the control device. Consequently, the explanation focuses primarily on those aspects of the second embodiment that differ from the first embodiment, and explanations of those portions that are the same are omitted.

<Function Block Configuration of Control Device> FIG. 2 is a function block diagram of the control device 4 shown in FIG. 1. As shown in FIG. 2, the control device 4 of this embodiment is provided with the above-mentioned electronically controlled throttle valve logic A1, an electronically controlled throttle valve model M1, a throttle model M2, an intake valve model M3, a compressor model M4, an intercooler model M5, an intake pipe model M6 and an intake valve model M7.

As will be made clearer by an explanation to be provided later, in this embodiment, the principal portion of in-cylinder intake air flow rate acquisition means of the invention is realized by the throttle model M2, the intake valve model M3 and the intake pipe model M6, the principal portions of provisional intake air amount acquisition means and compressor rotating speed estimation means of the invention are composed by the compressor model M4, and the principal portion of supercharging pressure acquisition means is composed by the intercooler model M5.

In addition, in this embodiment, the principal portions of provisional in-cylinder intake air flow rate acquisition means, provisional supercharging pressure acquisition means and compressor outflow flow rate acquisition means are composed by the compressor model M4, the principal portion of throttle passage air flow rate acquisition means of the invention is composed by the throttle model M2, and the principal portion of intake pipe internal status acquisition means of the invention is composed by the intake pipe model M6.

<Explanation of Contents and Functions of Each Block> The following provides an explanation of those portions of the second embodiment that differ from the first embodiment with respect to the contents and functions of each block shown in FIG. 2.

<Compressor Model M4> The compressor model M4 is a calculation model that estimates the flow rate of air flowing out from the compressor 39b (air supplied to the intercooler 34) in the form of a compressor outflow flow rate mcm based on the immediately prior (most recent) in-cylinder intake air flow rate mc(k−1) previously estimated by the intake valve model M3, and the immediately prior (most recent) intercooler internal pressure Pic(k−1) previously estimated by the intercooler model M5 to be described later.

<Basic Principle of Compressor Model> The inventors of the invention obtained the findings indicated below as a result of conducting various studies.

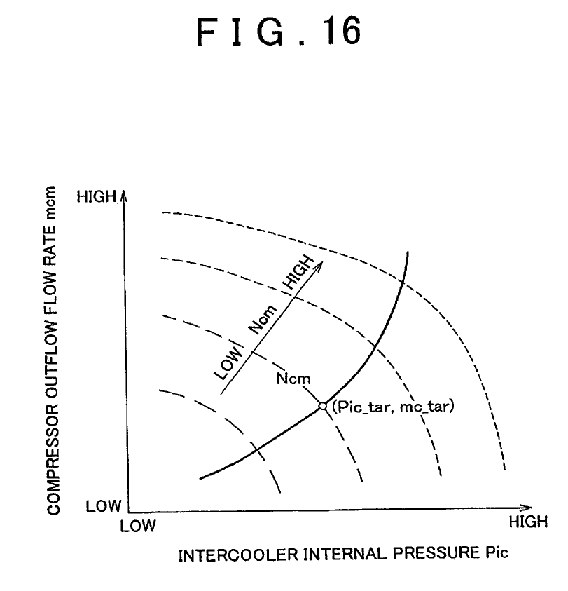

(1) In general, in terms of the supercharger 39 alone, the relationship between the intercooler internal pressure Pic (supercharging pressure) and the compressor outflow flow rate mem changes in various ways in accordance with the compressor rotating speed Ncm as shown in FIG. 16.

Namely, the relationship between the compressor outflow flow rate mcm and the intercooler internal pressure Pic in the case the compressor rotating speed Ncm is constant is in the form of a single curve (compressor characteristic curve) in the shape of a substantially elliptical arc that opens in the direction of the origin (direction downward and to the left in FIG. 16) in the case the intercooler internal pressure Pic and the compressor outflow flow rate mcm are used for the coordinate axes.

As shown in FIG. 16, the shape and position of this compressor characteristic curve in the intercooler internal pressure Pic-compressor outflow flow rate mcm coordinate system changes in accordance with the compressor rotating speed Ncm. More specifically, when the compressor rotating speed Ncm increases, the compressor characteristic curve shifts to the outside (direction moving away from the origin). A plurality of compressor characteristic curves corresponding to different compressor rotating speeds Ncm are arranged in the form of substantially concentric elliptical arcs.

On the other hand, in terms of the internal combustion engine system 1 provided with the supercharger 39 instead of the supercharger 39 alone, the intercooler internal pressure Pic can be represented as a function of the in-cylinder intake air flow rate mc, which coincides with the compressor outflow flow rate mcm during steady-state operation, during that steady-state operation thereof. Namely, the relationship between these two parameters during this steady-state operation (intake amount-supercharging pressure steady-state relationship) is in the form of a single curve that intersects one time each with the plurality of compressor characteristic lines arranged in the form of substantially concentric elliptical arcs as previously described regardless of the compressor rotating speed Ncm (intake amount-supercharging pressure steady-state curve; refer to the curve indicated with a solid line in FIG. 16). Furthermore, the intake amount-supercharging pressure steady-state relationship and the intake amount-supercharging pressure steady-state curve can be acquired in advance through experimentation (bench test).

A single specific point on this intake amount-supercharging pressure steady-state curve indicates the compressor outflow flow rate mcm (namely, the in-cylinder intake air flow rate mc) and the intercooler internal pressure Pic for a specific operating state that satisfies the conditions of steady-state operation. The compressor rotating speed Ncm during this operating state is uniquely determined. Namely, a single specific point on the intake amount-supercharging pressure steady-state curve is an intersect between a single compressor characteristic curve corresponding to the compressor rotating speed Ncm in the specific operating state and the intake amount-supercharging pressure steady-state curve (refer to the circle in FIG. 16).

Thus, if it were possible to accurately estimate the compressor rotating speed Ncm, the intercooler internal pressure Pic and the compressor outflow flow rate mcm (namely, the provisional supercharging pressure. Pic_tar and the provisional in-cylinder intake air flow rate mc_tar) in the above-mentioned specific operating state corresponding to this estimated value could be specified. The use thereof makes it possible to accurately estimate the actual compressor outflow flow rate mcm during an actual operating state that does not satisfy the conditions of steady-state operation.

Namely, the actual compressor outflow flow rate mcm is acquired by correcting the provisional in-cylinder intake air flow rate mc_tar premised on steady-state operation, based on a shift of the actual operating state from the steady-state operation. More specifically, with reference to FIG. 17, the actual compressor outflow flow rate mcm is calculated by correcting the provisional in-cylinder intake air amount mc_tar with a correction value Δmcm calculated from the product of ΔPic (difference between the provisional supercharging pressure Pic_tar and the intercooler internal pressure Pic) and a prescribed coefficient K.

However, as shown in FIG. 17, the actual compressor outflow flow rate mcm to be acquired ought to be a value corresponding to a single point on the compressor characteristic curve corresponding to a specific compressor rotating speed Ncm.

Here, in the case the value of the above-mentioned coefficient K is assumed to be a constant value determined by the provisional supercharging pressure Pic_tar (such as the slope of a tangent to the compressor characteristic curve for the provisional supercharging pressure Pic_tar), when ΔPic is sufficiently small, the error between the acquired compressor outflow flow rate mcm and an actual value is small. However, this error becomes large when ΔPic is large.

Therefore, in this embodiment, the coefficient K is determined based on the provisional supercharging pressure Pic_tar and ΔPic. Namely, the coefficient K is determined based on a table MAPK(Pic_tar, ΔPic) stored in the RAM 40b.

(2) In the internal combustion engine system 1 provided with the supercharger 39, the response delay of the supercharger 39 cannot be ignored. Accordingly, it is necessary to use values for the piovisional in-cylinder intake air flow rate mc_tar and the provisional supercharging pressure Pic_tar that take this response delay of the supercharger 39 into consideration.

When considering this response delay, a point on the intake amount-supercharging pressure steady-state curve corresponding to the current actual compressor rotating speed Ncm (Pic_tar,mc_tar; the circle in FIG. 17) can be assumed to be located between a first point corresponding to the current in-cylinder intake air flow rate mc (white diamond in FIG. 17) and a second point corresponding to the current intercooler internal pressure Pic (black diamond in FIG. 17).

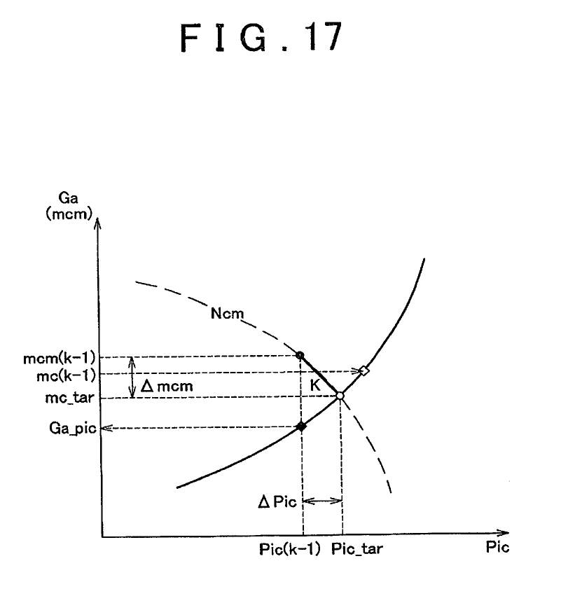

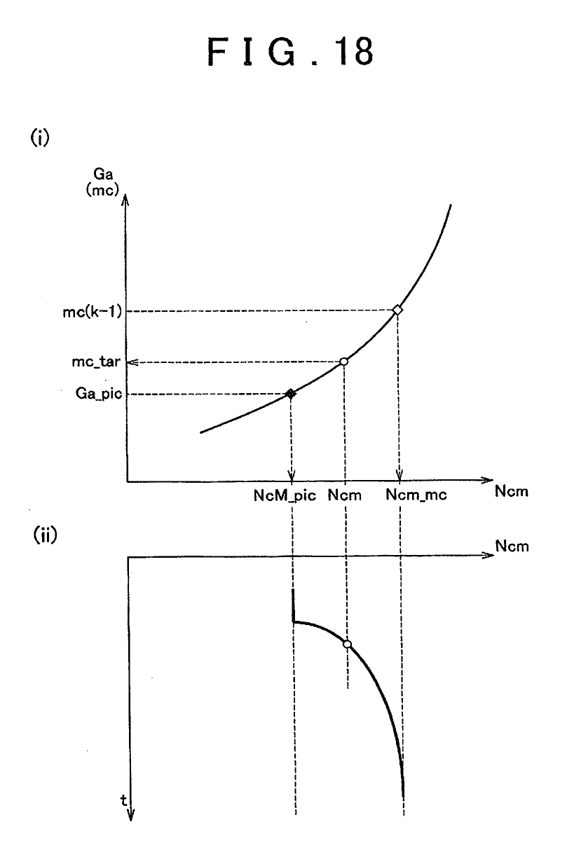

Here, during steady-state operation in the internal combustion engine system 1 provided with the supercharger 39 (an intake air amount Ga and the in-cylinder intake air flow rate mc coincide at this time), the compressor rotating speed Ncm is represented as a function of the mass flow rate of intake air in the intake passage in the form of the intake air amount Ga (intake amount-rotating speed steady-state curve) as shown in FIG. 18(i).

Accordingly, a point on the intake amount-rotating speed steady-state curve corresponding to the current actual compressor rotating speed Ncm (circle in FIG. 18(i)) can be assumed to be located between a first point corresponding to the current in-cylinder intake air flow rate mc (white diamond in FIG. 18(i)), and a second point corresponding to a provisional intake air amount Ga_pic (see FIG. 17) acquired from the current intercooler internal pressure Pic and the intake amount-supercharging pressure steady-state curve (black diamond in FIG. 18(i)). The current actual compressor rotating speed Ncm can then be accurately estimated on the basis thereof.

More specifically, with reference to FIG. 18(i), a first provisional rotating speed Ncm_mc is acquired based on the current in-cylinder intake air flow rate mc and the intake amount-rotating speed steady-state relationship. In addition, a second provisional rotating speed Ncm_pic is acquired based on the provisional intake air amount Ga_pic and the intake amount-rotating speed steady-state relationship.

As shown in FIG. 18(ii), an estimated value of the compressor rotating speed Ncm (circle) is acquired by estimating a transient change in the compressor rotating speed Ncm based on the first provisional rotating speed Ncm_mc and the second provisional rotating speed Ncm_pic by using a dead time and a primary delay as parameters that take into consideration delay with respect to step-wise changes. These dead time and primary delay can be acquired in advance by modeling various changes in rotating speed in bench tests using a bench testing system equipped with a compressor rotating speed sensor.

<Block Diagram of Compressor Model> FIG. 19 is a function block diagram showing the details of a configuration relating to acquisition of the compressor outflow flow rate mcm in the compressor model M4 shown in FIG. 2. With reference to FIG. 19, a provisional intake air amount acquisition unit M241, a compressor rotating speed estimation unit M242, a provisional in-cylinder intake air flow rate acquisition unit M243, a provisional supercharging pressure acquisition unit M244 and arithmetic processing units M245 to M247 are included in the compressor model M4.

The provisional intake air amount acquisition unit M241 acquires the provisional intake air amount Ga_pic based on an intake amount-supercharging pressure steady-state map that defines the intake amount-supercharging pressure steady-state relationship (refer to the solid line curve in FIG. 17) and the immediately prior (most recent) intercooler internal pressure Pic(k−1) previously estimated by the intercooler model M5 to be described later.

The compressor rotating speed estimation unit M242 estimates the compressor rotating speed Ncm based on the in-cylinder intake air flow rate mc(k−1) previously estimated by the intake valve model M3, the provisional intake air amount Ga_pic acquired by the provisional intake air amount acquisition unit M241, and an intake amount-rotating speed steady-state map that defines the intake amount-rotating speed steady-state relationship (see FIG. 18(i)). Details of the contents and functions of this compressor rotating speed estimation unit M242 will be described later.

The provisional in-cylinder intake air flow rate acquisition unit M243 acquires the provisional in-cylinder intake air flow rate mc_tar based on the compressor rotating speed Ncm estimated by the compressor rotating speed estimation unit M242 and the above-mentioned intake amount-rotating speed steady-state map.

The provisional supercharging pressure acquisition unit M244 acquires the provisional supercharging pressure Pic_tar based on the provisional in-cylinder intake air flow rate mc_tar acquired by the provisional in-cylinder intake air flow rate acquisition unit M243 and the above-mentioned intake amount-supercharging pressure steady-state map.

The arithmetic processing unit M245 calculates a difference ΔPic between the provisional supercharging pressure Pic_tar acquired by the provisional supercharging pressure acquisition unit M244 and the above-mentioned immediately prior (most recent) intercooler internal pressure Pic(k−1).

The arithmetic processing unit M246 calculates the compressor outflow flow rate correction value Δmcm by multiplying the prescribed gain (coefficient) K by ΔPic calculated with the arithmetic processing unit M245.

The arithmetic processing unit M247 calculates (acquires or estimates) the compressor outflow flow rate mcm(k−1) by adding the compressor outflow flow rate correction value Δmcm calculated with the arithmetic processing unit M246 to the above-mentioned provisional in-cylinder intake air flow rate mc_tar.

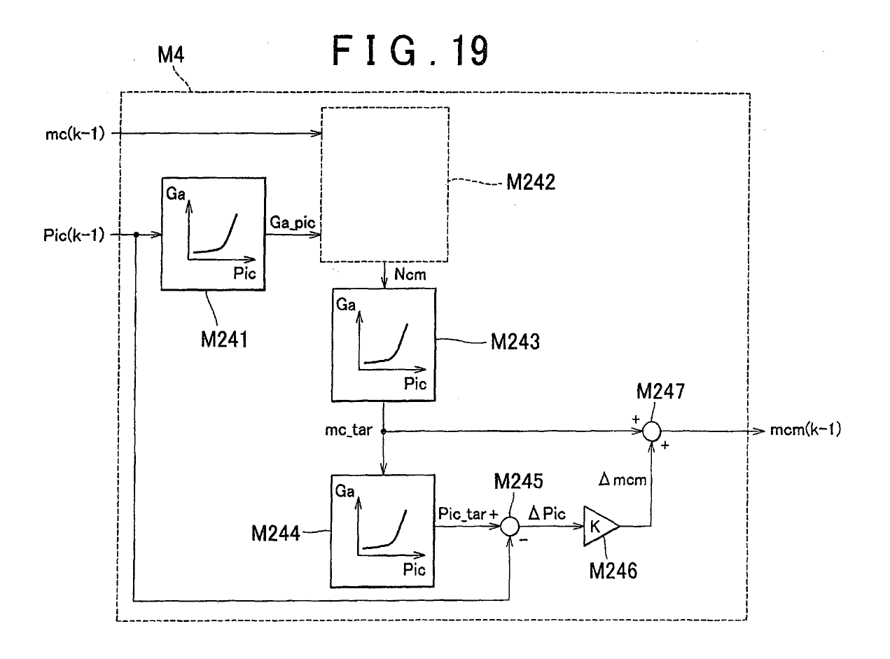

FIG. 20 is a function block diagram showing the details of the configuration of the compressor rotating speed estimation unit M242 shown in FIG. 19.

With reference to FIG. 19, a first provisional rotating speed acquisition unit M2421, a second provisional rotating speed acquisition unit M2422, an arithmetic processing unit M2423, a dead time arithmetic processing unit M2424, a primary delay arithmetic processing unit M2425, and an arithmetic processing unit M2426 are included in the compressor rotating speed estimation unit M242. Furthermore, the principal portion of rotating speed estimated value acquisition means of the invention is composed by the arithmetic processing unit M2423, the dead time arithmetic processing unit M2424, the primary delay arithmetic processing unit M2425 and the arithmetic processing unit M2426.

The first provisional rotating speed acquisition unit M2421 acquires the provisional rotating speed of the compressor 39b in the form of a first provisional rotating speed Ncm_mc based on the in-cylinder intake air flow rate mc(k−1) previously estimated by the intake valve model M3 and the above-mentioned intake amount-rotating speed steady-state map.

The second provisional rotating speed acquisition unit M2422 acquires another provisional value of the rotating speed of the compressor 39b in the form of a second provisional rotating speed Ncm_pic based on the provisional intake air amount Ga_pic and the above-mentioned intake amount-rotating speed steady-state map.

The arithmetic processing unit M2423, the dead time arithmetic processing unit M2424, the primary delay arithmetic processing unit M2425 and the arithmetic processing unit M2426 acquire the compressor rotating speed Ncm by estimating a transient change in the rotating speed of the compressor 39b based on the first provisional rotating speed Ncm_mc and the second provisional rotating speed Ncm_pic.

Again referring to FIG. 2, the compressor model M4 is also a model that estimates the compressor-imparted energy Ecm. This compressor-imparted energy Ecm is calculated according to a general formula representing a portion of this model in the form of the following formula (10), the compressor efficiency η, the compressor outflow flow rate mcm, the value of Pic/Pa (value obtained by dividing the intercooler internal pressure Pic by the intake pressure Pa) and the intake temperature Ta (refer to JP-A-2006-70881 for the process for deriving the following formula (10)).

$$Ecm = Cp \cdot mcm \cdot Ta ( {( \frac{Pic}{P a} )}^{\frac{κ - 1}{κ}} - 1 ) \frac{1}{η} \qquad ( 10 )$$

In formula (10) above, Cp is the isobaric specific heat of air. In addition, the compressor efficiency η can be estimated empirically based on the compressor outflow flow rate mcm and the compressor rotating speed Ncm. Thus, the compressor efficiency η is acquired based on the table MAPETA, which defines the relationship among the compressor outflow flow rate mcm, the compressor rotating speed Ncm and the compressor efficiency η, the compressor outflow flow rate mcm and the compressor rotating speed Ncm. Here, this compressor rotating speed Ncm is estimated by the above-mentioned compressor rotating speed estimation unit M242 without using a compressor rotating speed detection sensor.

The table MAPETA is stored in advance in the ROM 40b (see FIG. 9). The compressor model M4 estimates the compressor efficiency η(k−1) (namely, MAPETA(mcm(k−1),Ncm)) from this table MAPETA, the compressor outflow flow rate mcm(k−1) estimated in the manner described above, and the compressor rotating speed Ncm.

The compressor model M4 then estimates the compressor-imparted energy Ecm(k−1) by performing calculation using the above-mentioned formula (10) by substituting the compressor efficiency η(k−1) and the compressor outflow flow rate mcm(k−1) estimated in the manner described above, the value of Pic(k−1)/Pa, and the current intake temperature Ta into this formula (10). Here, the value Pic(k−1)/Pa is obtained by dividing the immediately prior (most recent) intercooler internal pressure Pic(k−1) previously estimated by the intercooler model M5 to be described later by the current intake pressure Pa.

<Specific Example of Operation of the Embodiment> The following provides an explanation of a specific example of the operation of the control device 4 of this embodiment provided with the configuration as described above using flow charts.

<Estimation of In-cylinder Air Volume> The CPU 40a estimates the in-cylinder air amount at a future time point relative to the current time point (predicted in-cylinder air amount KLfwd) by executing the in-cylinder air amount estimation routine 1100 shown in FIG. 11 at every predetermined arithmetic processing cycle ΔTt2 (8 ms in this example).

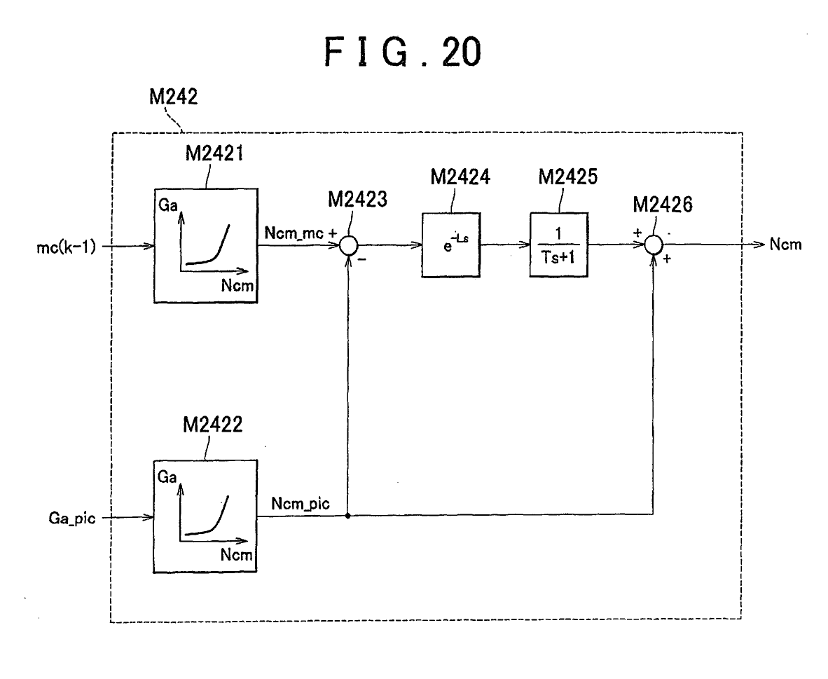

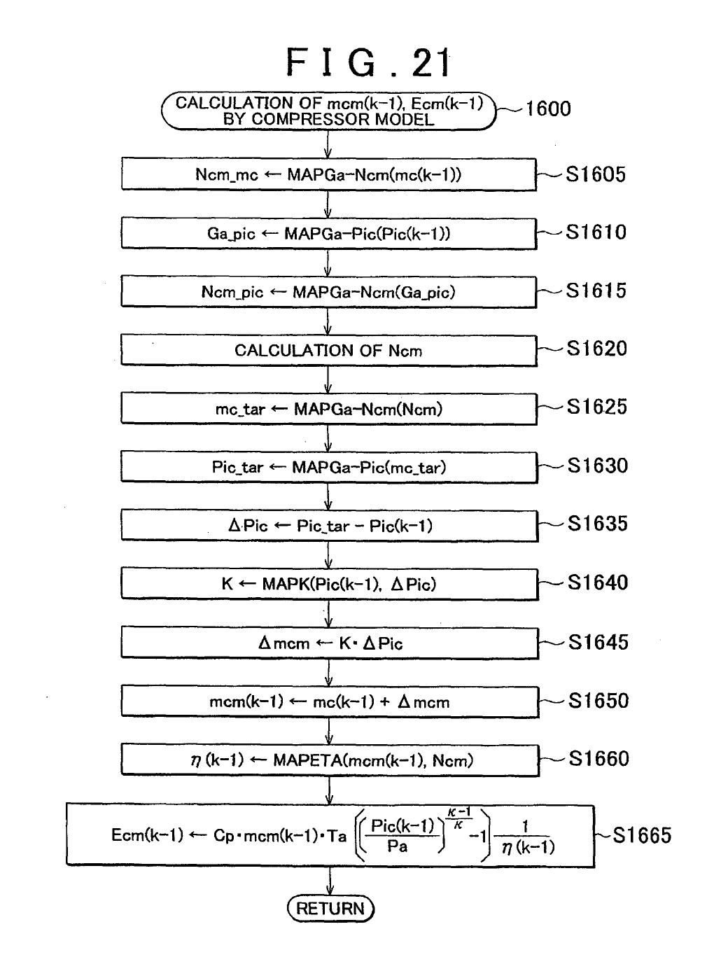

Processing processed in the same manner as the first embodiment up to Step 1110. When processing proceeds to Step 1115, processing proceeds to a routine 1600 indicated in the flow chart of FIG. 21 in order to calculate the compressor outflow flow rate mcm(k−1) and the compressor-imparted energy Ecm(k−1) by the compressor model M4.

In the routine 1600, the CPU 40a first acquires a provisional value of the rotating speed of the compressor 39b in the form of the first provisional rotating speed Ncm_mc in Step 1605 based on the in-cylinder intake air flow rate mc(k−1) at the Previous estimation time point t1 acquired in the above-mentioned Step 1110 and an intake amount-rotating speed steady-state map MAPGa-Ncm.

Next, in Step 1610, the CPU 40a acquires the provisional intake air amount Ga_pic based on the intercooler internal pressure Pic(k−1) at the previous estimation time point t1 calculated in Step 1120 to be described later during a previous execution of the routine of FIG. 11, and on an intake amount-supercharging pressure steady-state map MAPGa-Pic.

Subsequently, in Step 1615, the CPU 40a acquires another provisional value of the rotating speed of the compressor 39b in the form of the second provisional rotating speed Ncm_pic based on the provisional intake air amount Ga_pic acquired in Step 1605 and the intake amount-rotating speed steady-state map.

Subsequently, in Step 1620, the CPU 40a acquires the compressor rotating speed Ncm by estimating a transient change in the rotating speed of the compressor 39b based on the first provisional rotating speed Ncm_mc and the second provisional rotating speed Ncm_pic using a dead time and primary delay (see FIG. 18).

After estimating the compressor rotating speed Ncm in the manner described above, processing proceeds to Step 1625, and the CPU 40a acquires the provisional in-cylinder intake air flow rate mc_tar based on the estimated compressor rotating speed Ncm and the intake amount-rotating speed steady-state map MAPGa-Ncm. Next, processing proceeds to Step 1630, and the CPU 40a acquires the provisional supercharging pressure Pic_tar based on the provisional in-cylinder intake air flow rate mc_tar acquired in Step 1625 and the intake amount-supercharging pressure steady-state map MAPGa-Pic.

After having acquired the provisional supercharging pressure Pic_tar in the manner described above, processing proceeds to Step 1635 and the CPU 40a calculates the difference ΔPic between this provisional supercharging pressure Pic_tar and the above-mentioned intercooler internal pressure Pic(k−1) at the time point t1.

Next, processing proceeds to Step 1640, and the CPU 40a acquires the gain K based on the intercooler internal pressure Pic(k−1) and ΔPic, and the above-mentioned table MAPK(Pic_tar, ΔPic).

Subsequently, processing proceeds to Step 1645, and the CPU 40a calculates the compressor outflow flow rate correction value Δmcm by multiplying this gain K and the value of ΔPic. Next, processing proceeds to Step 1650, and the CPU 40a calculates the compressor outflow flow rate mcm(k−1) at the previous estimation time point t1 by adding the correction value Δmcm calculated in Step 1640 to the in-cylinder intake air flow rate mc(k−1) at the previous estimation time point t1.

Subsequently, processing proceeds to Step 1660, and the CPU 40a acquires the compressor efficiency η(k−1) based on the table MAPETA and the compressor rotating speed Ncm estimated in Step 1620.

Finally, processing proceeds to Step 1665, and the CPU 40a calculates the compressor-imparted energy Ecm(k−1) at the previous estimation time point t1 based on the value Pic(k−1)/Pa, which is obtained by dividing the intercooler internal pressure Pic(k−1) at the previous estimation time point t1 calculated in Step 1120 to be described later during previous execution of the routine of FIG. 11 by the current intake pressure Pa, the compressor outflow flow rate mcm(k−1) calculated in Step 1650, the compressor efficiency η(k−1) acquired in Step 1660, the current intake temperature Ta, and the above-mentioned formula (10) representing a portion of the compressor model M4 (refer to the formula shown in Step 1665 in FIG. 21). This routine 1600 then ends temporarily, and processing proceeds to Step 1120 of FIG. 11. Processing from Step 1120 onward is the same as that of the first embodiment.

<Effects of the Embodiment> As has been described above, the control device 4 of this embodiment calculates the in-cylinder intake air flow rate mc and the intercooler internal pressure Pic by using intake parameters, which are able to be acquired (measured or calculated) more accurately than exhaust parameters, and a calculation model (such as an intake valve model) constructed based on physical laws relating to the behavior of air in the intake system.

In addition, the control device 4 of this embodiment estimates the compressor rotating speed Ncm while taking into consideration the response delay of the supercharger 39 based on these calculated values as the relationship indicated in FIGS. 17 and 18, and acquires the compressor outflow flow rate mcm and the predicted in-cylinder air amount KLfwd based on that estimated value.

In this manner, in the configuration of this embodiment, the compressor rotating speed Ncm is accurately estimated while taking into consideration the response delay of the supercharger 39 without providing a compressor rotating speed sensor in the internal combustion engine system 1. In addition, it is no longer necessary to store a large number of compressor characteristic curves corresponding to a large number of compressor rotating speeds Ncm in the form of a table or map in the ROM 40b as indicated in FIG. 16.

Moreover, in this embodiment, the throttle passage air flow rate mt estimated by the throttle model M2 is used when calculating the compressor outflow flow rate mcm and the predicted in-cylinder air amount KLfwd instead of the output value of an air flow rate sensor.

As has been described above, according to this embodiment, the compressor outflow flow rate mcm and the predicted in-cylinder air amount KLfwd can be estimated with even greater accuracy than in the related art under a wide range of operating conditions and with an inexpensive device configuration.

<Examples of Variations> Furthermore, in the second embodiment as described above, the applicant has merely illustrated a typical embodiment of the invention considered to be the best mode for carrying out the invention at the time of filing. Accordingly, the invention is naturally not limited in any way to the embodiment described above. Thus, it goes without saying that various modifications with respect to the embodiment described above can be carried out within a range that does not deviate from the essential portions of the invention.

The following provides a description of several examples of typical variations. It goes without saying that the variations are not limited to those listed below. In addition, all or a portion of a plurality of variations can be suitably mutually combined within a range that is not technically conflicting. The invention (and particularly that represented in terms of action or function among the constituents that compose the means for solving the problems of the invention) should not be considered as limiting based on the descriptions of the above-mentioned embodiment or the following variations. Such a limiting interpretation is not permitted since it unfairly impedes the benefit of the applicant (who is hurrying with filing because of the first-to-file rule) while conversely benefiting imitators.

(A) The invention is not limited to the specific device configuration indicated in the above-mentioned embodiment.

For example, the invention can be applied to a gasoline engine, diesel engine, methanol engine, bioethanol engine or any other type of internal combustion engine. There are also no particular limitations on the number of cylinders or cylinder arrangement (in-line, V-type or boxer type).

The intercooler 34 may also be of the water-cooled type. Alternatively, the intercooler 34 may be absent. The supercharger 39 may also be of a type other than a turbocharger type.

(B) In addition, the invention is also not limited to the specific functions and operation indicated in the above embodiment.

For example, the delay time TD is not required to be a constant time, but rather may be a variable amount of time that corresponds to the engine rotating speed NE (for example, the time required for the crankshaft 23 to rotate by a prescribed angle).

In the case the throttle valve 36 is not provided in the internal combustion engine system 1, parameters required for calculation in another model such as the compressor model M4 can be generated by constructing a calculation model obtained by appropriately transforming the intake valve model M3 and/or the intake pipe model M6 instead of the throttle model M2. This applies similarly in the case of not providing the intercooler 34.

In the case the actual throttle valve opening θta becomes the target throttle valve opening θtt with substantially no delay from the time a drive signal is transmitted to the throttle valve actuator 36a, the following formula may be used instead of formula (1): θte(k)=θtt(k).

Instead of the intercooler internal pressure Pic in FIGS. 16 and 17, the value of Pic/Pa, which is the ratio between the intercooler internal pressure Pic and the intake pressure Pa, can be used as the “supercharging pressure” of the invention.

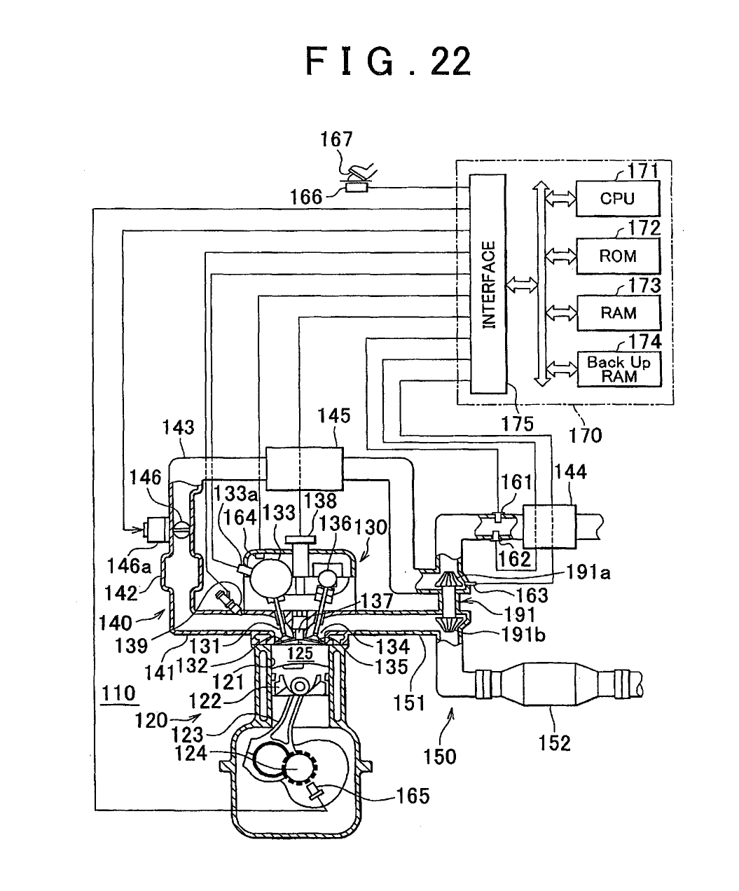

The following provides an explanation of a third embodiment of an internal combustion engine to which the control device of the invention is applied with reference to the drawings. FIG. 22 shows a spark ignition-type internal combustion engine to which the control device of the invention is applied. Furthermore, the internal combustion engine shown in FIG. 22 is a multi-cylinder internal combustion engine provided with multiple combustion chambers, or in other words, multiple cylinders. The configuration of only one specific cylinder is shown in FIG. 22, and the remaining cylinders are provided with a configuration similar thereto.

The internal combustion engine 110 shown in FIG. 22 is provided with a cylinder block unit 120 that includes a cylinder block, a cylinder block lower case and an oil pan and the like, a cylinder head unit 130 fixed on the cylinder block unit 120, an intake system 140 for supplying a fuel-air mixture composed of fuel and air to the cylinder block unit 120, and an exhaust system 150 for discharging exhaust gas to the outside from the cylinder block unit 120.

The cylinder block unit 120 has a cylinder 121, a piston 122, a connecting rod 123 and a crankshaft 124. The piston 122 reciprocates within the cylinder 121, and this reciprocating motion of the piston 122 is transferred to the crankshaft 124 through the connecting rod 123, thereby causing rotation of the crankshaft 124. In addition, a combustion chamber 125 is formed by inner walls of the cylinder 121, the upper wall of the piston 122, and the lower wall of the cylinder head unit 130.

The cylinder head unit 130 has an intake port 131 that communicates with the combustion chamber 125, an intake valve 132 that opens and closes the intake port 131, an intake camshaft (not shown) that drives the intake valve 132, and a variable intake timing device 133 provided with an actuator 133a that is able to continuously vary the phase angle of the intake camshaft. In addition, the cylinder head unit 130 has an exhaust port 134 that communicates with the combustion chamber 125, an exhaust valve 135 that opens and closes the exhaust port 134, and an exhaust camshaft 136 that drives the exhaust valve 135. Moreover, the cylinder head unit 130 has a spark plug 137 that ignites fuel in the combustion chamber 125, an igniter 138 provided with an ignition coil that imparts a high voltage to the spark plug 137, and a fuel injection valve 139 that injects fuel into the intake port 131.

The intake system 140 has an intake branch pipe 141 that is connected to the intake port 131, a surge tank 142 that is connected to the intake branch pipe 141, and an intake duct 143 that is connected to the surge tank 142. The intake duct 143, the intake port 131, the intake branch pipe 141 and the surge tank 142 compose an intake passage. Moreover, the intake system 140 has, the upstream end of the intake duct 143 to the downstream side (namely, towards the surge tank 142), an air filter 144, a throttle valve 146 and a throttle valve driving actuator 146a that drives the throttle valve 146, in the intake duct 143. In addition, a pressure sensor 161 that detects the pressure of air flowing through the intake duct 143, and a temperature sensor 162 that detects the temperature of air flowing through the intake duct 143, are mounted in the intake duct 143.

The throttle valve 146 is rotatably mounted to the intake duct 143, and the opening thereof is adjusted by being driven by the throttle valve driving actuator 146a. Namely, the throttle valve 146 is able to adjust the flow path area of the intake duct 143. The throttle valve driving actuator 146a is composed of a DC motor, and drives the throttle valve 146 so that the actual opening of the throttle valve 146 (to be referred to as “throttle opening”) becomes a target throttle opening in response to a drive signal output in accordance with an electronically controlled throttle valve logic executed by an electric control device 170 to be described later.

The exhaust system 150 has an exhaust pipe 151 that includes an exhaust branch pipe connected to the exhaust port 134, and a three-way catalyst device 152 arranged in the exhaust pipe 151. The exhaust pipe 151, the exhaust port 134 and the three-way catalyst device compose an exhaust passage.

In addition, a compressor 191a of a supercharger 191 is arranged within the intake duct 143 upstream from the throttle valve 146. On the other hand, an exhaust turbine 191b of the supercharger 191 is arranged within the exhaust pipe 151. The compressor 191a is connected to the exhaust turbine 191b, and when the exhaust turbine 191b is rotated by exhaust gas, rotation of the exhaust turbine 191b is transmitted to the compressor 191a, causing the compressor 191a to rotate. When the compressor 191a is rotated, the compressor 191a compresses and discharges air downstream therefrom.

A compressor rotating speed sensor 163 that detects rotating speed of the compressor 191a is mounted in the intake duct 143 in the proximity of the compressor 191a. The compressor rotating speed sensor 163 outputs a signal for each 360° rotation of the compressor 191a. In addition; the compressor rotating speed sensor 163 is connected to an interface 175 of the electric control device 170, and a signal output from the compressor rotating speed sensor 163 is supplied to a CPU 171 via the interface 175.

In addition, an intercooler 145, which cools air that flows through the intake duct 143, is arranged in the intake duct 143 between the compressor 191a and the throttle valve 146. The intercooler 145 cools air that flows through the intake duct 143 with air from outside the internal combustion engine 110.

In addition, the internal combustion engine 110 is provided with a cam position sensor 164 that detects the phase angle of the intake camshaft, a crank position sensor 165 that detects the phase angle of the crankshaft 124, an accelerator depression amount sensor 166 that detects the amount of depression of an accelerator pedal, and an electric control device 170. The accelerator depression amount sensor 166 functions as operating status acquisition means A2 that acquires parameters relating to operating status of the internal combustion engine 110.

The pressure sensor 161 is mounted in the intake duct 143 between the air filter 144 and the throttle valve 146, and outputs a signal that represents the pressure of air within the intake passage upstream from the throttle valve 146 (to be referred to as “intake pressure”) by detecting the pressure of air within the intake duct 143. On the other hand, the temperature sensor 162 is mounted in the intake duct 143 between the air filter 144 and the throttle valve 146, and outputs a signal that represents the temperature of air within the intake passage upstream from the throttle valve 146 (to be referred to as “intake temperature”) by detecting the temperature of air within the intake duct 143. The cam position sensor 164 generates a pulse signal for each 90° rotation of the intake camshaft (namely, for each 180° rotation of the crankshaft 124). On the other hand, the crank position sensor 165 generates a narrow-width pulse signal for each 10° rotation of the crankshaft 124 and a wide-width pulse signal for each 360° rotation of the crankshaft 124. The rotating speed of the internal combustion engine (to be referred to as “engine rotating speed”) can be calculated based on the pulse signal generated by the crank position sensor 165. In addition, the accelerator depression amount sensor 166 outputs a signal representing the amount of depression of an accelerator pedal 167 by detecting the amount of depression of the accelerator pedal 167 operated by a driver.

The electric control device 170 is a microcomputer that is composed of a CPU (microprocessor) 171, a ROM 172, in which are stored in advance a program executed by the CPU 171 and maps (including look-up tables), constants and the like, a RAM 173, in which the CPU 171 temporarily stores data as necessary; a backup RAM 154, which stores data while the power is turned on and retains this stored data while power is interrupted, and an interface 175, which includes an analog to digital (AD) converter, which are all interconnected by a bidirectional bus. The interface 175 is connected to the pressure sensor 161 and the temperature sensor 162, and together with supplying signals from the pressure sensor 161 and the temperature sensor 162 to the CPU 171, outputs drive signals to the actuator 133a of the variable intake timing device 133, the igniter 138, the fuel injection valve 139, and the throttle valve driving actuator 146a according to instructions from the CPU 171.

The following provides an explanation of an overview of a method for calculating the amount of air taken into the combustion chamber during the intake stroke (to be referred to as the “in-cylinder intake air amount”) of the internal combustion engine configured in the manner described above.

In the internal combustion engine 110, a target air-fuel ratio is set for the air-fuel ratio of the fuel-air mixture formed in the combustion chamber 125 in accordance with the operating status of the internal combustion engine (to be referred to as “engine operating status”). On the other hand, in the internal combustion engine 110, the fuel injection valve 139 is arranged upstream from the intake valve 132. Thus, in order to form a fuel-air mixture of a target air-fuel ratio in the combustion chamber 125 by supplying fuel to the combustion chamber 125, the amount of fuel to be injected from the fuel injection valve 139 (to be referred to as the “fuel injection amount”) must be determined by completion of the intake stroke, namely by the time the intake valve 132 closes, and that amount of fuel must then be injected from the fuel injection valve 139. Here, the in-cylinder intake air amount when the intake valve 132 has closed must be calculated by the time fuel is injected from the fuel injection valve 139 in order to determine the amount of the injected fuel that forms a fuel-air mixture of a target air-fuel ratio within the combustion chamber 125. Therefore, in this embodiment, the in-cylinder intake air amount is calculated by the time fuel is injected from the fuel injection valve 139 in the manner described below by an in-cylinder intake air amount calculation device.

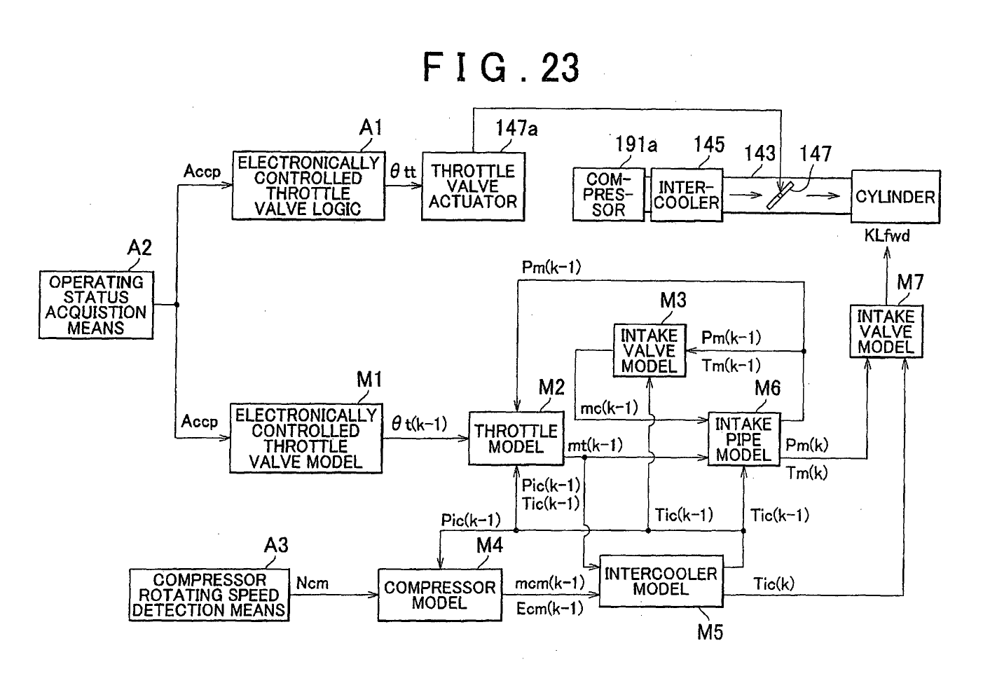

Namely, the in-cylinder intake air amount calculation device of this embodiment calculates the in-cylinder intake air amount by utilizing a plurality of physical models derived by using physical laws such as the mass conservation law, energy conservation law and momentum conservation law relating to air in the intake passage. Namely, the in-cylinder intake air amount calculation device of this embodiment calculates the in-cylinder intake air amount by using the electronically controlled throttle valve model M1, the throttle model M2, the intake valve model M3, the intake pipe model M6, the intake valve model M7, the compressor model M4 and the intercooler model M5 as shown in the function block diagram of FIG. 23.

The functions of each model will be briefly described. The electronically controlled throttle valve model M1 is a model that sets a throttle opening to be used as a target (to be referred to as the “target throttle opening”) based on the depression amount of an accelerator pedal in coordination with the electronically controlled throttle valve logic A1, and then outputs a drive signal to the throttle valve driving actuator 146a and calculates a predicted value of the actual throttle opening so that the throttle opening becomes the target throttle opening. In addition, the throttle model M2 is a model for calculating the flow rate of air passing through the throttle valve 146 (to be referred to as the “throttle valve passage air flow rate”), the intake valve model M3 is a model for calculating the flow rate of air that passes through the intake valve 132 and enters the combustion chamber 125 (to be referred to as the “intake valve passage air flow rate”), the intake pipe model M6 is a model for calculating the pressure within the intake passage downstream from the throttle valve 146 (to be referred to as the “intake pipe pressure”) and the temperature within the intake passage downstream from the throttle valve 146 (to be referred to as the “intake pipe temperature”), and the intake valve model M7 is a model for calculating the in-cylinder intake air amount.

Moreover, the compressor model M4 is a model for calculating the flow rate of air flowing out from the compressor 191a (to be referred to as the “compressor outflow air flow rate”), while the intercooler model M5 is a model for calculating the pressure of air within the intercooler 145 (to be referred to as the “intercooler pressure”) as well as the temperature of air within the intercooler 145 (to be referred to as the “intercooler temperature”).

Furthermore, in the case of expressing the model formula of each model with a generalized numerical formula such as y=f(x) (to be referred to as a “general formula”), in order to determine the value y at a certain future time point relative to the current time point, it is necessary to use a value at a certain future time point relative to the current point in time for the variable x. Namely, in the case the value to be determined by a general formula is a value at a certain future time point relative to the current point in time, it is necessary to use a value at a certain future time point relative to the current point in time for the variable used in the general formula. Here, the in-cylinder intake air amount to be determined by the in-cylinder intake air amount calculation device of this embodiment in the manner previously described is an in-cylinder intake air amount at the point in time at which calculation processing by the in-cylinder intake air amount calculation device begins, namely a certain future time point relative to the current point in time.

Thus, during calculation processing in accordance with the throttle model M2 that uses throttle opening, intake pipe pressure, intercooler pressure and intercooler temperature as variables, it is necessary to use the throttle opening, intake pipe pressure, intercooler pressure and intercooler temperature at the point in time at which calculation processing is executed in accordance with the throttle model M2, namely at a certain future time point relative to the current point in time.

Similarly, during calculation processing in accordance with the intake valve model M3, the intake pipe model M6 and the intake valve model M7, which use the intake pipe pressure, intake pipe temperature, intercooler temperature, engine rotating speed and opening and closing timing of the intake valve 132 (to be referred to as the “intake valve opening and closing timing”) as variables, it is necessary to use the intake pipe pressure, intake pipe temperature, intercooler temperature, engine rotating speed and intake valve opening and closing timing at the point in time at which calculation processing is executed in accordance with these models, namely at a certain future time point relative to the current point in time.

Thus, in this embodiment, in the case the point in time at which calculation processing in accordance with each of the models M2 to M7 begins is taken to be the current point in time, since the in-cylinder intake air amount is calculated based on the throttle opening, intake pipe pressure, intake pipe temperature, intercooler pressure, intercooler temperature, engine rotating speed and intake valve opening and closing timing at a certain future time point relative to the current point in time, the in-cylinder intake air amount calculated in this manner is the in-cylinder intake air amount at a certain future time point relative to the current point in time.

The following provides an explanation of the details of a method for calculating the in-cylinder intake air amount in the control device of the internal combustion engine shown in FIG. 22 along with an explanation of the details of each model.

First, an explanation is provided of the electronically controlled throttle valve model M1. The electronically controlled throttle valve model M1 is executed at predetermined time intervals ΔT1 (to be referred to as “prescribed time interval ΔT1”, and is, for example, 2 ms). The electronically controlled throttle valve model M1 is a model that sets a target throttle opening based on an accelerator pedal depression amount in coordination with the electronically controlled throttle valve logic A1, and then outputs a drive signal to the throttle valve driving actuator 146a so that the throttle opening becomes the target throttle opening, and in addition, calculates a predicted value of actual throttle opening.

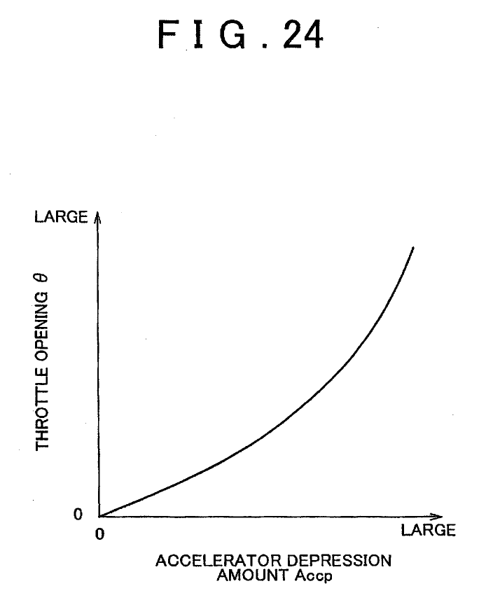

Namely, a constant relationship like that shown in FIG. 24 exists between an accelerator pedal depression amount Accp and a target throttle opening θt. Therefore, in this embodiment, a map Ma, which defines the relationship between the accelerator pedal depression amount Accp and a target throttle opening, is stored in advance in the ROM 172 in a form like that shown in FIG. 24. The electronically controlled throttle valve logic A1 then determines the target throttle opening θt from the above-mentioned map Ma based on the actual accelerator pedal depression amount Accp detected by the accelerator depression amount sensor 166 at the point in time arithmetic processing is currently executed in accordance with the electronically controlled throttle valve model M1 (to be referred to as the “model arithmetic processing time point”). The electronically controlled throttle valve logic A1 then sets the target throttle opening θt determined in this manner as the target throttle opening after a predetermined amount of time TD (to be referred to as “prescribed delay time”, and is, for example, 64 ms) from the current model arithmetic processing time point. Moreover, the electronically controlled throttle valve logic A1 outputs, a drive signal to the throttle valve driving actuator 146a so that the throttle opening becomes the target throttle opening at the current model arithmetic processing time point, namely the target throttle opening set by the electronically controlled throttle valve logic A1 the prescribed delay time TD ago.

However, operation of the throttle valve driving actuator 146a is accompanied by a certain delay, and inertia is present in the throttle valve 146. Consequently, even if a drive signal has been output to the throttle valve driving actuator 146a from the electronically controlled throttle valve logic A1, the resulting throttle opening is brought to the target throttle opening with a certain delay. Therefore, the electronically controlled throttle valve model M1 calculates, as a predicted throttle opening θe, a predicted value of the actual throttle opening after the prescribed delay time TD based on the following formula (11), and stores or retains that value in the ROM 153.

θe(i)=θe(i−1)+ΔT1·f(θt(i),θe(i−1)) (11)

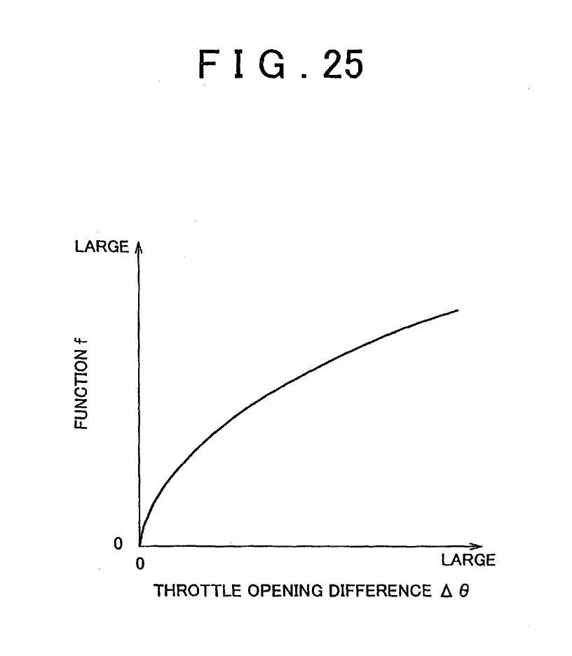

In formula (11), θe(i) is the predicted throttle opening after the prescribed delay time TD to be calculated by executing the current arithmetic processing in accordance with the electronically controlled throttle valve model M1 (to be referred to as “model arithmetic processing”), θe(i−1) is the predicted throttle opening calculated according to the previous model arithmetic processing (namely, arithmetic processing in accordance with the electronically controlled throttle valve model M1 executed the above-mentioned prescribed time interval ΔT1 ago), θt(i) is the target throttle opening after the prescribed delay time TD set by the current model arithmetic processing, and ΔT1 is the above-mentioned prescribed time interval, namely the time intervals at which model arithmetic processing is carried out. In addition, as shown in FIG. 25, the function f(θt, θe) is a function that returns a value that increases as the difference Δθ between the target throttle opening θt and the predicted throttle opening θe increases, namely a function that increases monotonically with respect to the difference Δθ.

Thus, according to the electronically controlled throttle valve model M1, the target throttle opening θt is determined by the electronically controlled throttle valve logic A1, the determined target throttle opening is set for a target throttle opening at a time point the prescribed delay time ID after the current time point, a drive signal is output to the throttle valve driving actuator 146a so that the actual throttle opening of the current time point becomes the target throttle opening set as the current throttle opening the prescribed delay time TD ago, and the actual throttle opening at a time point the prescribed delay time TD after the current time point is calculated as the predicted throttle opening θe.

Furthermore, in the case there is no delay in the operation of the throttle valve driving actuator 146a and inertia of the throttle valve 146 can be ignored, the target throttle opening θt may be used as is for the predicted throttle opening θe instead of calculating the predicted throttle opening θe according to the formula (11).

Next, an explanation is provided of the throttle model M2. Furthermore, since a method for deriving a model formula that represents this throttle model M2 is commonly available (see, for example, JP-A-2001-041095 and JP-A-2003-184613), a detailed explanation relating to the method of deriving this throttle model M2 is omitted. In addition, arithmetic processing in accordance with the throttle model M2, the intake valve model M3, the intake pipe model M6, the intake valve model M7, the compressor model M4 and the intercooler model M5 explained below is executed as a series of arithmetic operations at predetermined time intervals ΔT2 that differs from the above-mentioned prescribed time intervals ΔT1 (to be referred to as “prescribed time interval ΔT2”, and is, for example, 8 ms). Naturally, the prescribed time interval ΔT2 and the prescribed time interval ΔT1 may be equal.

The throttle model M2 of this embodiment is a model for calculating the throttle valve passage air flow rate based on the following model formulas (12) and (13), which were derived using physical laws such as the mass conservation law, energy conservation law, momentum conservation law and state equation of a gas.

$$\begin{matrix}mt = C ( θ ) \cdot A ( θ ) \cdot \frac{Pi}{\sqrt{R \cdot Ti}} \cdot Φ ( Pm / Pi ) & ( 12 ) \\ Φ ( Pm / Pi ) = ( \begin{matrix}\sqrt{\frac{κ}{2 \cdot ( κ + 1 )}} & where & \frac{Pm}{Pi} ≦ \frac{1}{κ + 1} \\ \sqrt{\begin{matrix}( \begin{matrix}\frac{κ - 1}{2 κ} ( 1 - \frac{Pm}{Pi} ) + \\ \frac{Pm}{Pi}\end{matrix} ) \\ ( 1 - \frac{Pm}{Pi} )\end{matrix}} & where & \frac{Pm}{Pi} > \frac{1}{κ + 1}\end{matrix} & ( 13 )\end{matrix}$$

In the formulas (12) and (13) above, mt is the throttle valve passage air flow rate to be calculated by current arithmetic processing in accordance with the throttle model M2 (to be referred as “model arithmetic processing”), θ is a throttle opening, C(θ) is a flow rate coefficient corresponding to the throttle opening θ, A(θ) is a throttle flow path area corresponding to the throttle opening θ, Pm is an intake pipe pressure calculated by arithmetic processing in accordance with the intake pipe model M6 (the details of which will be described later), R is a gas constant, and κ is the specific heat ratio of air. In addition, Pi is an intercooler pressure, namely the pressure of air within the intercooler 145, calculated by arithmetic processing in accordance with the intercooler model M5 (the details of which will be described later), and Ti is an intercooler temperature, namely the temperature of air within the intercooler 145, calculated by arithmetic processing in accordance with the intercooler model M5 (the details of which will be described later). κ is treated as a constant value in this embodiment as well.

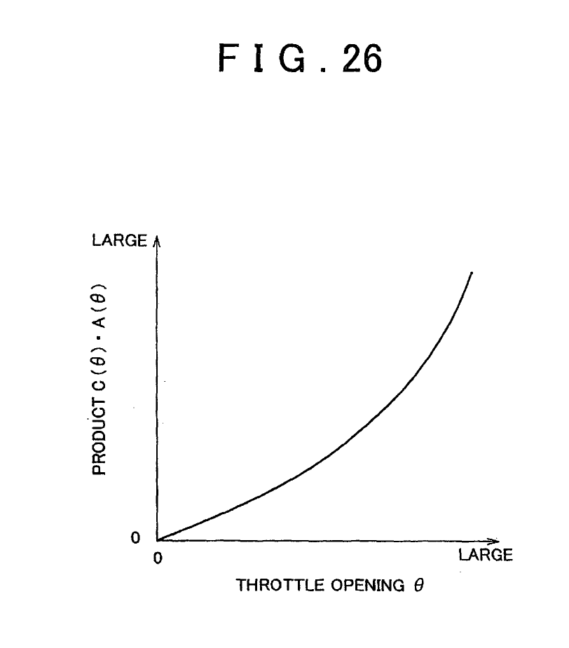

In addition, the product C(θ)·A(θ) of the model formula (12) is determined from a map Mca shown in FIG. 26 based on the predicted throttle opening θe calculated by arithmetic processing in accordance with the electronically controlled throttle valve model M1. In addition, the value Φ(Pm/Pi) is determined from a map MΦ shown in FIG. 34 based on the ratio Pm/Pi (to be referred to as the “pressure ratio”) of the intake pipe pressure Pm to the intercooler pressure Pi calculated according to arithmetic processing in accordance with the intercooler model M5 (the details of which will be described later), and the predicted throttle opening θe.

The following provides an explanation of the intake valve model M3. Furthermore, since a method for deriving this model formula that represents the intake valve model M3 is commonly available (see, for example, JP-A-2001-041095 and JP-A-2003-184613), an explanation of the details of the derivation method of the intake valve model M3 is omitted.

The intake valve model M3 is a model for calculating the in-cylinder intake air flow rate, namely the flow rate of air that passes through the intake valve 132 and enters the combustion chamber 125, based on the following model formula (14) that is derived by using empirical laws.

mc=(Ti/Tm)·(c·Pm−d) (14)

In the model formula (14) above, mc is the in-cylinder intake air flow rate to be calculated by the current arithmetic processing in accordance with the intake valve model M3 (to be referred to as “model arithmetic processing”), Tm is the intake pipe temperature, namely the temperature within the intake passage downstream from the throttle valve 146, that is calculated by arithmetic processing in accordance with the intake pipe model M6 (the details of which will be described later), Pm is the intake pipe pressure, namely the pressure within the intake passage downstream from the throttle valve 146, that is calculated by arithmetic processing in accordance with the intake pipe model M6 (the details of which will be described later), c is a proportionality constant corresponding to engine rotating speed and intake valve opening and closing timing, d is a value corresponding to the amount of burned gas remaining in the combustion chamber 125 without being discharged from the combustion chamber 125 to the discharge passage during the exhaust stroke, and corresponds to engine rotating speed and intake valve opening and closing timing, and Ti is the intercooler temperature that is calculated by arithmetic processing in accordance with the intercooler model M5 (the details of which will be described later).

Furthermore, although the intake pipe pressure Pm is used as a variable in the model formula (14), in principle, the pressure within the combustion chamber 125 during the intake stroke (to be referred to as the “in-cylinder pressure”) should be used to calculate the in-cylinder intake air flow rate. However, the in-cylinder pressure during the intake stroke can be considered to be equal to the pressure within the intake passage upstream from the intake valve 132, namely the intake pipe pressure. Thus, in this embodiment, the intake pipe pressure Pm is used as a variable instead of in-cylinder pressure in the intake valve model M3.

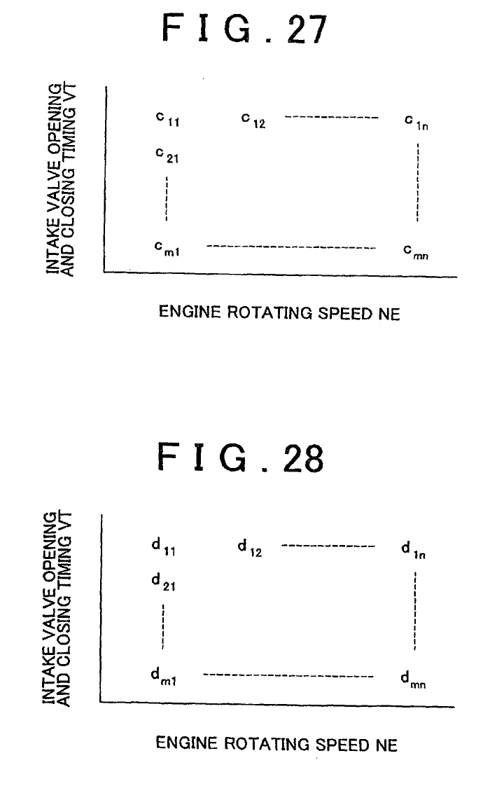

In addition, the proportionality coefficient c can be determined in advance through experimentation and the like as a value based on engine rotating speed and intake valve opening and closing timing. Therefore, in this embodiment, a map Mc, which defines the relationship among the engine rotating speed NE, the intake valve opening and closing timing VT and the proportionality coefficient c, is determined and stored in advance in the ROM 172 in the form shown in FIG. 27. The intake valve model M3 then determines the proportionality coefficient c from the map Mc based on the engine rotating speed NE and the intake valve opening and closing timing VT.

Similarly, the value d can also be determined in advance through experimentation and the like as a value based on engine rotating speed and intake valve opening and closing timing. Therefore, in this embodiment, a map Md, which defines the relationship among the engine rotating speed NE, the intake valve opening and closing timing VT and the value d, is determined and stored in advance in the ROM 172 in the form shown in FIG. 28. The intake valve model M3 then determines the value d from the map Md based on the engine rotating speed NE and the intake valve opening and closing timing VT.

Next, an explanation is provided of the compressor model M4. The compressor model M4 is a model for calculating the compressor outflow air flow rate, namely the flow rate of air that flows out of the compressor 191a.

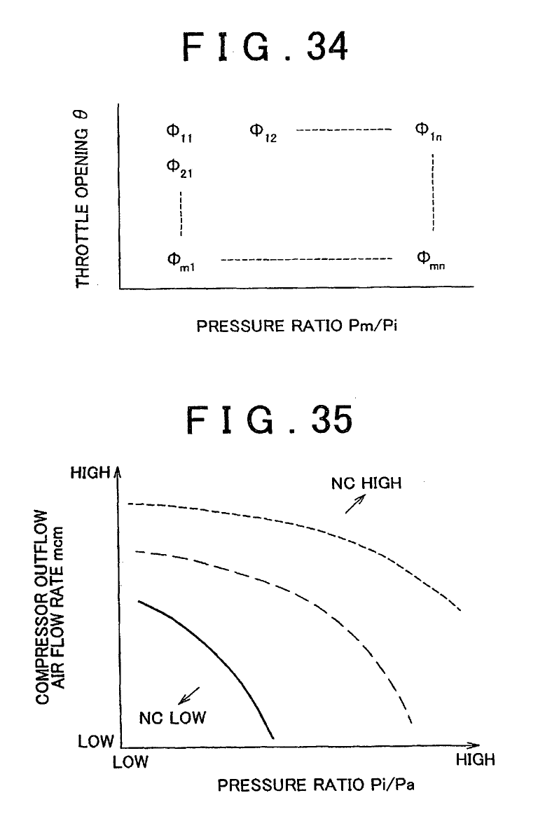

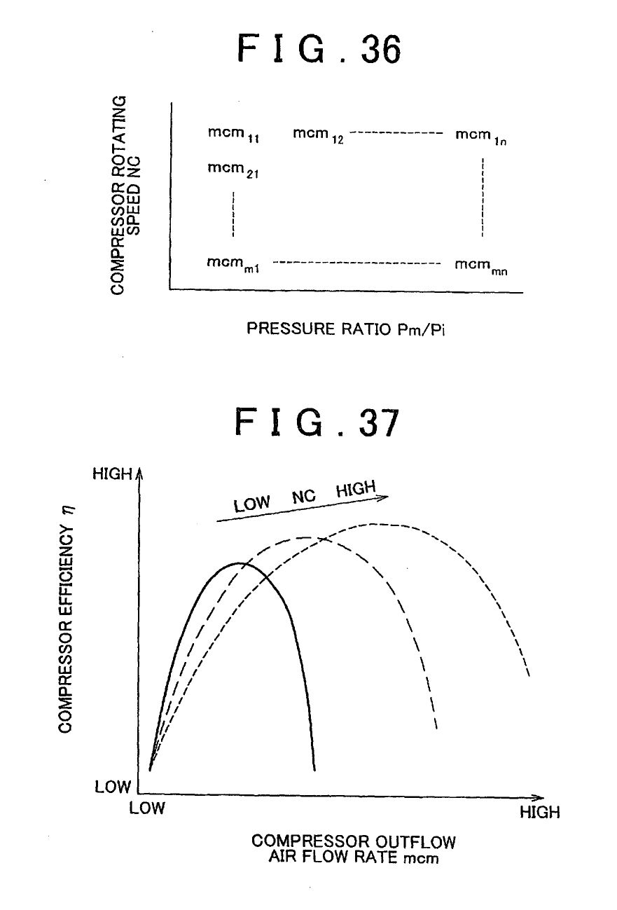

However, the compressor outflow air flow rate can be estimated empirically based on the ratio between intercooler pressure and intake pressure (intake pressure in the second embodiment is the pressure within the intake duct 143 upstream from the compressor 191a) and the compressor rotating speed. Namely, there is a relationship as shown in FIG. 35 among the compressor outflow air flow rate mcm, the value of Pi/Pa obtained by dividing the intercooler pressure Pi by the intake pressure Pa (to be referred to as the “pressure ratio”), and the compressor rotating speed NC, and the compressor outflow air flow rate mcm decreases as the ratio of Pi/Pa increases and increases as the compressor rotating speed NC increases. The compressor outflow air flow rate can be determined in advance through experimentation and the like as a value based on the pressure ratio and the compressor rotating speed NC. Therefore, in the second embodiment, a map Mmcm, which defines the relationship among the pressure ratio Pi/Pa, the compressor rotating speed NC and the compressor outflow air flow rate mcm, is determined and stored in advance in the ROM 172 in the form shown in FIG. 36. The compressor model M4 then calculates the compressor outflow air flow rate mcm from the map Mmcm based on the value of Pi/Pa and the compressor rotating speed NC.

Next, an explanation is provided of the intercooler model M5. The intercooler model M5 is a model for calculating the intercooler pressure and the intercooler temperature at the time point of current execution of arithmetic processing (to be referred to as “model arithmetic processing) in accordance with the following model formulas (15) and (16) derived using the mass conservation law and the energy conservation law.

d(Pi/Ti)/dt=(R/Vi)·(mcm−mt) (15)

dPi/dt=κ·(R/Vi)·(mcm·Ta−mt·Ti)+(κ−1)/Vi·(Ec−K·(Ti−Ta)) (16)

In the model formulas (15) and (16) above, Pi is the intercooler pressure to be calculated by the current model arithmetic processing, Ti is the intercooler temperature to be calculated by the current model arithmetic processing, Vi is the volume of the intake passage between the outlet of the compressor 191a and the throttle valve 146, mcm is the compressor outflow air flow rate at the current model estimation time point that is calculated by arithmetic processing in accordance with the compressor model M4, Ec is the energy imparted to air as a result of compression by the compressor 191a (the calculation method thereof will be described later), mt is the throttle valve passage air flow rate at the current model arithmetic processing time point that is calculated by arithmetic processing in accordance with the throttle model M2, Ta is the intake temperature at the current model arithmetic processing time point, R is a gas constant, K is the specific heat ratio of air, and K is a coefficient (the details of which will be described later).

The following provides an explanation of the method for deriving the model formulas (15) and (16). When a portion of the intake passage between the compressor 191a and the throttle valve 146 is designated as an intercooler portion and the total amount of air in this intercooler portion is designated as a total air amount M, since the change dM/dt per unit time in the total air amount M is the difference between the compressor outflow air flow rate mcm equivalent to the flow rate of air entering the intercooler portion and the throttle valve passage air flow rate mt equivalent to the flow rate of air flowing out from the intercooler portion, the following formula (17) can be obtained based on the mass conservation law.

dM/dt=mcm−mt (17)

In addition, the next formula (18) is obtained based on a state equation relating to air within the intercooler portion.

Pi·Vi=M·R·Ti (18)

Here, the above-mentioned model formula (15) is obtained by substituting the formula (18) into the formula (17) and eliminating the total air amount M, taking account of the fact that the volume Vi of the intercooler portion is constant.

On the other hand, when the change in energy of air within the intercooler portion is designated as an intercooler internal energy change Ei, the energy of air prior to being compressed by the compressor 191a is designated as pre-compression air energy Ea, the energy imparted to air as a result of being compressed by the compressor 191a is designated as compressor-imparted energy Ec, the energy of air released to the outside through the walls of the intercooler 145 is designated as dissipated air energy Ed, and the energy of air that flows out from the intercooler portion is designated as outflow air energy Et, then the following formula (19) is obtained from the energy conservation law with respect to air in the intercooler portion.

Ei=Ea+Ec−Ed−Et (19)

The intercooler internal energy change Ei is equal to the value obtained by subtracting the dissipated air energy Ed and the outflow air energy Et from the sum of the energy of air entering the intercooler portion, namely the pre-compression air energy Ea, and the compressor-imparted energy Ec.

The pre-compression air energy Ea and the outflow air energy Et of these energies can be calculated in accordance with the following formulas (20) and (21), respectively.

Ea=Cp·mcm·Ta (20)

Et=Cp·mt·Ti (21)

In the formulas (20) and (21), Cp is the isobaric specific heat of air, mcm is the compressor outflow air flow rate, Ta is the intake temperature, mt is the throttle passage air flow rate, and Ti is the intercooler temperature.

In addition, the compressor-imparted energy Ec can be calculated in accordance with the following formula (22).

$$Ec = Cp \cdot mcm \cdot Ta ( {( \frac{Pi}{P a} )}^{\frac{κ - 1}{κ}} - 1 ) \frac{1}{η} \qquad ( 22 )$$

In the formula (22), Cp is the isobaric specific heat of air, mcm is the compressor outflow air flow rate, Ta is the intake temperature, Pi is the intercooler pressure, Pa is the intake pressure, and η is the compressor efficiency.

Namely, when the flow rate of air that flows into the compressor 191a is designated as a compressor inflow air flow rate mci, the temperature of air that flows into the compressor 191a is designated as a compressor inflow air temperature Tci, the flow rate of air that flows out from the compressor 191a is designated as a compressor outflow air flow rate mco, and the temperature of air that flows out from the compressor 191a is designated as a compressor outflow air temperature Tco, then the energy Eci of air that flows into the compressor 191a and the energy Eco of air that flows out from the compressor 191a can be represented with the following formulas (23) and (24), respectively.

Eci=Cp·mci·Tci (23)

Eco=Cp·mco·Tco (24)

Here, since the sum of the energy Ed of air that flows into the compressor 191a and the compressor-imparted energy Ec is equal to the energy Eco of air that flows out from the compressor 191a, the following formula (25) is obtained by using the formulas (23) and (24) based on the energy conservation law.

Cp·mci·Tci+Ec=Cp·mco·Tco (25)

Here, the following formula (26) is obtained by modifying the formula (25), considering that the flow rate of air that flows into the compressor 191a is equal to the flow rate of air that flows out from the compressor 191a.

Ec=Cp·mco·(Tco−Tci) (26)

On the other hand, the compressor efficiency η is represented by the following formula (27).

$$η = \frac{Tci ( {( \frac{Pco}{Pci} )}^{\frac{κ - 1}{κ}} - 1 )}{Tco - Tci} \qquad ( 27 )$$

In the formula (27), Tci is the temperature of air that flows into the compressor, Pio is the pressure of air that flows out from the compressor, Pi is the intercooler pressure, Tio is the temperature of air that flows out from the compressor, and κ is the specific heat ratio of air.

The following formula (28) is obtained by substituting the formula (27) into the formula (25) and transforming the resultant equation.

$$Ec = Cp \cdot mco \cdot Tci ( {( \frac{Pco}{Pci} )}^{\frac{κ - 1 }{κ}} - 1 ) \frac{1}{η} \qquad ( 28 )$$

Here, the pressure Pci and temperature Tci of air that flows into the compressor can be said to be equal to the intake pressure Pa and the intake temperature Ta, respectively. In addition, the pressure Pco of ah that flows out from the compressor can be said to be equal to the intercooler pressure Pi. Moreover, the flow rate mco of air that flows out from the compressor is the compressor outflow air flow rate mcm. Thus, the formula (22) is obtained by modifying the formula (28) in consideration thereof.

Furthermore, the relationship among compressor outflow air flow rate, compressor rotating speed and compressor efficiency is as shown in FIG. 37. Namely, provided that the compressor rotating speed is constant, the compressor efficiency η increases as the compressor outflow air flow rate increases until the compressor outflow air flow rate reaches a certain fixed flow rate, and decreases as the compressor outflow air flow rate increases when the compressor outflow air flow rate exceeds a certain fixed flow rate. Namely, the compressor efficiency η reaches a peak where the compressor outflow air flow rate reaches a certain fixed flow rate. In addition, the peak of the compressor efficiency η increases as the compressor outflow air flow rate increases, and the compressor outflow air flow rate where the compressor efficiency η reaches a peak increases as the compressor rotating speed increases. The compressor efficiency can be determined in advance through experimentation and the like as a value based on the compressor outflow air flow rate and the compressor rotating speed. Therefore, in this embodiment, a map Mη, which defines the relationship among compressor outflow air flow rate mcm, compressor rotating speed NC and compressor efficiency η, is determined and stored in advance in the ROM 172 in the form shown in FIG. 38. The intercooler model M5 then determines the compressor efficiency η from the map Mη based on the compressor outflow air flow rate mcm, which is calculated by arithmetic processing in accordance with the compressor model M4, and the compressor rotating speed NC.

In addition, in the explanation provided above, the energy imparted to air from the compressor contributes to a rise in temperature of air from the time of flowing into to the time of flowing out of the compressor, and contributions to movement of the air are ignored.

Moreover, the dissipated air energy Ed can be calculated in accordance with the following formula (29).

Ed=K·(Ti−Ta) (29)

In the formula (29), K is a coefficient corresponding to the product of the surface area of the intercooler 145 and the heat transfer coefficient from air within the intercooler 145 to the walls of the intercooler 145, Ti is the intercooler temperature, and Ta is the intake air temperature.

Namely, the dissipated air energy Ed is proportional to the difference between the intercooler temperature Ti and the wall temperature Tw of the intercooler 145 based on empirical laws. Here, since the intercooler 145 cools air inside the intercooler 145 with air from outside the internal combustion engine 110, the wall temperature Tw of the intercooler 145 is equal to the temperature outside the internal combustion engine 110, and as a result thereof, can be said to be equal to the intake temperature Ta. Thus, the dissipated air energy Ed is proportional to the difference between the intercooler temperature Ti and the intake temperature Ta. Formula (29) above is obtained on the basis thereof.

The intercooler internal energy change Ei is represented with the following formula (30).

Ei=d(M·Cv·Ti)/dt (30)

In the formula (30), M is the total air amount, Cv is the constant volume specific heat of air, and Ti is the intercooler temperature.

Thus, the following formula (31) is obtained from the previous formulas (19) to (30).

d(M·Cv·Ti)/dt=Cp·mcm·Ta+Ec−K·(Ti−Ta)−Cp·mt·Ti (31)

Since the specific heat ratio κ is represented with the following formula (32) and Mayer's relation is represented with the following formula (33), the previous formula (16) is obtained by modifying the formula (31) using these formulas (32) and (33).

κ=Cp/Cv (32)

Cp=Cv+R (33)

Next, an explanation is provided of the intake pipe model M6. Furthermore, since a technique for deriving the model formula that represents this intake pipe model M6 is commonly available (see, for example, JP-A-2001-041095 and JP-A-2003-184613), a detailed explanation relating to the method of deriving this intake pipe model M6 is omitted.

The intake pipe model M6 is a model for calculating the intake pipe pressure and the intake pipe temperature based on the following model formulas (34) and (35) that were derived using the mass conservation law and the energy conservation law.

d(Pm/Tm)/dt=(R/Vm)·(mt−mc) (34)

dPm/dt=κ·(R/Vm)·(mt·Ti−mc·Tm) (35)

In these model formulas (34) and (35), Pm is the intake pipe pressure to be calculated by the current model arithmetic processing, Tm is the intake pipe temperature to be calculated by the current model arithmetic processing, R is a gas constant, Vm is the volume of the intake passage between the throttle valve 46 and the intake valve 32, mt is the throttle valve passage air flow rate that is calculated by arithmetic processing in accordance with the throttle model M2, mc is the in-cylinder intake air flow rate that is calculated by arithmetic processing in accordance with the intake valve model M3, Ti is the intercooler temperature that is calculated by arithmetic processing in accordance with the intercooler model M5, and κ is the specific heat ratio of air.

The following provides an explanation of the intake valve model M7. The intake valve model M7 is a model for calculating the in-cylinder intake air flow rate based on the following model formulas (36) and (37) that were derived using empirical laws.

mc=(Ti/Tm)·(c·Pm−d) (36)

KLfwd=mc−Tint (37)

In the model formulas (36) and (37) above, mc is the in-cylinder intake air flow rate to be calculated by the current arithmetic processing in accordance with the intake valve model M7 (to be referred to as “model arithmetic processing”), Ti is the intercooler temperature, Tm is the intake pipe temperature, Pm is the intake pipe pressure, c is a proportionality coefficient corresponding to engine rotating speed and intake valve opening and closing timing, d is a value that corresponds to the amount of unburned gas remaining in the combustion chamber 25 without being discharged from the combustion chamber 25 into the exhaust passage during the exhaust stroke, and corresponds to engine rotating speed and intake valve opening and closing timing, KLfwd is the in-cylinder intake air amount, namely the total amount of air that flows into the combustion cylinder 25 during the intake stroke, to be calculated by the current model arithmetic processing, and Tint is the time from opening to closing of the intake valve 32.

Furthermore, in the model formula (36) above, the intake pipe pressure Pm is used as a variable, instead of the in-cylinder pressure for the same reason as explained with respect to the above-mentioned model formula (14). In addition, the proportionality coefficient c is the same as the proportionality coefficient c explained with respect to the intake valve model M3, and is determined from the above-mentioned map Mc (see FIG. 27) based on the engine rotating speed NE and the intake valve opening and closing timing VT in the same manner as the intake valve model M3. In addition, the value d is also the same as the value d explained with respect to the intake valve model M3, and is determined from the above-mentioned map Md (see FIG. 28) based on the engine rotating speed NE and the intake valve opening and closing timing VT in the same manner as the intake valve model M3.

However, in the case of the compressor outflow air flow rate being calculated in the manner described above, a certain amount of time is required from the start of arithmetic processing that calculates the compressor outflow air flow rate until completion of that arithmetic processing. In addition, there are also cases in which a certain amount of time is also required from completion of arithmetic processing that calculates the compressor outflow air flow rate until the in-cylinder intake air amount, which is calculated by using the calculated compressor outflow air flow rate, is actually used to control operation of the internal combustion engine. Here, in the case the change in the compressor outflow air flow rate during the short period of time after the start of arithmetic processing that calculates the compressor outflow air flow rate is comparatively small, the calculated compressor outflow air flow rate coincides with the actual compressor outflow air flow rate when the in-cylinder intake air amount calculated using the compressor outflow air flow rate is used to control operation of the internal combustion engine, and in this case, the in-cylinder intake air amount calculated using the compressor outflow air flow rate can also be said to coincide with the actual in-cylinder intake air amount when it is used to control operation of the internal combustion engine. However, in the case the change in the compressor outflow air flow rate during the short period of time after the start of arithmetic processing that calculates the in-cylinder intake air amount is comparatively large, when the in-cylinder intake air amount calculated using the calculated compressor outflow air flow rate is used to control operation of the internal combustion engine, the actual compressor outflow air flow rate changes considerably in comparison with that when arithmetic processing that calculates the compressor outflow air flow rate was begun. In this case, the compressor outflow air flow rate calculated in the manner described above cannot be said to coincide with the actual compressor outflow air flow rate when the in-cylinder intake air amount calculated using the compressor outflow air flow rate is used to control operation of the internal combustion engine. Thus, the in-cylinder intake air amount calculated using this compressor outflow air flow rate can also not be said to coincide with the actual in-cylinder intake air amount when it is used to control operation of the internal combustion engine.

Therefore, in this embodiment, in the case it has been determined during execution of arithmetic processing that calculates the in-cylinder intake air amount that the compressor outflow air flow rate calculated in the manner described above cannot be said to coincide with the actual compressor outflow air flow rate when the in-cylinder intake air amount calculated using the compressor outflow air flow rate is used to control operation of the internal combustion engine, the compressor outflow air flow rate that is calculated by arithmetic processing in accordance with the compressor model M4 is corrected so that the in-cylinder intake air amount calculated by that arithmetic processing coincides with the actual in-cylinder intake air amount when it is used to control operation of the internal combustion engine.

Namely, when a difference between a target throttle opening and an actual throttle opening at the start of in-cylinder intake air amount arithmetic processing (namely, arithmetic processing that calculates the in-cylinder intake air amount) is larger than a predetermined opening difference, the throttle opening can be said to be being changed comparatively considerably in order to make the actual throttle opening the target throttle opening. Therefore, in this embodiment, when the difference between the target throttle opening and the actual throttle opening (predicted throttle opening in this embodiment) at the start of in-cylinder intake air amount arithmetic processing is calculated and that difference is larger than a predetermined opening difference, the compressor outflow air flow rate calculated by arithmetic processing in accordance with the compressor model M5 is corrected in the manner described below, thereby correcting the in-cylinder intake air amount that is calculated by using that compressor outflow air flow rate.

Namely, when the difference between the predicted throttle opening and the target throttle opening at the start of in-cylinder intake air amount arithmetic processing in accordance with the above-mentioned models M2 to M7 (to be referred to as “model arithmetic processing”) is comparatively large, the change in the throttle opening during the short period of time after the start of model arithmetic processing is assumed to be large. In the case the change in the throttle opening is large, the change in the throttle valve passage air flow rate is also large, and the change in the compressor outflow air flow rate can therefore also be said to be large. For these reasons, in this embodiment, when the difference between the predicted throttle opening and the target throttle opening is larger than a predetermined opening difference, the change in the compressor outflow air flow rate is determined to be larger than a predetermined amount of change, and thus, the change in the in-cylinder intake air amount is also determined to be larger than a predetermined amount of change, thereby resulting in correction of the compressor outflow air flow rate calculated by arithmetic processing in accordance with the compressor model M4.

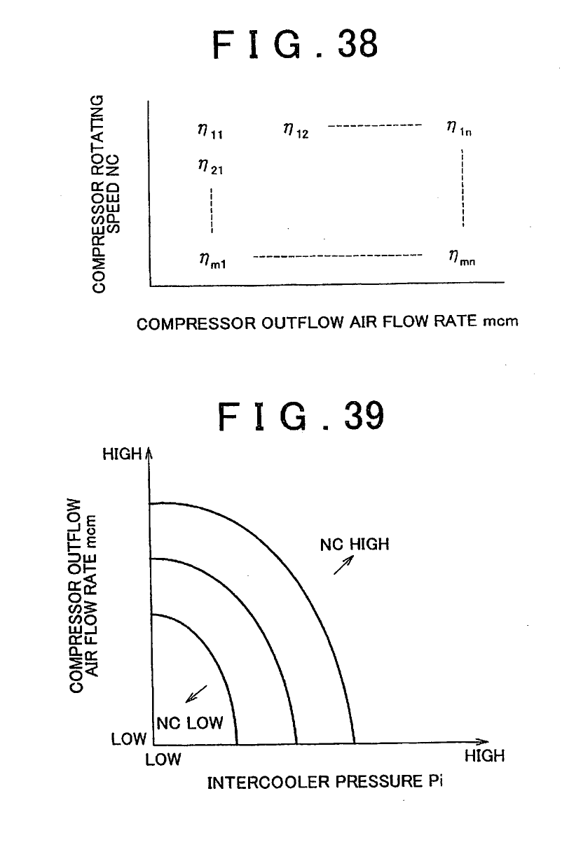

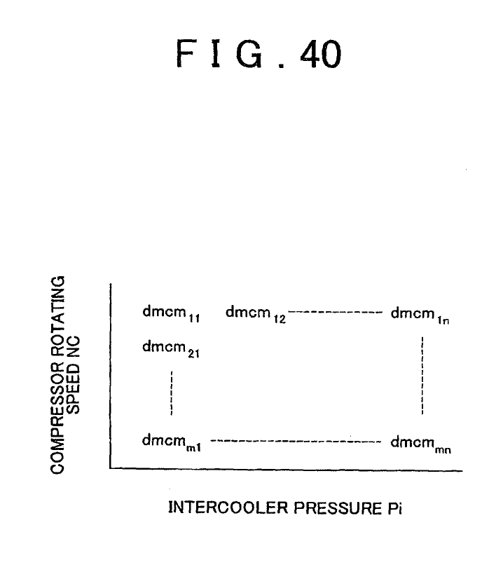

Namely, the relationship among the intercooler pressure Pi, the compressor rotating speed NC and the compressor outflow air flow rate mcm is as shown in FIG. 39. Namely, provided that the compressor rotating speed NC is constant, the compressor outflow air flow rate mcm decreases as the intercooler pressure Pi increases, and provided that the intercooler pressure Pi is constant, the compressor outflow air flow rate increases as the compressor rotating speed NC increases. As can be understood from FIG. 39, the amount of change in compressor outflow air flow rate can be determined if the amount of change in intercooler pressure is multiplied by the slope at a point on a curve indicating the relationship between intercooler pressure and compressor outflow air flow rate corresponding to each compressor rotating speed, the point corresponding to a certain specific intercooler pressure. Therefore, in this embodiment, a map Mdmcm, which defines the relationship among the compressor rotating speed NC, the intercooler pressure Pi and the slope dmcm corresponding thereto, is stored in advance in the ROM 172 in a form like that shown in FIG. 40. When the amount of change in the compressor outflow air flow rate has been determined to be larger than a predetermined amount of change, the slope dmcm is determined from the map Mdmcm based on the compressor rotating speed NC and the intercooler pressure Pi. A correction amount Δmcm(k) for compressor outflow air flow rate is then calculated by calculating the difference ΔPi(k) between the intercooler pressure Pi(k) at the current model estimation time point and the intercooler pressure Pi(k−1) at the previous model estimation time point (namely, Pi(k)−Pi(k−1)), and then multiplying the calculated difference ΔPi(k) by the above-mentioned slope dmcm. Here, the calculated difference Δmcm(k) is equivalent to the amount of change in the compressor outflow air flow rate that is likely to occur from the start of the current model arithmetic processing to the start of the next-model arithmetic processing. Thus, if this difference Δmcm(k) is added to the compressor outflow air flow rate mcm(k) calculated by the current model arithmetic processing, the resulting compressor outflow air flow rate can be said to coincide with or closely approximate the actual compressor outflow air flow rate at the start of the next model arithmetic processing.

Therefore, in this embodiment, correction is made by adding the correction amount Δmcm calculated in the manner described above to the compressor outflow air flow rate mcm calculated by the current model arithmetic processing.

Accordingly, if the intercooler pressure calculated by the current model arithmetic processing is higher than the intercooler pressure calculated by the previous model arithmetic processing, then the difference ΔPi is positive, and since the slope dmcm is a negative value, the correction amount Δmcm also becomes a negative value, thereby causing the compressor outflow air flow rate after correction to be smaller than the compressor outflow air flow rate before correction by the amount of the correction amount Δmcm. The compressor outflow air flow rate corrected in this manner is then used in arithmetic processing in accordance with the intercooler model M5, and as a result thereof, the in-cylinder intake air amount calculated by the current model arithmetic processing becomes smaller than the in-cylinder intake air amount calculated in the case of using the compressor outflow air flow rate before correction.

On the other hand, if the intercooler pressure calculated by the current model arithmetic processing is lower than the intercooler pressure calculated by the previous model arithmetic processing, then the difference ΔPi is negative, and since the slope dmcm is a negative value, the correction amount Δmcm becomes a positive value, thereby causing the compressor outflow air flow rate after correction to be larger than the compressor outflow air flow rate before correction by the amount of the correction amount Δmcm. The compressor outflow air flow rate corrected in this manner is then used in arithmetic processing in accordance with the intercooler model M5, and as a result thereof, the in-cylinder intake air amount calculated by the current model arithmetic processing becomes larger than the in-cylinder intake air amount calculated in the case of using the compressor outflow air flow rate before correction.

If the compressor outflow air flow rate is corrected in this manner, the in-cylinder intake air amount ultimately obtained by model arithmetic processing either coincides with the actual in-cylinder intake air amount at the time it is used to control operation of the internal combustion engine, or is at least closer to the actual in-cylinder intake air amount than the in-cylinder intake air amount calculated in the case of not correcting.

Furthermore, although a determination as to whether or not the amount of change in the compressor outflow air flow rate is larger than a predetermined amount of change is made based on the difference between the predicted throttle opening and the target throttle opening in this example, this determination may alternatively or additionally be made based on the amount of change in the intake pipe pressure. Namely, when the amount of change in the intake pipe pressure is comparatively large, the amount of change in the compressor outflow air flow rate during the short amount of time after the start of arithmetic processing is assumed to be large. In turn, in the case the amount of change in the compressor outflow air flow rate is large, the amount of change in the in-cylinder intake air amount can also be said to be large. Therefore, when the difference ΔPm(k) between the intake pipe pressure Pm(k−1) at the previous model arithmetic processing time point and the intake pipe pressure Pm(k) at the current model arithmetic processing time point is larger than a predetermined pressure difference, the amount of change in the compressor outflow air flow rate may be determined to be larger than the predetermined amount of change.

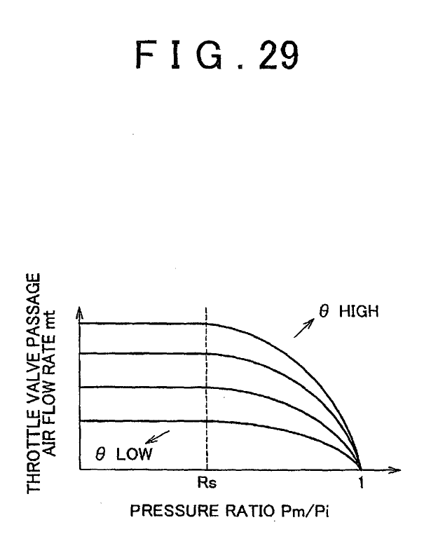

In addition, a determination as described below may be made instead of or in addition to the determination described above involving determination of whether or not the amount of change in the compressor outflow air flow rate is larger than a predetermined amount of change. Namely, the relationship between the ratio Pm/Pi of the intake pipe pressure Pm to the intercooler pressure Pi and the throttle valve passage air flow rate mt is as shown in FIG. 29. Namely, in the case the throttle opening θ is constant and the pressure ratio Pm/Pi is smaller than a specific pressure ratio Rs, the throttle valve passage air flow rate is constant regardless of the pressure ratio. On the other hand, in the case the throttle opening is constant and the pressure ratio is larger than the specific pressure ratio Rs, the throttle valve passage air flow rate becomes smaller as the pressure ratio increases. In addition, in the case the pressure ratio is constant, the throttle valve passage air flow rate becomes larger as the throttle opening increases.

Thus, when the pressure ratio Pm/Pi has increased beyond the specific pressure ratio Rs, the throttle valve passage air flow rate mt changes greatly even if the throttle opening θ is constant. In addition, when the pressure ratio has increased within a region in which it exceeds that specific pressure ratio, the throttle valve passage air flow rate changes greatly even if the throttle opening is constant. Conversely, when the pressure ratio has decreased beyond the specific pressure ratio, the throttle valve passage air flow rate changes greatly even if the throttle opening is constant, and when the pressure ratio has decreased within a region in which it exceeds the specific pressure ratio, the throttle valve passage air flow rate also changes greatly even if the throttle opening is constant.

In general, the compressor outflow air flow rate can be said to change greatly when the throttle valve passage air flow rate changes greatly. Therefore, when, from the previous model arithmetic processing time point to the current model arithmetic processing time point, the pressure ratio Pm/Pi has increased beyond the specific pressure ratio Rs, it has increased within a region in which it exceeds the specific pressure ratio, it has decreased beyond the specific pressure ratio, or it has decreased within a region in which it exceeds the specific pressure ratio, it may be determined that, during the short period of time after arithmetic processing, even if the throttle opening θ is constant, the throttle valve passage air flow rate mt changes greatly, and thus the compressor outflow air flow rate changes greatly and the in-cylinder intake air amount also changes greatly. When the compressor outflow air flow rate has been determined to change greatly, the in-cylinder intake air flow rate is corrected by correcting the compressor outflow air flow rate in the manner previously described.

In addition, the determination as to whether or not the amount of change in the compressor outflow air flow rate is larger than the predetermined amount of change may be alternatively or additionally made based on the amount of change in the compressor rotating speed. Namely, when the amount of change in the compressor rotating speed is large, the amount of change in the compressor outflow air flow rate can also be said to be large. Therefore, when the absolute value of a difference ΔNC(k) between the compressor rotating speed NC(k−1) at a previous model arithmetic processing time point and the compressor rotating speed NC(k) at the current model arithmetic processing time point (namely, NC(k)−NC(k−1)) is larger than a predetermined rotating speed difference ΔNCs, the amount of change in the compressor outflow air flow rate may be determined to be large.

In addition, the determination as to whether or not the amount of change in the compressor outflow air flow rate is larger than the predetermined amount of change may be made in the manner described below instead of or in addition to the determination described above. Namely, the difference ΔPi between the intercooler pressure at a previous model arithmetic processing time point and the intercooler pressure at the current model arithmetic processing time point, and the result of adding this difference ΔPi to the intercooler pressure at the current model arithmetic processing time point is calculated as a provisional intercooler pressure. This provisional intercooler pressure is equivalent to the intercooler pressure expected to be reached at the next model arithmetic processing time point. Moreover, the difference ΔNC between the compressor rotating speed at a previous model arithmetic processing time point and the compressor rotating speed at the current model arithmetic processing time point is calculated, and the result of adding this difference ΔNC to the compressor rotating speed at the current model arithmetic processing time point is calculated as a provisional compressor rotating speed. This provisional compressor rotating speed is equivalent to the compressor rotating speed expected to be reached at the next model arithmetic processing time point.

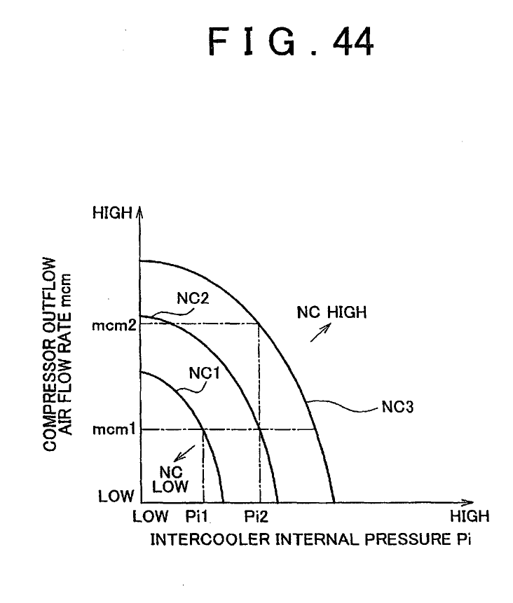

Here, an explanation will be provided with reference to FIG. 44. If the intercooler pressure at the current model arithmetic processing time point is designated as Pi1, and the compressor rotating speed at the current model arithmetic processing time point is designated as NC1, the compressor outflow air flow rate is a flow rate mcm1. Here, in the case the intercooler pressure at the next model arithmetic processing time point is assumed to be the above-mentioned provisional intercooler pressure Pi2, the compressor outflow air flow rate is a flow rate equal to the compressor outflow air flow rate mcm1 at the current model arithmetic processing time point if the compressor rotating speed is a compressor rotating speed NC2. Thus, if the provisional compressor rotating speed is the rotating speed NC2, the compressor outflow air flow rate either does not change or at least does not change greatly during the time from the current model arithmetic processing time point to the next model arithmetic processing time point. On the other hand, if the provisional compressor rotating speed is a rotating speed NC3 larger than the rotating speed NC2, since the compressor outflow air flow rate increases to the flow rate mcm2, the compressor outflow air flow rate changes greatly during the time from the current model arithmetic processing time point to the next model arithmetic processing time point. Also in the case the provisional compressor rotating speed is smaller than the compressor rotating speed NC2, the compressor outflow air flow rate changes greatly during the time from the current model arithmetic processing time point to the next model arithmetic processing time point.

Therefore, even in the case the provisional intercooler pressure and the provisional compressor rotating speed are calculated in the manner described above and the intercooler pressure has reached the provisional intercooler pressure, the compressor rotating speed at which the compressor outflow air flow rate becomes equal to the flow rate at the current model arithmetic processing time point is determined as a reference compressor rotating speed. When the difference between this reference compressor rotating speed and the provisional compressor rotating speed is larger than a predetermined difference in rotating speeds, it may be determined that the amount of change in the compressor outflow air flow rate will become larger than the predetermined amount of change.

Furthermore, in the case of using this determination, if the provisional compressor rotating speed is larger than the reference compressor rotating speed, the compressor outflow air flow rate is corrected so that the compressor outflow air flow rate increases. On the other hand, if the provisional compressor rotating speed is smaller than the reference compressor rotating speed, the compressor outflow air flow rate is corrected so that the compressor outflow air flow rate decreases.

In addition, the determination as to whether or not the amount of change in the compressor outflow air flow rate is larger than a predetermined amount of change may be made in the manner described below instead of or in addition to the determination described above. Namely, the compressor 191a is rotated as a result of the exhaust turbine 191b being rotated by exhaust gas. Thus, if the energy received by the exhaust turbine 191b from the exhaust gas and the energy imparted to air by the compressor 191a are equal, the compressor rotating speed does not change. However, if the energy imparted to air by the compressor 191a is smaller than the energy received by the exhaust turbine 191b from the exhaust gas, the compressor rotating speed increases, while conversely, if the energy imparted to air by the compressor 191a is larger than the energy received by the exhaust turbine 191b from the exhaust gas, the compressor rotating speed decreases.

Therefore, when the absolute valve of the difference between the energy received by the exhaust turbine 191b from the exhaust gas and the energy imparted to air by the compressor 191a is larger than a predetermined energy difference, the amount of change in the compressor outflow air flow rate may be determined to be larger than a predetermined amount of change.

Furthermore, in the case of using this determination, if the energy imparted to the air by the compressor 191a is smaller than the energy received by the exhaust turbine 191b from the exhaust gas, the compressor outflow air flow rate is corrected so that the compressor outflow air flow rate increases. On the other hand, if the energy imparted to air by the compressor 191a is larger than the energy received by the exhaust turbine 191b from the exhaust gas, the compressor outflow air flow rate is corrected so that the compressor outflow air flow rate decreases.

In addition, although the difference between the intercooler pressure calculated by the previous model arithmetic processing and the intercooler pressure calculated by the current model arithmetic processing is used as the correction amount of the compressor outflow air flow rate in the example described above, a value calculated in the manner described below may be used instead for the correction amount of the compressor outflow air flow rate. Namely, the difference Δmcm(k) between the compressor outflow air flow rate mcm(k) before correction as calculated by the current model arithmetic processing and the compressor outflow air flow rate mcm(k−1) calculated by the previous model arithmetic processing (namely, mcm(k)−mcm(k−1)) is calculated. The difference Δmcm(k) calculated here can be considered to be equivalent to the amount of change in the compressor outflow air flow rate from the start of the current model arithmetic processing to the start of the next model arithmetic processing. Thus, if this difference Δmcm(k) is added to the compressor outflow air flow rate mcm(k) calculated by the current model arithmetic processing, the resulting compressor outflow air flow rate can be said to at least coincide with the actual compressor outflow air flow rate at the start of the next model arithmetic processing.

Therefore, in this example, correction is made by adding the difference Δmcm(k) calculated in the manner described above to the compressor outflow air flow rate calculated by the current model arithmetic processing.

Accordingly, if the compressor outflow air flow rate before correction as calculated by the current model arithmetic processing is larger than the compressor outflow air flow rate calculated by the previous model arithmetic processing, since the above-mentioned difference Δmcm(k) becomes a positive value, the compressor outflow air flow rate after correction is larger than the compressor outflow air flow rate before correction by the amount of the difference Δmcm(k). The compressor outflow air flow rate corrected in this manlier is then used in arithmetic processing in accordance with the intercooler model M5, and as a result, the in-cylinder intake air amount calculated by the current model arithmetic processing is larger than the in-cylinder intake air amount calculated in the case of using the compressor outflow air flow rate before correction.

On the other hand, if the compressor outflow air flow rate before correction as calculated by the current model arithmetic processing is smaller than the compressor outflow air flow rate calculated by the previous model arithmetic processing, since the difference Δmcm(k) becomes a negative value, the compressor outflow air flow rate after correction is smaller than the compressor outflow air flow rate before correction by the amount of this difference Δmcm(k). The compressor outflow air rate corrected in this manner is then used in arithmetic processing in accordance with the intercooler model M5, and as a result, the in-cylinder intake air amount calculated by the current model arithmetic processing is smaller than the in-cylinder intake air amount calculated in the case of using the compressor outflow air flow rate before correction.

Even if the compressor outflow air flow rate is corrected in this manner, the in-cylinder intake air amount ultimately obtained by model arithmetic processing coincides with the actual in-cylinder intake air amount at the time it is used to control operation of the internal combustion engine, or is at least closer to the actual in-cylinder intake air amount than the in-cylinder intake air amount calculated in the case the in-cylinder air intake amount is not corrected.

In many cases, however, the throttle valve passage air flow rate increases as the throttle opening increases, while conversely the throttle valve passage air flow rate decreases as the throttle opening decreases. However, as explained with reference to FIG. 29, in the case the pressure ratio Pm/Pi is larger than the above-mentioned specific pressure ratio Rs, the throttle valve passage air flow rate mt decreases when the pressure ratio increases even if the throttle opening θ is constant. Thus, even if the throttle opening has increased, when the pressure ratio increases to a certain value or more at this time, the throttle valve passage air flow rate decreases, while conversely, even if the throttle opening has decreased, if the pressure ratio decreases to a certain value or less, the throttle valve passage air flow rate increases.

Therefore, the determination as to whether or not the amount of change in the in-cylinder intake air amount during the short period of time after the start of model arithmetic processing is larger than a predetermined amount of change may use the method described below instead of or in addition to the method described above.

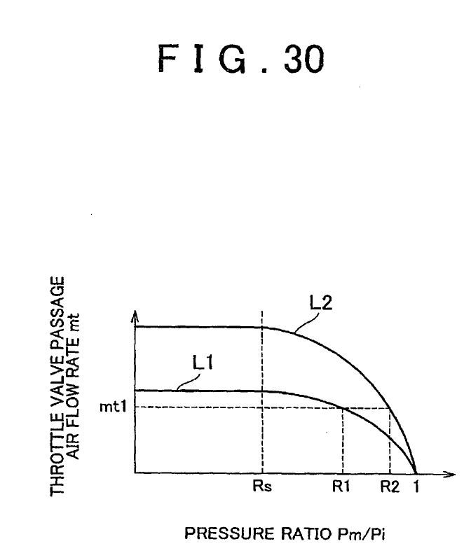

For example, the throttle opening θ at the previous model arithmetic processing time point is assumed to have been an opening θ1. In this case, the throttle valve passage air flow rate mt changes following the solid line L1 of FIG. 30 in accordance with the pressure ratio Pm/Pi. Thus, in the case the pressure ratio at the previous model arithmetic processing time point had a value of R1, the throttle valve passage air flow rate at the previous model arithmetic processing time point has a value of mt1. Here, the throttle opening at the current model arithmetic processing time point is assumed to be an opening θ2 larger than the opening θ1 at the previous model arithmetic processing time point. In this case, the throttle valve passage air flow rate mt changes following the solid line L2 of FIG. 30 in accordance with the pressure ratio. Here, when the throttle valve passage air flow rate at the current model arithmetic processing time point is equal to the throttle valve passage air flow rate mt1 at the previous model arithmetic processing time point, the pressure ratio at the current model arithmetic processing time point becomes a value R2 that is larger than the above-mentioned specific pressure ratio Rs. In other words, even if the throttle opening has changed to the opening θ2 that is larger than the opening θ1, if the pressure ratio becomes larger than the value R1 and changes to the value R2 that is larger than the specific pressure ratio Rs, it means that the throttle valve passage air flow rate at the current model arithmetic processing time point has not changed from the throttle valve passage air flow rate at the previous model arithmetic processing time point. Thus, even if the throttle opening is larger than the opening θ1 and has changed to the opening θ2, if the pressure ratio at the current model arithmetic processing time point has changed to a value larger than the value R2, the throttle valve passage air flow rate at the current model arithmetic processing time point is smaller than the throttle valve passage air flow rate at the previous model arithmetic processing time point. On the other hand, when the throttle opening is larger than the opening θ1 and has changed to the opening θ2, and the pressure ratio has changed to a value smaller than the value R2, the throttle valve passage air flow rate at the current model arithmetic processing time point is larger than the throttle valve passage air flow rate at the previous model arithmetic processing time point.

In addition, in the case the throttle opening θ at the previous model arithmetic processing time point was the opening θ2 and the pressure ratio Pm/Pi was the value R2 that is larger than the specific pressure ratio Rs, the throttle valve passage air flow rate at the previous model arithmetic processing time point is the value mt1. Here, the throttle opening at the current model arithmetic processing time point is assumed to have been smaller than the opening θ2 at the previous model arithmetic processing time point and become the opening θ1. Here, if the throttle valve passage air flow rate at the current model arithmetic processing time point is assumed to be equal to the throttle valve passage air flow rate mt1 at the previous model arithmetic processing time point, this means that the pressure ratio at the current model arithmetic processing time point becomes the value R1. In other words, even if the throttle opening has changed to the opening θ1 smaller than the opening θ2, if the pressure ratio has changed to the value R1 that is smaller than the value R2, it means that the throttle valve passage air flow rate at the current model arithmetic processing time point has not changed from the throttle valve passage air flow rate at the previous model arithmetic processing time point. Thus, even if the throttle opening has changed to the opening θ1 that is smaller than the opening θ2, if the pressure ratio has changed to a value smaller than the value R1, the throttle valve passage air flow rate at the current model arithmetic processing time point is larger than the throttle valve passage air flow rate at the previous model arithmetic processing time point. On the other hand, if the pressure ratio has changed to a value larger than the value R1 when the throttle opening has changed to an opening θ1 that is smaller than the opening θ2, the throttle valve passage air flow rate at the current model arithmetic processing time point is smaller than the throttle valve passage air flow rate at the previous model arithmetic processing time point.

In this manner, when the pressure ratio at the current model arithmetic processing time point has increased from the pressure ratio at the previous model arithmetic processing time point beyond the above-mentioned specific pressure ratio, or the pressure ratio at the current model arithmetic processing time point has become larger than the pressure ratio at the previous model arithmetic processing time point in a region larger than the specific time ratio, the throttle valve passage air flow rate changes greatly regardless of whether or not the throttle opening at the current model arithmetic processing time point has changed from the throttle opening at the previous model arithmetic processing time point. Conversely, when the pressure ratio at the current model arithmetic processing time point has decreased from the pressure ratio at the previous model arithmetic processing time point beyond the specific pressure ratio, or the pressure ratio at the current model arithmetic processing time point has become smaller than the pressure ratio at the previous model arithmetic processing time point in a region larger than the specific pressure ratio, the throttle valve passage air flow rate changes greatly regardless of whether or not the throttle opening at the current model arithmetic processing time point has changed from the throttle opening at the previous model arithmetic processing time point.

Therefore, when the pressure ratio has increased beyond the above-mentioned specific pressure ratio during the time from the previous model arithmetic processing time point to the current model arithmetic processing time point, when it has increased in a region larger than the specific pressure ratio, when it has decreased beyond the specific pressure ratio, or when it has decreased in a region larger than the specific pressure ratio, the throttle valve passage air flow rate changes greatly during the short time after the start of the current model arithmetic processing regardless of the presence or absence of a change in the throttle opening, and the in-cylinder intake air amount is therefore determined to change greatly. In this case, a difference ΔPm/Pi(k) between the pressure ratio Pm/Pi(k−1) at the previous model arithmetic processing time point and the pressure ratio Pm/Pi(k) at the current model arithmetic processing time point (namely, Pm/Pi(k−1)−Pm/Pi(k)) is calculated, and this calculated difference ΔPm/Pi(k) is used instead of the pressure ratio Pm/Pi in the above-mentioned model formula (12) to carry out calculations in accordance with that model formula (12). The value calculated by this calculation is the amount of change Δmt(k) in the throttle valve passage air flow rate, and can be considered to be equivalent to the amount of change in throttle valve passage air flow rate during the time from the start of the current model arithmetic processing to the start of the next model arithmetic processing. Therefore, correction is made by adding the amount of change Δmt(k) in the throttle valve passage air flow rate calculated in this manner to the throttle valve passage air flow rate mt(k) calculated by the current model arithmetic processing.

Accordingly, if the pressure ratio at the current model arithmetic processing time point is larger than the pressure ratio Pm/Pi at the previous model arithmetic processing time point, the difference ΔPm/Pi is a negative value, and since the above-mentioned amount of change Δmt also becomes a negative value, the throttle valve passage air flow rate after correction becomes smaller than the throttle valve passage air flow rate before correction by the amount of change Δmt. The throttle valve passage air flow rate corrected in this manner is then used in arithmetic processing in accordance with the intake pipe model M6, and as a result, the in-cylinder intake air amount calculated by the current model arithmetic processing becomes smaller than the in-cylinder intake air amount calculated in the case of having used the throttle valve passage air flow rate before correction.

On the other hand, if the pressure ratio at the current model arithmetic processing time point is smaller than the pressure ratio Pm/Pi at the previous model arithmetic processing time point, the difference ΔPm/Pi is a positive value, and since the amount of change Δmt also becomes a positive value, the throttle valve passage air flow rate after correction becomes larger than the throttle valve passage air flow rate before correction by the amount of change Δmt. The throttle valve passage air flow rate corrected in this manner is then used in arithmetic processing in accordance with the intake pipe model M6, and as a result, the in-cylinder intake air amount calculated by the current model arithmetic processing becomes larger than the in-cylinder intake air amount calculated in the case of having used the throttle valve passage air flow rate before correction.

If the throttle valve passage air flow rate is corrected in this manner, the in-cylinder intake air amount ultimately obtained by model arithmetic processing coincides with the actual in-cylinder intake air amount at the time it is used to control operation of the internal combustion engine, or is at least closer to the actual in-cylinder intake air amount than the in-cylinder intake air amount calculated in the case the in-cylinder air intake amount is not corrected.

Furthermore, in an embodiment in which the throttle valve passage air flow rate calculated by the current model arithmetic processing is corrected when it has been determined that the amount of change in the in-cylinder intake air amount during the short time after the start of model arithmetic processing is larger than a predetermined amount of change, correction of the throttle valve passage air flow rate may also be carried out in the manner described below in the case the intake pipe pressure is constant.

Namely, in the case the intake pipe pressure Pm is constant, the intake pipe pressure does not serve as a variable in the formula (12) of the throttle model M2. In addition, since the intercooler pressure Pi and the intercooler temperature Ti can be considered to be substantially equal to atmospheric pressure and atmospheric temperature, respectively, and substantially constant, the intercooler pressure and intercooler temperature also do not serve as variables in formula (12) of the throttle model M2. Thus, in this case, the only portion of formula (12) of the throttle model M2 that serves as a variable is the product C(θ)·A(θ) that changes in accordance with the throttle opening θ. The relationship between the throttle opening θ and the product C(θ)·A(θ) is as shown in FIG. 26.

Therefore, the map Mca, which defines the relationship between the throttle opening θ and the product C(θ)·A(θ), is determined and stored in advance in the ROM 172 in a form like that shown in FIG. 26. Since the difference between the predicted throttle opening and the target throttle opening is larger than a predetermined opening difference, the amount of change in the in-cylinder intake air amount during the short time after the start of the current model arithmetic processing is determined to be larger than a predetermined amount of change, and when the intake pipe pressure Pm from the previous model arithmetic processing time point to the current model arithmetic processing time point is constant, a difference ΔC(θ)·A(θ) with respect to the product C(θ)·A(θ) is determined from the above-mentioned map Mca (see FIG. 26) based on the difference Δθ between the predicted throttle opening θe and the target throttle opening θt (namely, θt−θe). Calculation is then carried out in accordance with the model formula (12) by using the difference ΔC(θ)·A(θ) determined in this manner instead of the product C(θ)·(θ) in the model formula (12). The value calculated according to this calculation is the amount of change Δmt(k) in the throttle valve passage air flow rate, and can be considered to be equivalent to the amount of change in the throttle valve passage air flow rate during the time from the start of the current model arithmetic processing to the start of the next model arithmetic processing. Therefore, correction is made by adding the amount of change Δmt(k) in the throttle valve passage air flow rate calculated in this manner to the throttle valve passage air flow rate mt(k) calculated according to the current model arithmetic processing.

Accordingly, if the predicted throttle opening is smaller than the target throttle opening, since the above-mentioned difference Δθ is a positive valve, the throttle valve passage air flow rate after correction is larger than the throttle valve passage air flow rate before correction by the amount of change Δmt(k). The throttle valve passage air flow rate corrected in this manner is then used in arithmetic processing in accordance with the intake pipe model M6, and as a result, the in-cylinder intake air amount calculated according to this current model arithmetic processing is larger than the in-cylinder intake air amount calculated in the case of having used the throttle valve passage air flow rate before correction. In this case, the calculated in-cylinder intake air amount can be said to at least coincide with the actual in-cylinder intake air amount at the time a short period of time has elapsed from the start of the current model arithmetic processing.

On the other hand, if the predicted throttle opening is larger than the target throttle opening, since the difference Δθ is a negative value, the throttle valve passage air flow rate after correction is smaller than the throttle valve passage air flow rate before correction by the amount of change Δmt(k). The throttle valve passage air flow rate corrected in this manner is then used in arithmetic processing in accordance with the intake pipe model M6, and as a result, the in-cylinder intake air amount calculated according to this current model arithmetic processing is smaller than the in-cylinder intake air amount calculated in the case of having used the throttle valve passage air flow rate before correction. In this case, the calculated in-cylinder intake air amount can be said to at least coincide with the actual in-cylinder intake air amount at the time a short period of time has elapsed from the start of the current model arithmetic processing.

Naturally, the amount of change in the product C(θ)·A(θ) can be determined by multiplying the amount of change of the throttle opening θ by the slope at the corresponding point on the curve indicating the relationship between the throttle opening θ and the product C(θ)·A(θ) as can be understood from FIG. 26. Therefore, a method may be adopted in which a map that defines the relationship between the throttle opening θ and the slope corresponding thereto is determined and stored in advance in the ROM 172, the slope is determined from the map based on the throttle opening θ, the amount of change in the product C(θ)·A(θ) is determined by multiplying the amount of change in the throttle opening θ by the slope, and the correction amount for the throttle valve passage air flow rate is calculated on the basis thereof.

In addition, in an embodiment in which the throttle valve passage air flow rate calculated by the current model arithmetic processing is corrected when the amount of change in the in-cylinder intake air amount during the short period of time after the start of model arithmetic processing is determined to be larger than a predetermined amount of change, correction of the throttle valve passage air flow rate may be carried out in the manner described below in the case the throttle opening is constant.

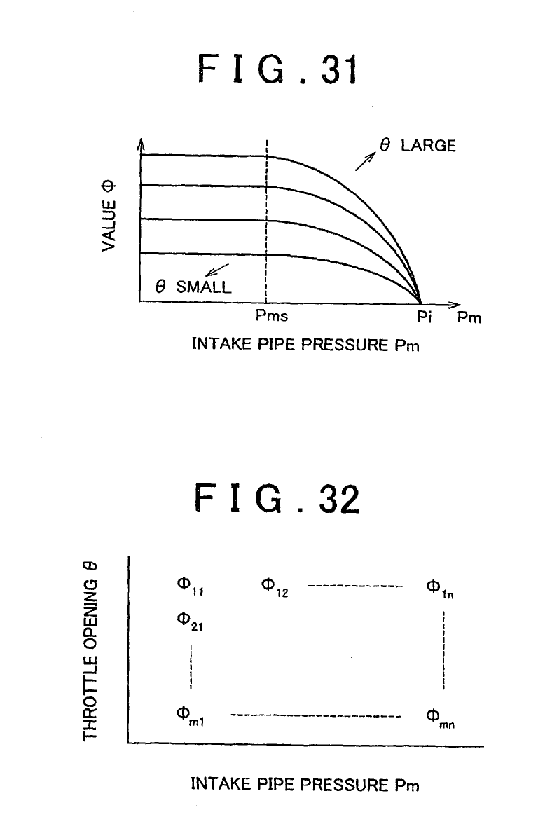

Namely, in the case the throttle opening θ is constant, the throttle opening does not serve as a variable in formula (12) of the throttle model M2. In addition, since the intercooler pressure Pi and the intercooler temperature Ti can be considered to be substantially equal to atmospheric pressure and atmospheric temperature, respectively, and substantially constant, the intercooler pressure and intercooler temperature also do not serve as variables in formula (12) of the throttle model M2. Thus, in this case, the portion of formula (12) of the throttle model M2 that serves as a variable is the value Φ(Pm/Pi) that changes in accordance with the intake pipe pressure Pm. The relationship between the intake pipe pressure Pm and the value Φ(Pm/Pi) is as shown in FIG. 31. Namely, in the case the throttle opening θ is constant and the pressure ratio Pm/Pi is smaller than the specific pressure ratio Rs, the value Φ(Pm/Pi) is constant regardless of the pressure ratio. On the other hand, in the case the throttle opening is constant and the pressure ratio is larger than the specific pressure ratio Rs, the value Φ(Pm/Pi) decreases as the pressure ratio increases. In addition, in the case the pressure ratio is constant, the value Φ(Pm/Pi) increases as the throttle opening increases.

Therefore, the map MΦ, which defines the relationship among the intake pipe pressure Pm, the throttle opening θ and the value Φ(Pm/Pi), is determined and stored in advance in the ROM 172 in a form like that shown in FIG. 32. Since the difference ΔPm(k) between the intake pipe pressure Pm(k−1) at the previous model arithmetic processing time point and the intake pipe pressure Pm(k) at the current model arithmetic processing time point (namely, Pm(k−1)−Pm(k)) is larger then a predetermined pressure difference, the amount of change in the in-cylinder intake air amount during the short time after the start of the current model arithmetic processing is determined to be larger than a predetermined amount of change, and when the throttle opening θ from the previous model arithmetic processing time point to the current model arithmetic processing time point is constant, a difference ΔΦ(Pm/Pi) in the value Φ(Pm/Pi) is determined from the above-mentioned map MΦ based on the difference ΔPm(k). Calculation is then carried out in accordance with the model formula (12) by using the difference ΔΦ(Pm/Pi) determined in this manner instead of the value Φ(Pm/Pi) in the model formula (12). The value calculated according to this calculation is the amount of change Δmt(k) in the throttle valve passage air flow rate, and can be considered to be equivalent to the amount of change in the throttle valve passage air flow rate during the time from the start of the current model arithmetic processing to the start of the next model arithmetic processing. Therefore, correction is made by adding the amount of change Δmt(k) in the throttle valve passage air flow rate calculated in this manner to the throttle valve passage air flow rate mt(k) calculated according to the current model arithmetic processing.

Accordingly, if the intake pipe pressure at the current model arithmetic processing time point is smaller than the intake pipe pressure at the pervious model arithmetic processing time point, since the above-mentioned difference ΔPm(k) is a positive valve, the throttle valve passage air flow rate after correction is larger than the throttle valve passage air flow rate before correction by the amount of change Δmt(k). The throttle valve passage air flow rate corrected in this manner is then used in arithmetic processing in accordance with the intake pipe model M6, and as a result, the in-cylinder intake air amount calculated according to this current model arithmetic processing is larger than the in-cylinder intake air amount calculated in the case of having used the throttle valve passage air flow rate before correction.

On the other hand, if the intake pipe pressure at the current model arithmetic processing time point is larger than the intake pipe pressure at the previous model arithmetic processing time point, since the difference ΔPm(k) is a negative value, the throttle valve passage air flow rate after correction is smaller than the throttle valve passage air flow rate before correction by the amount of change Δmt(k). The throttle valve passage air flow rate corrected in this manner is then used in arithmetic processing in accordance with the intake pipe model M6, and as a result, the in-cylinder intake air amount calculated according to this current model arithmetic processing is smaller than the in-cylinder intake air amount calculated in the case of having used the throttle valve passage air flow rate before correction.

If the throttle valve passage air flow rate is corrected in this manner, the in-cylinder intake air amount ultimately obtained by model arithmetic processing coincides with the actual in-cylinder intake air amount at the time it is used to control operation of the internal combustion engine, or at least is closer to the actual in-cylinder intake air amount than the in-cylinder intake air amount calculated in the case the in-cylinder air intake amount is not corrected.

Naturally, the amount of change in the value Φ(Pm/Pi) can be determined by multiplying the amount of change in the pressure ratio Pm/Pi by the slope at a point that corresponds to a certain specific pressure ratio Pm/Pi on the curve indicating the relationship between the pressure ratio Pm/Pi corresponding to each throttle opening θ and the value Φ(Pm/Pi) as can be understood from FIG. 29. Therefore, a method may be adopted in which a map that defines the relationship among the throttle opening θ, the pressure ratio Pm/Pi and the slope corresponding thereto is determined and stored in advance in the ROM 172, the slope is determined from the map based on the throttle opening θ and pressure ratio Pm/Pi, the amount of change in the value Φ(Pm/Pi) is determined by multiplying the pressure change Pm/Pi by the slope, and the correction amount for the throttle valve passage air flow rate is calculated on the basis thereof.

Furthermore, as can be understood by observing the relationship between the intake pipe pressure Pm and the value Φ(Pm/Pi) shown in FIG. 31, even if the above-mentioned difference ΔPm(k) is greater than the predetermined pressure difference, in the case the intake pipe pressure at the previous model arithmetic processing time point and the intake pipe pressure at the current model arithmetic processing time point are both smaller than the specific pressure Ps, the above-mentioned difference ΔΦ(Pm/Pi) determined from the map stored in the ROM 172 becomes zero. Consequently, the amount of change Δmt(k) in the throttle valve passage air flow rate calculated according to the model formula (12) becomes zero. As a result, the throttle valve passage air flow rate in this case is not corrected, and the in-cylinder intake air amount is also not corrected.

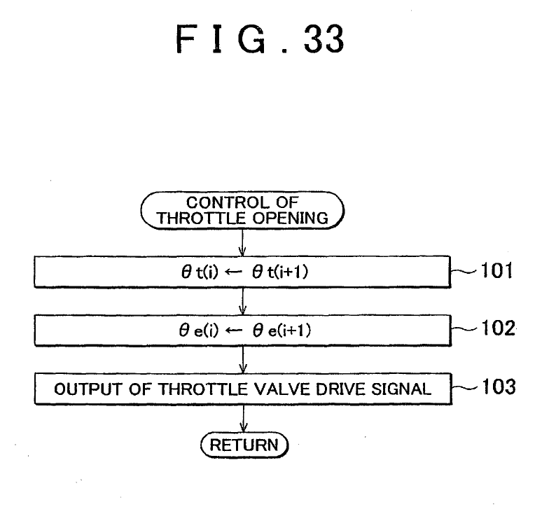

Next, an explanation is provided of examples of routines that calculate the in-cylinder intake air amount in accordance with this embodiment. Examples of these routines are shown in FIGS. 33, and 41 to 43.

The routine shown in FIG. 33 is a routine that executes arithmetic processing in accordance with the electronically controlled throttle valve model M1, and is executed at each of the above-mentioned prescribed time intervals ΔT1. When this routine is started, the target throttle opening θt(i+1) is first determined in Step 101 from a map Mθ shown in FIG. 24 based on the accelerator pedal depression amount Accp detected by the accelerator depression amount sensor 165. This is then stored in the ROM 172 as the target throttle opening θt(i) after the above-mentioned prescribed delay time TD from the current model arithmetic processing time point. Next, in Step 102, the predicted throttle opening θe(i+1) is calculated in accordance with the formula (11), and this is then stored in the ROM 172 as the predicted throttle opening θe(i+1) after the prescribed delay time TD from the current model arithmetic processing time point. Next, in Step 103, a drive signal is output to the throttle valve driving actuator 146a so that the throttle opening becomes the target throttle opening stored in the ROM 172 the prescribed delay time TD ago as the target throttle opening at the current model arithmetic processing time point, after which the routine ends.

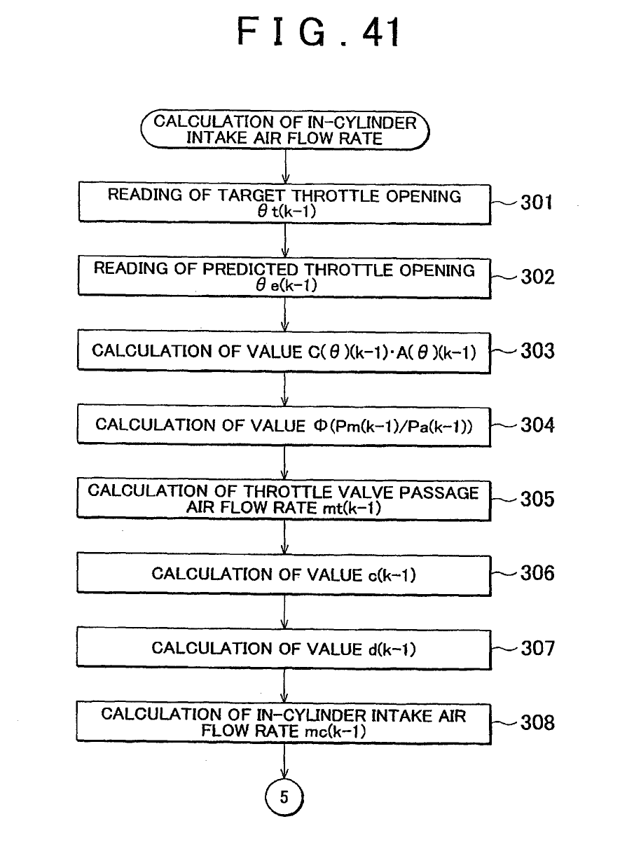

The routine shown in FIGS. 41 to 43 is a routine that executes arithmetic processing in accordance with the above-mentioned models M2 to M7, and is executed at the above-mentioned prescribed time intervals ΔT2. When this routine is started, the target throttle opening θt stored in the ROM 172 as a result of execution of the routine of FIG. 33, which is the target throttle opening θt at the time point later in time than the current model arithmetic processing time point and closest to the time point of calculating the target throttle opening θt, is first read in Step 301 as the target throttle opening θt(k−1) to be used in the current model arithmetic processing. Next, in Step 302, the predicted throttle opening θe stored in the ROM 172 as a result of execution of the routine of FIG. 33, which is the predicted throttle opening θe at the time point later in time than the current model arithmetic model processing time point and closest to the time point of calculating the predicted throttle opening θe, is similarly read as the predicted throttle opening θe(k−1) to be used in the current model arithmetic processing.

Next, the routine proceeds to Steps 303 to 305 that execute arithmetic processing in accordance with the throttle model M2. In Step 303, the value C(θ)(k−1)·A(θ)(k−1) is determined from the above-mentioned map Mca (see FIG. 26) based on the predicted throttle opening θe(k−1) read in the previous Step 302. Next, in Step 304, the value Φ(Pm(k−1)/Pi(k−1)) is determined from the above-mentioned map MΦ (see FIG. 34) based on the value Pm(k−1)/Pi(k−1) obtained by dividing the intake pressure Pm(k−1) at the previous model arithmetic processing time point by the intercooler pressure Pi(k−1) at the previous model arithmetic processing time point. Next, in Step 305, the throttle valve passage air flow rate mt(k−1) is calculated in accordance with the above-mentioned model formula (12) based on the value C(θ)(k−1)·A(θ)(k−1) determined in Step 303, the value D(Pm(k−1)/Pi(k−1)) determined in Step 304, the intake pipe pressure Pm(k−1) at the previous model arithmetic processing time point, and the intercooler temperature Ti(k−1) at the previous model arithmetic processing time point.

Next, the routine proceeds to Steps 306 to 308 that execute arithmetic processing in accordance with the intake valve model M3. Namely, in Step 306, the value c(k−1) is determined from the above-mentioned map Mc (see FIG. 27) based on the engine rotating speed NE(k−1) and the intake valve opening and closing timing VT(k−1) at the current model arithmetic processing time point. Next, in Step 307, the value d(k−1) is determined from the above-mentioned map Md (see FIG. 28) based on the engine rotating speed NE(k−1) and the intake valve opening and closing timing VT(k−1) at the current model arithmetic processing time point. Next, in Step 308, the in-cylinder intake air flow rate mc(k−1) is calculated in accordance with the model formula (14) based on the value c(k−1) determined in Step 306, the value d(k−1) determined in Step 307, the intercooler temperature Ti(k−1) at the previous model arithmetic processing time point, the intake pipe temperature Tm(k−1) at the previous model arithmetic processing time point, and the intake pipe pressure Pm(k−1) at the previous model arithmetic processing time point

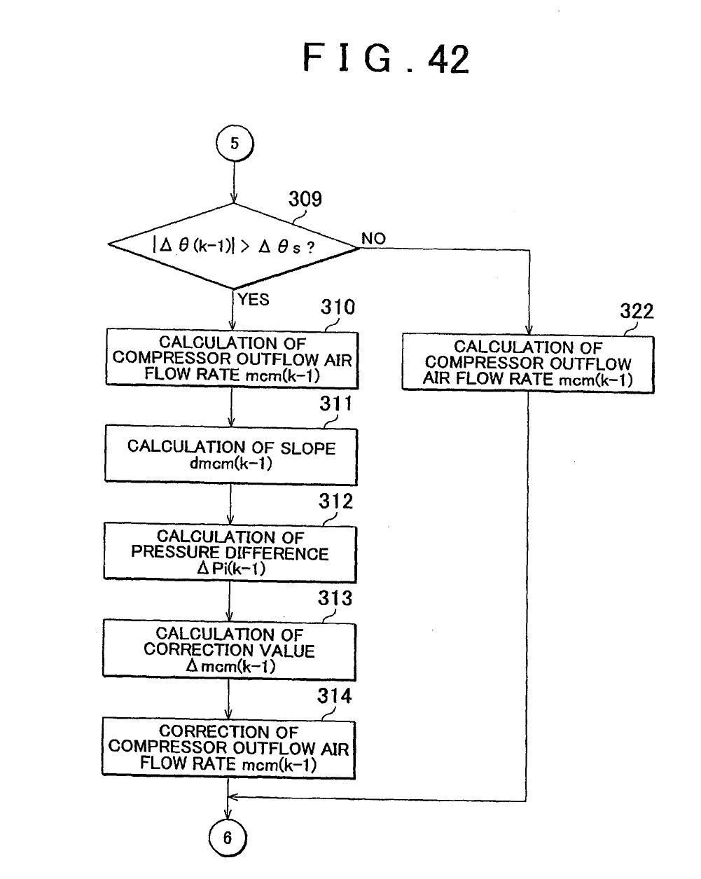

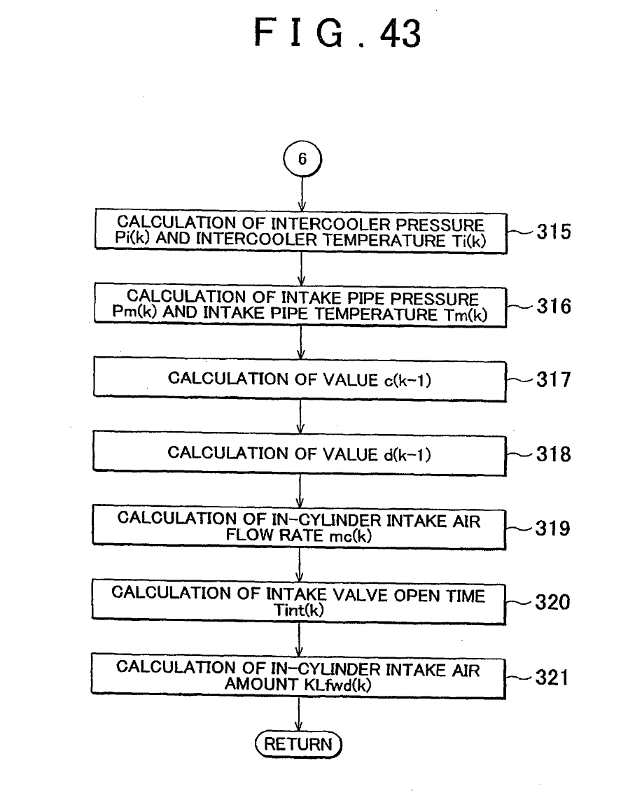

Next, in Step 309 of FIG. 42, a determination is made as to whether or not the absolute value of a difference Δθ(k−1) between the target throttle opening θt(k−1) read in Step 301 and the predicted throttle opening θe(k−1) read in Step 302 is larger than a predetermined opening difference Δθs (|Δθ(k−1)|>Δθs). Here, when the absolute value |Δθ(k−1)| has been determined to be larger than Δθs, namely when the compressor outflow air flow rate has been determined to change greatly during the time from the current model arithmetic processing time point to the next model arithmetic processing time point, the routine proceeds to Steps 310 to 312 that carry out arithmetic processing in accordance with the compressor model M5 and correction of the compressor outflow air flow rate as calculated by this arithmetic processing. Namely, in Step 310, the compressor outflow air flow rate mcm(k−1) is determined from the above-mentioned map Mmcm (see FIG. 36) based on the pressure ratio Pm(k−1)/Pi(k−1), which is the ratio of the intake pipe pressure Pm(k−1) at the previous model arithmetic processing time point to the intercooler pressure Pi(k−1) at the previous model arithmetic processing time point, and the compressor rotating speed NC(k−1) at the previous model arithmetic processing time point. Next, in Step 311, the slope dmcm(k−1) is determined from the above-mentioned map Mmcm (see FIG. 40) based on the compressor rotating speed NC(k−1) at the previous model arithmetic processing time point and the intercooler pressure Pi(k−1) at the previous model arithmetic processing time point. Next, in Step 312, a difference ΔPi(k−1) between the intercooler pressure Pi(k−1) at the current model arithmetic processing time point and the intercooler pressure Pi(k−2) at the previous model arithmetic processing time point (namely, Pi(k−1)−Pi(k−2)) is calculated. Next, in Step 313, a correction amount Δmcm(k−1) is calculated for the compressor outflow air flow rate by multiplying the difference ΔPi(k−1) calculated in Step 312 by the slope dmcm(k−1) determined in Step 311. Next, in Step 314, correction is made by adding the correction amount Δmcm(k−1) calculated in Step 313 to the compressor outflow air flow rate mcm(k−1) calculated in Step 310, after which the routine proceeds to Step 315 of FIG. 43 that executes arithmetic processing in accordance with the intercooler model M5. Thus, when the compressor outflow air flow rate has been determined to change greatly during the time from the current model arithmetic processing time point to the next model arithmetic processing time point, the corrected compressor outflow air flow rate is used in the model arithmetic processing starting in Step 315, and as a result, the in-cylinder air amount calculated by the current model arithmetic processing is in a corrected form.

On the other hand, when the absolute value |Δθ(k−1)| has been determined to be less than or equal to Δθs in Step 309, namely when the compressor outflow air flow rate has been determined to not change greatly during the time from the current model arithmetic processing time point to the next model arithmetic processing time point, the routine proceeds to Step 322 that executes arithmetic processing in accordance with the compressor model M5. Namely, in Step 322, the compressor outflow air flow rate mcm(k−1) is determined from the map Mmcm (see FIG. 36) based on the pressure ratio Pm(k−1)/Pi(k−1), which is the ratio of the intake pipe pressure Pm(k−1) at the previous model arithmetic processing time point to the intercooler pressure Pi(k−1) at the previous model arithmetic processing time point, and the previous compressor rotating speed NC(k−1), after which the routine proceeds to Step 315 of FIG. 43 that executes arithmetic processing in accordance with the intercooler model M5. Thus, when it has been determined in Step 309 that the compressor outflow air flow rate does not change greatly during the time from the current model arithmetic processing time point to the next model arithmetic processing time point, an uncorrected compressor outflow air flow rate is used in the model arithmetic processing starting in Step 315, and as a result, the in-cylinder intake air amount calculated by the current model arithmetic processing is in an uncorrected form.

In Step, 315, the intercooler pressure Pi(k) and the intercooler temperature Ti(k) are calculated in accordance with the model formulas (15) and (16) based on the compressor outflow air flow rate mcm(k−1) calculated in Step 314 or Step 322, the throttle valve passage air flow rate mt(k−1) calculated in Step 305, the intake temperature Ta(k−1) at the previous model arithmetic processing time point, and the compressor-imparted energy Ec calculated in accordance with formula (22).

Next, the routine proceeds to Step 313 of FIG. 43 that executes arithmetic processing in accordance with the intake pipe model M6. Namely, in Step 313, the intake pipe pressure Pm(k) and the intake pipe temperature Tm(k) are calculated in accordance with the model formulas (34) and (35) based on the throttle valve passage air flow rate mt(k−1) calculated in Step 305, the in-cylinder intake air flow rate mc(k−1) calculated in Step 308, and the intercooler temperature Ti(k−1) at the current model arithmetic processing time point.

Next, the routine proceeds to Step 317 to 321 that execute arithmetic processing in accordance with the intake valve model M7. Namely, in Step 317, the value c(k−1) is determined from the map Mc (see FIG. 27) based on the engine rotating speed NE(k−1) and the intake valve opening and closing timing VT(k−1) at the current model arithmetic processing time point. Next, in Step 318, the value d(k−1) is determined from the map Md (see FIG. 28) based on the engine rotating speed NE(k−1) and the intake valve opening and closing timing VT(k−1) at the current model arithmetic processing time point. Next, in Step 319, the in-cylinder intake air flow rate mc(k) is calculated in accordance with the model formula (36) based on the value c(k−1) determined in Step 317, the value d(k−1) determined in Step 318, the intake pipe pressure Pm(k) calculated in Step 316, the intake pipe temperature Tm(k) also calculated in Step 316, and the intercooler temperature Ti(k) calculated in Step 315. Next, in Step 320, the intake valve open time Tint(k) is calculated based on the engine rotating speed NE(k−1) and the intake valve opening and closing timing VT(k−1) at the current model arithmetic processing time point. Next, in Step 321, the in-cylinder intake air amount KLfwd(k) is calculated in accordance with the formula (37) based on the in-cylinder intake air flow rate mc(k) calculated in Step 319 and the intake valve open time Tint calculated in Step 320, after which the routine ends.

In the embodiment described above, the in-cylinder intake air amount that is calculated by model arithmetic processing is corrected in accordance with the amount of change in a certain specific parameter during the time from the previous model arithmetic processing time point to the current model arithmetic processing time point (for example, the amount of change in throttle valve passage air flow rate). Namely, it is taken into consideration that the value of a certain specific parameter changes from the current model arithmetic processing time point to the next model arithmetic processing time point by the amount substantially equal to the amount of change in that parameter from the previous model arithmetic processing time point to the current model arithmetic processing time point. Thus, in the embodiment described above, the in-cylinder intake air amount after correction becomes a value that coincides with or is at least close to the in-cylinder intake air amount at the next model arithmetic processing time point.

However, instead of using the amount of change in the value of a certain specific parameter during the time from the previous model arithmetic processing time point to the current model arithmetic processing time point to correct the in-cylinder intake air amount, the amount of change in a certain specific parameter during a time period that is shorter than that time period or conversely, the amount of change in the value of a certain specific parameter during a time period that is longer than that time period, may also be used. In this case, the in-cylinder intake air amount after correction is a value that either coincides with or is at least close to the in-cylinder intake air amount when a time period used as a reference for calculating the amount of change in the value of a parameter has elapsed from the current model arithmetic processing time point. As an example thereof, the time period from the current model arithmetic processing to when the in-cylinder intake air amount calculated by the current model arithmetic processing is actually used to control operation of the internal combustion engine may be used for the time period that serves as a reference for calculating the amount of correction of the value of a parameter. In this case, the calculated in-cylinder intake air amount is a value that coincides with or is at least close to the actual in-cylinder intake air amount when it is actually used to control operation of the internal combustion engine.

Although the above has provided a detailed explanation of embodiments of the invention, modifications not specifically mentioned in the description are naturally included in the scope of the invention within a range that does not alter the essential portions thereof. In addition, elements represented in terms of their action or function among the elements that compose the means for solving the problems of the invention include the specific structures disclosed in the above-mentioned embodiments and modifications, as well as all structures able to realize the actions and functions thereof.

1. An internal combustion engine system control device comprising:
an internal combustion engine system, provided with an intake passage that is connected to a cylinder provided within an internal combustion engine, an intake valve provided in the internal combustion engine so as to open and close an intake port that is connected to the cylinder in the intake passage, and a supercharger that has a compressor that compresses air in the intake passage farther upstream than the intake valve,
an in-cylinder intake air flow rate calculation section that calculates an in-cylinder intake air flow rate, which is a flow rate of air entering the cylinder, with the use of parameters that indicate a status of an intake system that includes the intake passage and the intake valve and comprise at least a pressure of air in the intake passage and a temperature of air in the intake passage, and an air model, which is a calculation model, constructed based on thermodynamics laws and fluid dynamics laws including the energy conservation law, momentum conservation law and mass conservation law relating to the behavior of air in the intake system; and
a compressor outflow flow rate calculation section that calculates a compressor outflow flow rate, which is a flow rate of air flowing out from the compressor, based on a predetermined relationship and the value of the in-cylinder intake air flow rate calculated by the in-cylinder intake air flow rate calculation section, wherein the predetermined relationship is a relationship between the in-cylinder intake air flow rate during steady-state operation in the internal combustion engine system and a supercharging pressure corresponding to the pressure of air that is compressed by the compressor and which is one of an air pressure at the outlet of the supercharger or a ratio between the air pressure at the outlet of the supercharger and the air pressure on the upstream side of the compressor.

2. The internal combustion engine system control device according to claim 1, wherein the internal combustion engine system is further provided with a throttle valve that is installed in the intake passage and that is able to adjust an flow path cross-sectional area in the intake passage,
wherein the in-cylinder intake air flow rate calculation section is configured to calculate the in-cylinder intake air flow rate in addition with the use of parameters that indicate a status of the throttle valve.

3. The internal combustion engine system control device according to claim 2, further comprising:
a throttle passage air flow rate calculation section that calculates a throttle passage air flow rate, which is the flow rate of air in the throttle valve, based on the opening of the throttle valve with the use of a throttle model, which is a calculation model, constructed based on thermodynamics laws and fluid dynamics laws including the energy conservation law, momentum conservation law and mass conservation law relating to the behavior of air in the throttle valve; and
a supercharging pressure calculation section that calculates the supercharging pressure based on the throttle passage air flow rate calculated by the throttle passage air flow rate calculation section, with the use of an intercooler model, which is a calculation model, constructed based on thermodynamics laws and fluid dynamics laws including the energy conservation law, momentum conservation law and mass conservation law relating to the behavior of air in an intercooler that is installed between the compressor and the throttle valve and that cools air that flows out from the compressor, wherein
the in-cylinder intake air flow rate calculation section calculates the in-cylinder intake air flow rate based on the throttle passage air flow rate calculated by the throttle passage air flow rate calculation section, with the use of an intake valve model as the air model, which is a calculation model constructed based on thermodynamics laws and fluid dynamics laws including the energy conservation law, momentum conservation law and mass conservation law relating to the behavior of air around the intake valve, and
the compressor outflow flow rate calculation section calculates the compressor outflow flow rate based on the value of the supercharging pressure calculated by the supercharging pressure calculation section and a provisional supercharging pressure that is acquired in the form of a provisional value of the supercharging pressure based on the relationship and the value of the in-cylinder intake air flow rate calculated by the in-cylinder intake air flow rate calculation section.

4. The internal combustion engine system control device according to claim 3, further comprising: an intake pipe internal status calculation section that calculates an intake pipe internal pressure and an intake pipe internal temperature, which are the pressure and temperature of air in a portion of the intake passage farther downstream than the throttle valve based on the throttle passage air flow rate calculated by the throttle passage air flow rate calculation section, with the use of an intake pipe model, which is a calculation model, constructed based on thermodynamics laws and fluid dynamics laws including the energy conservation law, momentum conservation law and mass conservation law relating to the behavior of air in that portion,
wherein the in-cylinder intake air flow rate calculation section calculates the in-cylinder intake air flow rate based on the values of the intake pipe internal pressure and the intake pipe internal temperature calculated by the intake pipe internal status calculation device, with the use of the intake valve model.

5. The internal combustion engine system control device according to claim 1, wherein the in-cylinder intake air flow rate calculation section calculates the in-cylinder intake air flow rate with the use of an intake valve model as the air model, which is a calculation model constructed based on thermodynamics laws and fluid dynamics laws including the energy conservation law, momentum conservation law and mass conservation law relating to the behavior of air around the intake valve.

6. The internal combustion engine system control device according to claim 1, wherein the compressor outflow flow rate calculation section calculates the compressor outflow flow rate based on a value of a rotating speed of the compressor that is calculated based on the relationship and the value of the in-cylinder intake air flow rate calculated by the in-cylinder intake air flow rate calculation section.

7. The internal combustion engine system control device according to claim 1, further comprising a responsiveness reflecting section that reflects a response delay of the supercharger in the value of the compressor outflow flow rate calculated by the compressor outflow flow rate calculation section.

8. The internal combustion engine system control device according to claim 7, wherein the responsiveness reflecting section reflects a response delay of the supercharger in the value of the in-cylinder intake air flow rate calculated by the in-cylinder intake air flow rate calculation section, the value serving as the basis for calculation of the compressor outflow flow rate by the compressor outflow flow rate calculation section.

9. An internal combustion engine system control device comprising:
an internal combustion engine system, including an intake passage that is connected to a cylinder provided within an internal combustion engine, an intake valve provided in the internal combustion engine so as to open and close an intake port that is connected to the cylinder in the intake passage, a throttle valve that is installed in the intake passage and that is able to adjust an flow path cross-sectional area in the intake passage, and a supercharger that has a compressor that compresses air in the intake passage farther upstream than the throttle valve in the intake passage;
an in-cylinder intake air flow rate acquisition section that acquires an in-cylinder intake air flow rate, which is a flow rate of air that enters the cylinder, with the use of a calculation model constructed based on thermodynamics laws and fluid dynamics laws including the energy conservation law, momentum conservation law and mass conservation law relating to the behavior of air in an intake system that includes the intake passage, the throttle valve, the compressor, and the intake valve;
a supercharging pressure acquisition section that acquires supercharging pressure corresponding to the pressure of air compressed by the compressor, wherein said supercharging pressure is one of an air pressure at the outlet of the supercharger or a ratio between the air pressure at the outlet of the supercharger and the air pressure on the upstream side of the compressor, with the use of another calculation model constructed based on other thermodynamics laws and fluid dynamics laws including the energy conservation law, momentum conservation law and mass conservation law relating to the behavior of air in the intake system;
a provisional intake air amount acquisition section that acquires a provisional intake air amount, which is the in-cylinder intake air flow rate in the case of assuming that the supercharging pressure during the steady-state operation coincides with a value of supercharging pressure acquired by the supercharging pressure acquisition section, based on an intake amount-supercharging pressure steady-state relationship and the supercharging pressure acquired value acquired by the supercharging pressure acquisition section, wherein the intake amount-supercharging pressure steady-state relationship is a relationship between the in-cylinder intake air flow rate and the supercharging pressure during steady-state operation in the internal combustion engine system; and
a compressor rotating speed estimation section that estimates rotating speed of the compressor based on an intake amount-rotating speed steady-state relationship, which is a relationship between the in-cylinder intake air flow rate and the rotating speed of the compressor during the steady-state operation, the in-cylinder intake air flow rate acquired by the in-cylinder intake air flow rate acquisition section, and the provisional intake air amount.

10. The internal combustion engine system control device according to claim 9, wherein
the compressor rotating speed estimation section includes:
a first provisional rotating speed acquisition section that acquires a first provisional rotating speed which is a provisional value of the rotating speed, based on the in-cylinder intake air flow rate acquired by the in-cylinder intake air flow rate acquisition section and the intake amount-rotating speed steady-state relationship;
a second provisional rotating speed acquisition section that acquires a second provisional rotating speed which is another provisional value of the rotating speed, based on the provisional intake air amount and the intake amount-rotating speed steady-state relationship; and
a rotating speed estimated value acquisition section that acquires an estimated value of the rotating speed by estimating a transient change in the rotating speed based on the first provisional rotating speed and the second provisional rotating speed.

11. The internal combustion engine system control device according to claim 9, further comprising:
a provisional in-cylinder intake air flow rate acquisition section that acquires a provisional in-cylinder intake air flow rate, which is the in-cylinder intake air flow rate in the case of assuming that the rotating speed during the steady-state operation coincides with the rotating speed estimated value, based on the value of the rotating speed estimated by the compressor rotating speed estimation section and the intake amount-rotating speed steady-state relationship;
a provisional supercharging pressure acquisition section that acquires a provisional supercharging pressure, which is a provisional value of the supercharging pressure, based on the intake amount-supercharging pressure steady-state relationship and the provisional in-cylinder intake air flow rate; and
a compressor outflow flow rate acquisition section that acquires a compressor outflow flow rate, which is a flow rate of air flowing out from the compressor, based on the provisional in-cylinder intake air flow rate, the provisional supercharging pressure, and the supercharging pressure acquired value.

12. The internal combustion engine system control device according to claim 11, wherein the compressor outflow flow rate acquisition section calculates the compressor outflow flow rate by correcting the provisional in-cylinder intake air flow rate with a correction value calculated by a product of a coefficient, which is determined based on the provisional in-cylinder intake air flow rate and a difference between the provisional supercharging pressure and the supercharging pressure acquired value, and the difference.

13. The internal combustion engine system control device according to claim 9, wherein
the in-cylinder intake air flow rate acquisition section includes:
a throttle passage air flow rate acquisition section that acquires a throttle passage air flow rate, which is a flow rate of air in the throttle valve, based on the opening of the throttle valve, with the use of the throttle model, which is the calculation model, constructed based on thermodynamics laws and fluid dynamics laws including the energy conservation law, momentum conservation law and mass conservation law relating to the behavior of air in the throttle valve; and
an intake pipe internal status acquisition section that acquires an intake pipe internal pressure and an intake pipe internal temperature which are the pressure and temperature of air in a portion of the intake passage farther downstream than the throttle valve based on the throttle passage air flow rate, with the use of an intake pipe model, which is the calculation model, constructed based on thermodynamics laws and fluid dynamics laws including the energy conservation law, momentum conservation law and mass conservation law relating to the behavior of air in that portion,
wherein with the use of the intake valve model as the calculation model constructed based on thermodynamics laws and fluid dynamics laws including the energy conservation law, momentum conservation law and mass conservation law relating to the behavior of air in the intake valve, the in-cylinder intake air flow rate is acquired based on the intake pipe internal pressure and the intake pipe internal temperature.

14. The internal combustion engine system control device according to claim 13, wherein the supercharging pressure acquisition section acquires the supercharging pressure based on the throttle passage air flow rate acquired by the throttle passage air flow rate acquisition section, with the use of an intercooler model as the calculation model constructed based on thermodynamics laws and fluid dynamics laws including the energy conservation law, momentum conservation law and mass conservation law relating to the behavior of air in an intercooler that is installed between the compressor and the throttle valve and that cools air flowing out from the compressor.

15. The internal combustion engine system control device according to claim 1, wherein
when the amount of air actually taken into the cylinder during an intake stroke is designated as an actual value of in-cylinder intake air amount, the actual value of in-cylinder intake air amount when a predetermined amount of time has elapsed from the start of calculation of in-cylinder intake air amount is calculated as a predicted value of in-cylinder intake air amount at the start of calculation of in-cylinder intake air amount, a difference between the predicted value of in-cylinder intake air amount and the actual value of in-cylinder intake air amount at the start of calculation of in-cylinder intake air amount is calculated as a predicted value of a change in in-cylinder intake air amount at the start of calculation of in-cylinder intake air amount, and when the predicted value of the change in in-cylinder intake air amount is greater than a predetermined predicted value of change, the calculated value of in-cylinder intake air amount is corrected in accordance with the predicted value of change in the in-cylinder intake air amount, and operation of the internal combustion engine is controlled based on the corrected calculated value of in-cylinder intake air amount.

16. The internal combustion engine system control device according to claim 15, wherein, when a difference between a throttle valve opening at the start of calculation of in-cylinder intake air amount and a throttle valve opening to be used as a target at the start of calculation of the in-cylinder intake air amount is greater than a predetermined opening difference, the predicted value of change in in-cylinder intake air amount is determined to be greater than the predetermined predicted value of change.

17. The internal combustion engine system control device according to claim 15, wherein, when pressure in the intake passage downstream the throttle valve is designated as a throttle valve downstream pressure, the throttle valve downstream pressure when the predetermined amount of time has elapsed from the start of calculation of in-cylinder intake air amount is calculated as a predicted value of the throttle valve downstream pressure at the start of calculation of the in-cylinder intake air amount, a difference between the predicted value of the throttle valve downstream pressure and the throttle valve downstream pressure at the start of calculation of in-cylinder intake air amount is calculated as an amount of change in the throttle valve downstream pressure at the start of calculation of the in-cylinder intake air amount, and when the amount of change in the throttle valve downstream pressure is greater than a predetermined pressure change, the predicted value of change in in-cylinder intake air amount is determined to be greater than the predetermined predicted value of change.

18. The internal combustion engine system control device according to claim 15, wherein, when the predicted value of change in in-cylinder intake air amount has been determined to be greater than the predetermined predicted value of change, and the predicted value of change in the in-cylinder intake air amount has been determined to increase more than the predetermined predicted value of change, the calculated value of in-cylinder intake air amount is corrected so as to increase, while on the other hand, when the predicted value of change in the in-cylinder intake air amount has been determined to be greater than the predetermined predicted value of change, and the predicted value of change in the in-cylinder intake air amount has been determined to decrease more than the predetermined predicted value of change, the calculated value of in-cylinder intake air amount is corrected so as to decrease.

19. The internal combustion engine system control device according to claim 15, wherein the calculation of the in-cylinder intake air amount is executed at predetermined time intervals, and the predetermined time is equal to the predetermined time interval.

20. The internal combustion engine system control device according to claim 15, wherein the predetermined time is equal to a time from the start of calculation of the in-cylinder intake air amount until a calculated value of in-cylinder intake air amount, which is obtained by calculating the in-cylinder intake air amount, is used to control operation of an internal combustion engine.

21-29. (canceled)
